(19) United States
(12) Patent Application Publication
(10) Pub. No.: US 2013/0321206 A1
(43) Pub. Date: Dec. 5, 2013

(54) INTERFERENCE REJECTIONS OF SATELLITE GROUND TERMINAL WITH ORTHOGONAL BEAMS

(71) Applicant: Donald C.D. Chang, Camarillo, CA (US)

(72) Inventor: Donald C.D. Chang, Thousand Oaks, CA (US)

(21) Appl. No.: 13/904,051

(22) Filed: May 29, 2013

Related U.S. Application Data
(60) Provisional application No. 61/652,334, filed on May 29, 2012.

(51) Int. Cl. H01Q 3/34

(52) U.S. Cl. CPC H01Q 3/34
USPC 342/372

(57) ABSTRACT

An outdoor unit of a satellite ground terminal is capable of simultaneously receiving satellite signals or data streams originated from multiple different orbital satellites operating at the same frequency in a satellite communication frequency band such as Ka band or Ku band by multiple concurrent orthogonal beams, which are generated by multiple analogue or digital beam forming networks of the outdoor unit and an antenna, such as multiple-beam antenna or direct radiating/reception array, of the outdoor unit. Each of the orthogonal beams has a beam peak in the desired direction and multiple nulls in the interference directions.

### RELATED APPLICATION

This application claims priority to U.S. provisional application No. 61/652,334, filed on May 29, 2012, which is incorporated herein by reference in its entirety.

### BACKGROUND OF THE DISCLOSURE

1. Field of the Disclosure

The disclosure relates to an architecture of a satellite ground terminal, and more particularly, to an architecture of a satellite ground terminal simultaneously creating multiple orthogonal beams (OBs) to improve isolations of gain among data streams, such as radio-frequency (RF) signals, received from neighboring satellites operating in the same frequency slot in a satellite communication frequency band (e.g. Ka band, UHF, L/S band, C band, X band, or Ku band).

2. Brief Description of the Related Art

FIG. 1A depicts gains of five conventional horizontally polarized (HP) beams pointed at various positions or angular directions from a multiple-beam antenna (MBA). The five conventional HP beams are referred to as Beam C1, Beam C2, Beam C3, Beam C4 and Beam C5, respectively, and have respective beam peaks pointed at angular directions of −4, −2, 0, 2 and 4 degrees, where the 0 degree is the boresight direction of the MBA. The five conventional HP beams are generated by a conventional MBA. The tabulation in FIG. 1A shows that the isolations of gain among the five conventional HP beams are better than 27 dB but less than approximately 50 dB among the interested discrete angular directions. FIG. 1B shows a HP radiation pattern for Beam C2 illustrated in FIG. 1A. The radiation patterns of the other four beams in FIG. 1A from the MBA are not depicted. Referring to FIG. 1B, the horizontal axis represents the azimuth ranging from −10 to 10 degrees with respect to the MBA of a satellite ground terminal; the vertical axis represents a radiation power at a gain level ranging from −35 dBi to 45 dBi. In FIG. 1B, the solid circle on the horizontal axis depicts the direction of a desired satellite, and the solid squares on the horizontal axis depict the directions of potential interferences. It is clear on FIG. 1B that Beam C2 features a beam peak, pointed to a satellite in a geo-synchronous orbital slot at the angle of −2° from the MBA boresight, having radiation power gain of approximately 40 dBi, the radiation power gain of Beam C2 at the angle of −4° is 13 dBi, and the radiation power gain at the angle of 0° is 10 dBi. Accordingly, the isolations of the gain at the beam peak of Beam C2 against the gains for potential interferences from the satellites at the angles of −4° and 0° are approximately 27 dB and 30 dB, respectively. The gains of Beam C2 at the angles of 2° and 4° are 0 dBi and −10 dBi, respectively, and the isolations of the gain at the beam peak of Beam C2 against the gains for potential interferences from the satellites at the angles of 2° and 4° are approximately 40 dB and 50 dB, respectively.

### SUMMARY OF THE DISCLOSURE

The present invention provides exemplary approaches for receiving satellite signals or data streams originated from multiple different orbital satellites operating at the same frequency in a satellite communication frequency band such as Ka band or Ku band. An exemplary embodiment of the present disclosure provides an outdoor unit of a satellite ground terminal for simultaneously receiving satellite signals or data streams in Ka band originated from multiple different orbital satellites operating in the same frequency or frequency slot in Ka band. The satellite ground terminal may be a direct broadcasting satellite (DBS) TV terminal (or DBS TV receiver). The outdoor unit includes an antenna having multiple feeds, an analogue beamforming network arranged downstream of the antenna, and a RF front end processor arranged downstream of the analogue beamforming network. The satellite ground terminal includes an indoor unit configured to receive signals from the RF front end processor. The RF front end processor may include a controller, a switching mechanism arranged downstream of the analogue beamforming network, and multiple output ports arranged downstream of the switching mechanism.

The antenna may be a multi-beam antenna including the feeds and a reflector having an aperture size ranging from 55 cm to 85 cm in azimuth. Alternatively, the antenna may be a direct radiating/reception array including the feeds. The number of the feeds may be equal to or more than the number of satellite orbital slots allocated for the different orbital satellites. Each of the feeds is configured to receive or collect the satellite signals or data streams in Ka band so as to output a Ka-band signal or data stream in an analog format. The analogue beamforming network is configured to form multiple concurrent orthogonal beams at the same frequency or frequency slot in a frequency band (such as Ka band, L band, C band, X band, or Ku band) based on the Ka-band signals or data streams from the feeds. The concurrent orthogonal beams include first and second orthogonal beams, and the different orbital satellites include first and second satellites, which separate from each other by substantially 2 degrees.

The first orthogonal beam includes a first beam peak in a direction of the first satellite and a first null substantially in a direction of the second satellite. The second orthogonal beam includes a second beam peak in the direction of the second satellite and a second null substantially in the direction of the first satellite. The first orthogonal beam may include a third null adjacent to the first null, and an angular width between the first and third nulls ranges from 0.05 to 0.5 degrees. The first orthogonal beam may further include a peak of a first side lobe, below greater than 30 dB or 40 dB from the first beam peak, between the first and third nulls. The peak of the first side lobe, for example, may be at a gain level less than 0 dBi. The second orthogonal beam may include a fourth null adjacent to the second null, and an angular width between the second and fourth nulls ranges from 0.05 to 0.5 degrees. The second orthogonal beam may further include a peak of a second side lobe, below greater than 30 dB or 40 dB from the second beam peak, between the second and fourth nulls. The peak of the second side lobe, for example, may be at a gain level less than 0 dBi. The switching mechanism of the RF front end processor may be configured to select one of the first and second orthogonal beams.

The analogue beamforming network may include (1) a power dividing network arranged downstream of the feeds and (2) first and second hybrid networks arranged downstream of the power dividing network. The power dividing network is configured to divide the Ka-band signals or data streams from the feeds into first and second sets of power-divided signals or data streams. The first hybrid network is configured to receive the first set of power-divided signals or data streams and form the first orthogonal beam based on the first set of power-divided signals or data streams. The second hybrid network is configured to receive the second set of power-divided signals or data streams and form the second orthogonal beam simultaneously with the first orthogonal beam based on the second set of power-divided signals or data streams.

In one example, the power dividing network may be configured to divide one of the Ka-band signals or data streams into a first power-divided signal or data stream with a first power and a second power-divided signal or data stream with a second power and divide another one of the Ka-band signals or data streams into a third power-divided signal or data stream with a third power and a fourth power-divided signal or data stream with a fourth power. The first power may be equal to or different from the second power. The third power may be equal to or different from the fourth power. The first set of power-divided signals includes the first and third power-divided signals or data streams, and the second set of power-divided signals or data streams includes the second and fourth power-divided signals or data streams. The first hybrid network includes a first hybrid configured to receive the first and third power-divided signals or data streams and output a first combined signal or data stream containing information associated with the first and third power-divided signals or data streams. The second hybrid network includes a second hybrid configured to receive the second and fourth power-divided signals or data streams and output a second combined signal or data stream containing information associated with the second and fourth power-divided signals.

The first combined signal or data stream includes a first linear combination of the first power-divided signal or data stream multiplied by a first complex number plus the second power-divided signal or data stream multiplied by a second complex number. The second combined signal or data stream includes a second linear combination of the second power-divided signal or data stream multiplied by a third complex number plus the fourth power-divided signal or data stream multiplied by a fourth complex number.

The outdoor unit may include (1) multiple low-noise amplifiers (LNAs) on signal paths between the feeds and the power dividing network of the analogue beamforming network and (2) multiple band-pass filters (BPFs) on signal paths between the LNAs and the power dividing network of the analogue beamforming network. Alternatively, low-noise block down-converters (LNBs) may be used instead of the LNAs. The antenna may include Ku-band feeds configured to receive or collect Ku-band satellite signals or data streams originated from multiple Ku-band satellites so as to output analog signals or data streams in Ku band to the RF front end processor, and the switching mechanism of the RF front end processor may be configured to select one of the first orthogonal beam, the second orthogonal beam, and the analog signals or data streams. Alternatively, the analogue beamforming network may be replaced with a digital beamforming network, and in this case, the outdoor unit includes multiple analog-to-digital converters on signal paths between the feeds and the digital beamforming network.

These, as well as other components, steps, features, benefits, and advantages of the present disclosure, will now become clear from a review of the following detailed description of illustrative embodiments, the accompanying drawings, and the claims.

### BRIEF DESCRIPTION OF THE DRAWINGS

The drawings disclose illustrative embodiments of the present disclosure. They do not set forth all embodiments. Other embodiments may be used in addition or instead. Details that may be apparent or unnecessary may be omitted to save space or for more effective illustration. Conversely, some embodiments may be practiced without all of the details that are disclosed. When the same reference number or reference indicator appears in different drawings, it may refer to the same or like components or steps.

Aspects of the disclosure may be more fully understood from the following description when read together with the accompanying drawings, which are to be regarded as illustrative in nature, and not as limiting. The drawings are not necessarily to scale, emphasis instead being placed on the principles of the disclosure. In the drawings:

FIG. 1A shows gains of five conventional horizontally polarized (HP) beams pointed at various angular positions or directions from a multiple-beam (MBA) antenna;

FIG. 1B shows a typical horizontally polarized (HP) radiation pattern of an off-axis beam from a multiple-beam antenna (MBA) with an aperture about 40 wavelengths in diameter;

FIG. 2 shows five geostationary orbital (GEO) slots at X−2°, X°, X+2°, X−4° and X+4° for five geostationary satellites S1, S2, S3, S4 and S5, respectively, according to an embodiment of the present disclosure, where X (in degrees) is the angular direction of the boresight of an MBA antenna;

FIG. 3A shows requires gains of five horizontally polarized (HP) beams at various angular directions or positions for a multiple-beam antenna of a satellite ground terminal according to an embodiment of the present disclosure;

FIG. 3B shows a horizontally polarized (HP) radiation pattern for one of orthogonal beams according to an embodiment of the present disclosure;

FIGS. 4A, 4B and 4C show radiation patterns of three orthogonal beams according to an embodiment of the present disclosure;

FIG. 5 shows a simplified block diagram of receiving functions of an outdoor unit of a satellite ground terminal with a multi-beam antenna featuring an elliptical aperture of 80-cm by 50-cm, seven Ka-band feeds, and three Ku-band feeds according to an embodiment of the present disclosure;

FIG. 6 shows seven individual secondary radiation/reception patterns from seven feeds at Ka band illuminating a reflector according to an embodiment of the present disclosure;

FIG. 7 shows a simplified block diagram for receiving functions of an outdoor unit of a satellite ground terminal with two front end processors connecting to two analogue beamforming networks and a multiple-beam antenna with Ka-band feeds and Ku-band feeds according to an embodiment of the present disclosure, a reflector associated with the Ka-band and Ku-band feeds of the multiple-beam antenna being not depicted;

FIGS. 8A and 8B show two simplified block diagrams of two analogue beamforming networks according to an embodiment of the present disclosure;

FIGS. 9A, 9B and 9C show three broad-null beams generated by an analogue or digital beamforming network and an antenna according to an embodiment of the present disclosure;

FIG. 10 shows four broad-null beams, which are one of orthogonal beams operated at various frequency slots, according to an embodiment of the present disclosure;

FIG. 11 shows a simplified block diagram of receiving functions of an outdoor unit of a satellite ground terminal with a direct radiating array (DRA) featuring elements with uniform spacing according to an embodiment of the present disclosure;

FIG. 12 shows a simplified block diagram of receiving functions of an outdoor unit of a satellite ground terminal with an antenna (such as multi-beam antenna or direct radiating array) featuring seven elements according to an embodiment of the present disclosure;

FIG. 13 shows a simplified block diagram of receiving functions of an outdoor unit of a satellite ground terminal with an antenna (such as multi-beam antenna or direct radiating array) featuring seven elements according to an embodiment of the present disclosure;

FIG. 14 shows a simplified block diagram of a satellite ground terminal with an indoor unit and an outdoor unit according to an embodiment of the present disclosure;

FIG. 15 shows a theoretical plot showing the relation between gain reduction and aperture sizes of a reflector or dish according to an embodiment of the present disclosure, using an elliptical aperture of 80-cm by 50-cm as the reference;

FIG. 16 shows a simplified block diagram of receiving functions of an outdoor unit of a satellite ground terminal with a multi-beam antenna featuring an elliptical aperture of 55-cm by 50-cm, five Ka-band feeds, and three Ku-band feeds according to an embodiment of the present disclosure;

FIGS. 17A, 17B and 17C show radiation patterns of three Ka-band orthogonal beams respectively pointed at X, X−2 and X+2 degrees according to an embodiment of the present disclosure;

FIGS. 18A and 18B show simplified block diagrams of two analogue beamforming networks according to an embodiment of the present disclosure;

FIG. 19 shows azimuth cuts of three Ku-band beams according to an embodiment of the present disclosure;

FIG. 20 shows a simplified block diagram of receiving functions of an outdoor unit of a satellite ground terminal with a direct radiating array (DRA) featuring elements with non-uniform spacing according to an embodiment of the present disclosure;

FIG. 21 shows a simplified block diagram of receiving functions of an outdoor unit of a satellite ground terminal with an antenna (such as multi-beam antenna or direct radiating array) featuring five elements according to an embodiment of the present disclosure;

FIG. 22 shows a simplified block diagram of receiving functions of an outdoor unit of a satellite ground terminal with an antenna (such as multi-beam antenna or direct radiating array) featuring five elements according to an embodiment of the present disclosure;

FIG. 23 shows a simplified block diagram of a satellite ground terminal with an indoor unit and an outdoor unit according to an embodiment of the present disclosure;

FIGS. 24A and 24B show radiation patterns of two Ka-band orthogonal beams respectively pointed at X−4 and X+4 degrees according to an embodiment of the present disclosure;

FIG. 25A depicts Ka-band radiation patterns of five conventional spot beams for a multi-beam antenna featuring an elliptical aperture of 55-cm by 50-cm with five Ka-band feeds according to an embodiment of the present disclosure; and

FIG. 25B depicts Ka-band radiation patterns of five orthogonal beams for a multi-beam antenna featuring an elliptical aperture of 55-cm by 50-cm with five Ka-band feeds according to an embodiment of the present disclosure.

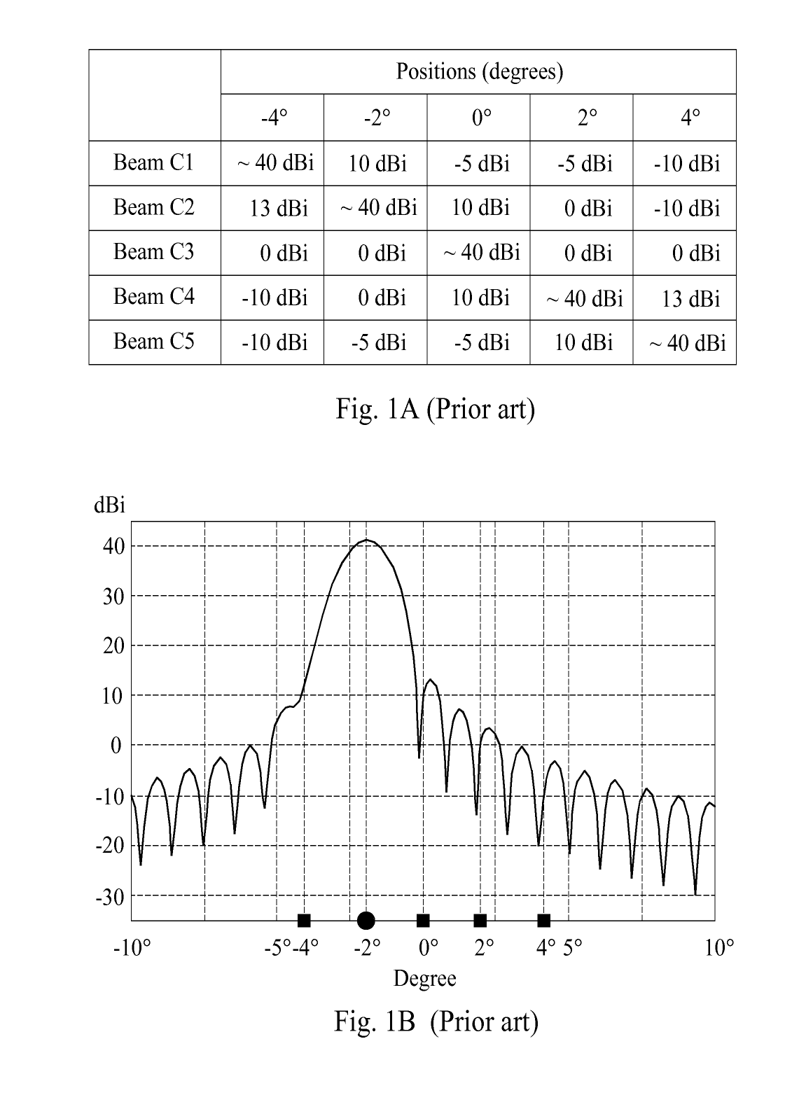

While certain embodiments are depicted in the drawings, one skilled in the art will appreciate that the embodiments depicted are illustrative and that variations of those shown, as well as other embodiments described herein, may be envisioned and practiced within the scope of the present disclosure.

### DETAILED DESCRIPTION OF THE INVENTION

Illustrative embodiments are now described. Other embodiments may be used in addition or instead. Details that may be apparent or unnecessary may be omitted to save space or for a more effective presentation. Conversely, some embodiments may be practiced without all of the details that are disclosed.

The present invention illustrates a satellite ground terminal (hereinafter referred to as ground terminal GT), such as multi-beam fixed or mobile ground terminal or direct broadcasting satellite (DBS) TV terminal, creating and/or using multiple orthogonal beams (OBs) to concurrently communicate with multiple satellites in different orbital slots but in the same frequency slot in a satellite communication frequency band (e.g. Ka band, UHF, L/S band, C band, X band, or Ku band). The satellites may be, but not limited to, geostationary satellites, separated apart by about 2 degrees in longitudes. They may also be non-geostationary satellites. These satellites shall have overlapped or common coverage areas communicating to multiple satellite ground terminals, including the terminal GT, in the overlapped or common coverage areas via the same frequency slot in a spectrum such as Ka band. The ground terminal GT includes an outdoor unit with an antenna (e.g. a multiple-beam antenna featuring a reflector with multiple feeds (or feed elements) illuminating the reflector, or a direct radiating/reception array featuring multiple array elements arranged in a linear array or in a line) and beam forming networks (e.g. analogue or digital beam forming networks), which may form the orthogonal beams each having a peak and multiple nulls in the specified directions from the view of the ground terminal. The beam forming networks may form fixed, reconfigurable or/and dynamic tracking beams for tracking targeted satellites and may be implemented in an analogue or digital format. The outdoor unit with the antenna and the beam forming networks may operate in various modes, such as mode for transmissions and receptions, mode for receptions only, or mode for transmission only.

The following embodiments illustrate that a satellite ground terminal communicates with multiple satellites operating in Ka band spectrum. Alternatively, the following embodiments may be applied to a satellite ground terminal operating in other frequency band, such as UHF, L/S band, C band, X band, or Ku band.

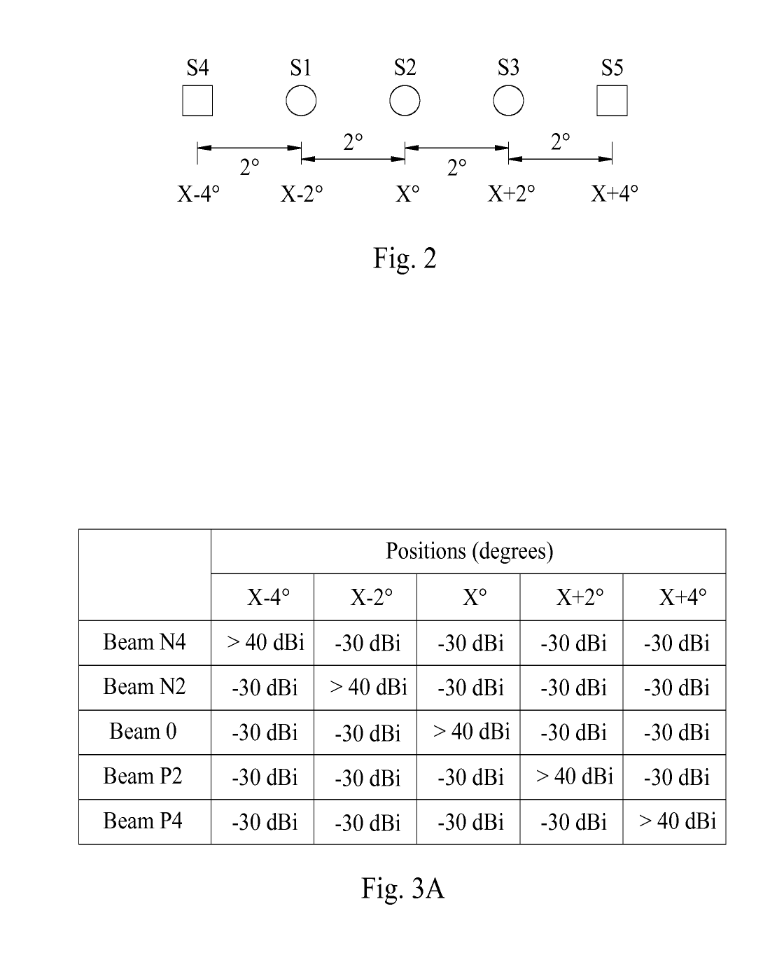

FIG. 2 shows five allocated satellite orbital slots in the geostationary (GEO) orbit at X−2°, X°, X+2°, X−4° and X+4° for five Ka band geostationary satellites S1, S2, S3, S4 and S5 (e.g. five Ka DBS satellites), respectively, for the contiguous United States (CONUS) coverage, where “X” could represent a boresight direction of a ground terminal (e.g. the terminal GT) pointed at any position, such as 101° W or −101° in longitude. Referring to FIG. 2, the three satellite orbital slots at X−2°, X° and X+2° may be allocated for the three satellites S1, S2 and S3 for a DBS TV service provider. The other two orbital slots at X−4° and X+4° may be allocated for the two satellites S4 and S5 for another DBS TV service provider. The five satellites S1, S2, S3, S4 and S5 may concurrently transmit analog data streams or signals to multiple satellite ground terminals in the same frequency slot in Ka band. They may also operate in other satellite communication frequency band, such as UHF, L/S band, C band, X band, or Ku band.

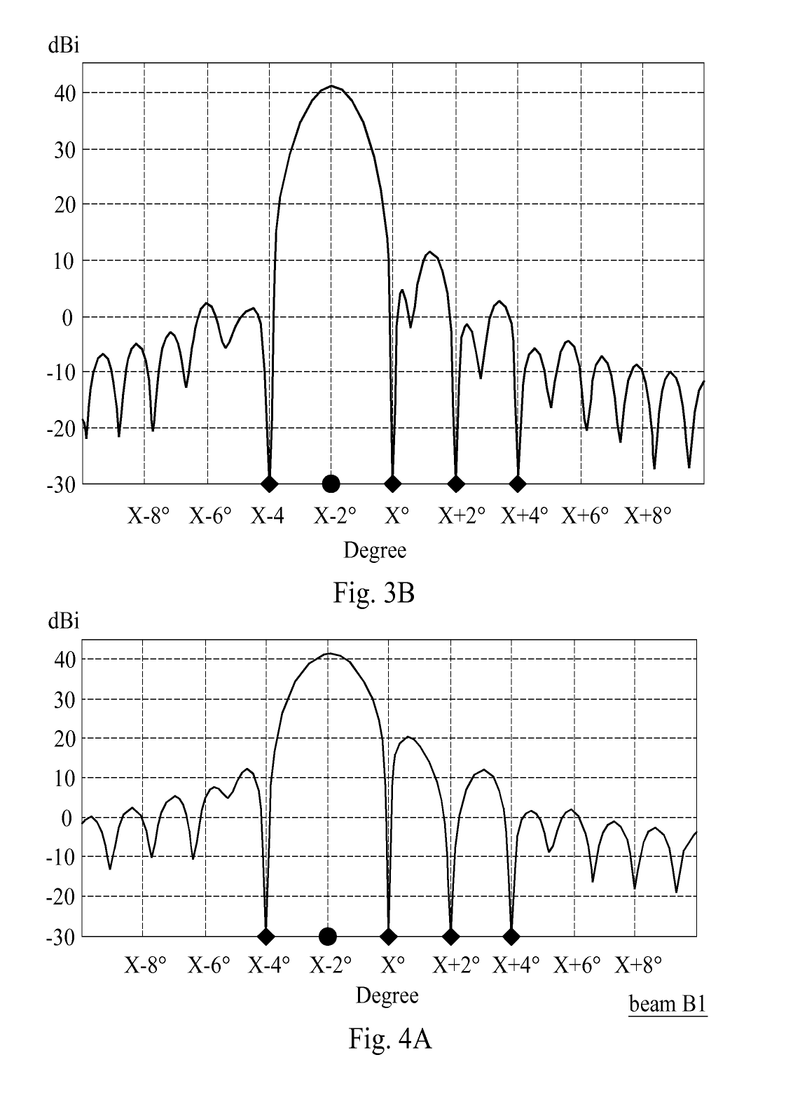

FIG. 3A depicts required gains of five Ka-band horizontally polarized (HP) beams in the interested angular directions or positions, i.e. X−2°, X°, X+2°, X−4° and X+4°. Referring to FIG. 3A, the five HP beams from a satellite ground terminal (e.g. Ka satellite ground terminal or Ka/Ku satellite ground terminal) are referred to as five beams N4, N2, 0, P2, and P4, each featuring a beam peak pointed to a corresponding one of the orbital slots at X−4, X−2, X, X+2, and X+4 degrees. Each of these beams 0, N2, N4, P2, and P4 also features multiple nulls with gains less than −30 dBi in the directions of the beam peaks of the other beams. These beams 0, N2, N4, P2, and P4 with specified peaks and nulls may be implemented as five orthogonal beams (OBs) and may be concurrently generated from an antenna of the satellite ground terminal, such as Ka-band multiple-beam antenna, featuring a reflector with an aperture size of, e.g., x1 cm in azimuth and x2 cm in elevation, where “x1” ranges from 55 cm to 85 cm, and “x2” ranges from 45 cm to 75 cm. For example, the aperture may have a dimension of 80-cm by 50-cm, 65-cm by 65-cm, 65-cm by 50-cm, or 55-cm by 50-cm. Beam shaping techniques are used in designing these orthogonal beams 0, N2, N4, P2, and P4. The shapes of these orthogonal beams 0, N2, N4, P2, and P4 are based on optimized beam weighting vectors (BWVs) calculated by an optimization algorithm. These concurrent beams 0, N2, N4, P2, and P4 exhibit two unique features: (1) a beam peak of one beam is always at nulls of all other beams; and (2) beam peaks of all other beams shall always at nulls of the beam. Thus, these five beams N2, 0, P2, N4, and P4 are shaped purposely to be orthogonal to one another. As a result, any one of the beams N2, 0, P2, N4, and P4 featuring a beam peak in a direction of one of the satellites S1, S2, S3, S4 and S5 in the respective orbital slots at X−2°, X°, X+2°, X−4°, and X+4° shall feature nulls in the directions of the others of the satellites S1-S5. Accordingly, the HP orthogonal beams provide enhanced isolation among signals or data streams from the satellites S1-S5.

A shaped beam is a result of a linear combination of many (N) element beams. Since antenna far field predictions are a linear process, a linear combination of feed elements on the antenna side is equivalent of the same linear combination of the element patterns in far field. As a result, the radiation pattern of a shaped beam is a weighted sum of the N element patterns. These complex weighting parameters for the linear combination of a shaped beam alter amplitudes and phases of element radiation patterns direction-by-direction accordingly, and are the N components of a beam weighting vector (BWV). The beam shaping for an orthogonal beam is through the modification of its BWV. When there are 5 orthogonal beams (such as the beams N2, 0, P2, N4, and P4), there shall be 5 BWVs for 5 different but “optimized” radiation patterns generated from different linear combinations of the same N element patterns. Various peaks and nulls for a group of orthogonal beams are the constraints for the optimizations of BWVs for a multiple-beam antenna. The optimized BWV's for various orthogonal beams from the multiple-beam antenna are implemented via BFNs either digitally or via analogue means.

Referring to FIG. 3A, the beam 0 features a beam peak at a gain level of greater than 40 dBi in the angular direction of X° and four nulls at a gain level of less than or equal to −30 dBi in the angular directions of X−2°, X+2°, X−4°, and X+4°. The beam N2 orthogonal to the beam 0 features a beam peak at a gain level of greater than 40 dBi in the angular direction of X−2° and four nulls at a gain level of less than or equal to −30 dBi in the angular directions of X+2°, X°, X−4°, and X+4°. The beam P2 orthogonal to the beams 0 and N2 features a beam peak at a gain level of greater than 40 dBi in the angular direction of X+2° and four nulls at a gain level of less than or equal to −30 dBi in the angular directions of X−2°, X°, X−4°, and X+4°. The beam N4 orthogonal to the beams 0, N2, and P2 features a beam peak at a gain level of greater than 40 dBi in the angular direction of X−4° and four nulls at a gain level of less than or equal to −30 dBi in the angular directions of X+2°, X−2°, X°, and X+4°. The beam P4 orthogonal to the beams 0, N2, P2, and N4 features a beam peak at a gain level of greater than 40 dBi in the angular direction of X+4° and four nulls at a gain level of less than or equal to −30 dBi in the angular directions of X−2°, X+2°, X°, and X−4°.

The tabulation in FIG. 3A shows that the isolations among the five HP beams are better than 30 dB or 70 dB. Referring to FIG. 3A, in the angular direction of X°, the beam 0 in receiving features a directional gain of greater than 40 dBi while each of the beams N2, N4, P2, and P4 in receiving features a directional gain of less than or equal to −30 dBi. There shall be a very small “leakage” from the radiation of the satellite S2 at X° to each of the beams N2, N4, P2, and P4, but a strong directional gain for the beam 0 for the same radiation from the satellite S2 at X°. There is an isolation or difference of greater than 70 dB in strengths for received signals originated from the same satellite S2 among the beams 0, N2, N4, P2 and P4. The isolation of the receiving beam 0 against any one of the receiving beams N2, N4, P2 and P4 in the angular direction of X° is better than 70 dB.

In the angular direction of X−2°, the beam N2 in receiving features a directional gain of greater than 40 dBi while each of the beams 0, N4, P2, and P4 in receiving features a directional gain of less than or equal to −30 dBi. There shall be a very small “leakage” from the radiation of the satellite S1 at X−2° to each of the beams 0, N4, P2, and P4, but a strong directional gain for the beam N2 for the same radiation from the satellite S1 at X−2°. There is an isolation or difference of greater than 70 dB in strengths for received signals originated from the same satellite S1 among the beams 0, N2, N4, P2 and P4. The isolation of the receiving beam N2 against any one of the receiving beams 0, N4, P2 and P4 in the angular direction of X−2° is better than 70 dB.

In the angular direction of X+2°, the beam P2 in receiving features a directional gain of greater than 40 dBi while each of the beams 0, N2, N4, and P4 in receiving features a directional gain of less than or equal to −30 dBi. There shall be a very small “leakage” from the radiation of the satellite S3 at X+2° to each of the beams 0, N2, N4, and P4, but a strong directional gain for the beam P2 for the same radiation from the satellite S3 at X+2°. There is an isolation or difference of greater than 70 dB in strengths for received signals originated from the same satellite S3 among the beams 0, N2, N4, P2 and P4. The isolation of the receiving beam P2 against any one of the receiving beams 0, N2, N4 and P4 in the angular direction of X+2° is better than 70 dB.

In the angular direction of X−4°, the beam N4 in receiving features a directional gain of greater than 40 dBi while each of the beams 0, N2, P2, and P4 in receiving features a directional gain of less than or equal to −30 dBi. There shall be a very small “leakage” from the radiation of the satellite S4 at X−4° to each of the beams 0, N2, P2, and P4, but a strong directional gain for the beam N4 for the same radiation from the satellite S4 at X−4°. There is an isolation or difference of greater than 70 dB in strengths for received signals originated from the same satellite S4 among the beams 0, N2, N4, P2 and P4. The isolation of the receiving beam N4 against any one of the receiving beams 0, N2, P2 and P4 in the angular direction of X−4° is better than 70 dB.

In the angular direction of X+4°, the beam P4 in receiving features a directional gain of greater than 40 dBi while each of the beams 0, N2, P2, and N4 in receiving features a directional gain of less than or equal to −30 dBi. There shall be a very small “leakage” from the radiation of the satellite S5 at X+4° to each of the beams 0, N2, P2, and N4, but a strong directional gain for the beam P4 for the same radiation from the satellite S5 at X+4°. There is an isolation or difference of greater than 70 dB in strengths for received signals originated from the same satellite S5 among the beams 0, N2, N4, P2 and P4. The isolation of the receiving beam P4 against any one of the receiving beams 0, N2, P2 and N4 in the angular direction of X+4° is better than 70 dB.

Assuming the five satellites S1-S5 radiating same amounts of EIRP, the receiving sensitivity of the orthogonal beams 0, N2, N4, P2 and P4 over the five specified pointing angular directions may be examined. In the beam 0, the received “desired” signals from the satellite S2 will be at least 70 dB stronger than one of those “undesired” signals from the satellites S1, S3, S4 and S5; thus, there is isolation better than 70 dB in the beam 0 between the enhanced desired signals from the satellite S2 and the suppressed undesired signals from one of the other four satellites S1, S3, S4 and S5. In the beam N2, the received “desired” signals from the satellite S1 will be at least 70 dB stronger than one of those “undesired” signals from the satellites S2, S3, S4 and S5; thus, there is isolation better than 70 dB in the beam N2 between the enhanced desired signals from the satellite S1 and the suppressed undesired signals from one of the other four satellites S2, S3, S4 and S5. In the beam P2, the received “desired” signals from the satellite S3 will be at least 70 dB stronger than one of those “undesired” signals from the satellites S1, S2, S4 and S5; thus, there is isolation better than 70 dB in the beam P2 between the enhanced desired signals from the satellite S3 and the suppressed undesired signals from one of the other four satellites S1, S2, S4, and S5. In the beam N4, the received “desired” signals from the satellite S4 will be at least 70 dB stronger than one of those “undesired” signals from the satellites S1, S2, S3 and S5; thus, there is isolation better than 70 dB in the beam N4 between the enhanced desired signals from the satellite S4 and the suppressed undesired signals from one of the other four satellites S1, S2, S3 and S5. In the beam P4, the received “desired” signals from the satellite S5 will be at least 70 dB stronger than one of those “undesired” signals from the satellites S1, S2, S3 and S4; thus, there is isolation better than 70 dB in the beam P4 between the enhanced desired signals from the satellite S5 and the suppressed undesired signals from one of the other four satellites S1, S2, S3 and S4.

FIG. 3B shows a horizontally polarized (HP) radiation pattern for the orthogonal beam N2 having a beam peak at the angular direction of X−2° and four specified nulls at the angular directions of X−4°, X°, X+2°, and X+4°. Referring to FIG. 3B, the horizontal axis represents the azimuth ranging from X−10 to X+10 degrees; the vertical axis represents the radiation power gain ranging from −30 dBi to 45 dBi. The solid circle on the horizontal axis depicts the direction of the desired satellite S1 depicted in FIG. 2 and the four solid diamonds on the horizontal axis depict the directions of potential interferences radiated from the satellites S2, S3, S4 and S5 depicted in FIG. 2. Using a beam shaping technique such as orthogonal-beam technique based on beam weighting vectors calculated by an optimization algorithm, the radiation pattern shown in FIG. 3B is optimized with constraints for a direction and gain level of a beam peak, for directions and gain levels of nulls and for isolation of the gain level of the beam peak against each one of the gain levels of the nulls. For example, for the beam N2, the constraint for the beam peak may be set greater than 40 dBi in the angular direction of X−2° and the constraint for each of the nulls may be set less than or equal to −30 dBi in the angular directions of X°, X+2°, X−4° and X+4°. Alternatively, the constraint for the isolation of the gain level of the beam peak against each one of the gain levels of the nulls may be set greater than 70 dB. The peak gain for the beam N2 is above 40 dBi at the angle of X−2° while its gains at the angles of X−4°, X°, X+2°, and X+4° are all suppressed to below −30 dBi. Accordingly, the isolation of the gain for desired data streams or signals from the satellite S1 against the gain for potential interference from any one of the satellites S2, S3, S4 and S5 shall be better than 70 dB. In the other words, the beam N2 features spatial isolation better than 70 dB between the gain for the desired data streams from the satellite S1 at the angle of X−2° and the gain for potential interference radiated by one of the four satellites S2, S3, S4 and S5 at the angles of X°, X+2°, X−4° and X+4°.

Alternatively, the above orbital slots may not be equally spaced, and the minimum angular resolution is related to the aperture size of the reflector. The minimum orbital slots are regulated by the Federal Communications Commission (FCC) in U.S., and ITT internationally. However, the regulated minimum spacing among adjacent satellites at same frequency band covering common service areas on earth may heavily dependent on the stat-of-art technologies on ground and space allowing adjacent assets to operate independently or fully without destructive interferences mutually. For an alternate antenna (not shown), the satellites S1, S2, S3, S4, and S5 may be placed in the orbital slots of X−2°, X−1°, X+1°, X−4°, and X+4°, respectively. In this case, the beam N2 may be altered to have nulls in the directions of the satellites S2, S3, S4 and S5 in the respective orbital slots of X−1°, X+1°, X−4° and X+4°. These nulls at the angles of X−4°, X−1°, X+1°, and X+4° are for suppressing gain for received signals originated from the satellites S2, S3, S4 and S5 while the beam peak in the direction of the satellite S1 in the orbital slot of X−2° is for enhancing received signals originated from the satellite S1. Since the specified constraints between a null and a beam peak is reduced to 1 degree from 2 degrees (using an antenna design for the pattern depicted in FIG. 3B as the reference design), the optimized aperture may result in significantly increased size in the azimuth direction, or significant compromising in the peak gain at the beam peak at X−2° and null depth at X−1°. Similarly, the beams 0, P2, N4 and P4 shall be modified and re-optimized in the new designs to become orthogonal to the beam N2. That is, the beam 0 may be altered to have nulls in the directions of the satellites S1, S3, S4 and S5 in the respective space slots of X−2°, X+1°, X−4° and X+4° and a beam peak in the direction of satellite S2 in the space slot of X−1°; the beam P2 may be altered to have nulls in the directions of the satellites S1, S2, S4 and S5 in the respective space slots of X−2°, X−1°, X−4° and X+4° and a beam peak in the direction of satellite S3 in the space slot of X+1°; the beam N4 may be altered to have nulls in the directions of the satellites S1, S2, S3 and S5 in the respective space slots of X−2°, X−1°, X+1° and X+4° and a beam peak in the direction of satellite S4 in the space slot of X−4°; the beam P4 may be altered to have nulls in the directions of the satellites S1, S2, S3 and S4 in the respective space slots of X−2°, X−1°, X+1° and X−4° and a beam peak in the direction of satellite S5 in the space slot of X+4°.

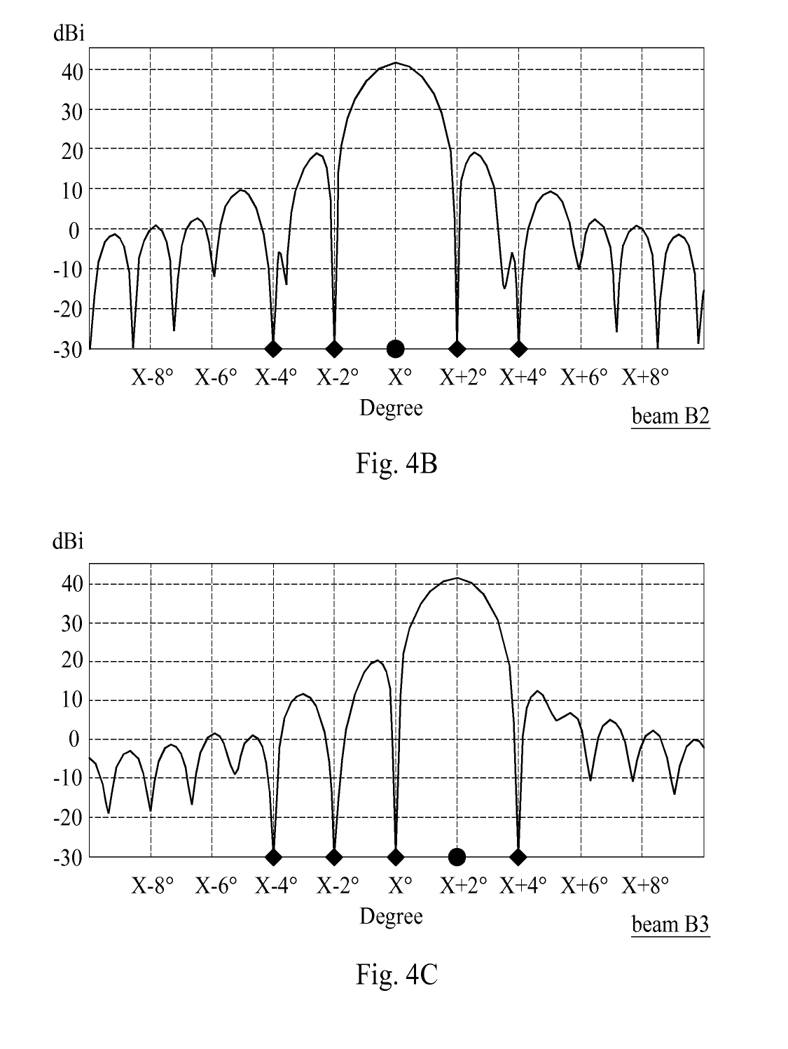

Coming back to the scenarios with references of equally spaced orbital slots as depicted in FIG. 2, FIGS. 4A, 4B and 4C depict radiation/reception patterns, or simply radiation patterns for short from here on, for three computer simulated performance of three concurrent orthogonal beams (OBs) B1, B2 and B3, which are concurrently generated in real time by a satellite ground terminal (hereinafter referred to as ground terminal ST) at a satellite communications frequency band (e.g. Ka band, L band, C band, X band, or Ku band). The orthogonal beams B1, B2 and B3 may be designed via an optimized beam shaping technique in computers based on beam weighting vectors calculated by an optimization algorithm. The optimized shaped radiation patterns of the beams B1, B2 and B3 may be implemented via analogue beam forming networks or digital beam forming networks for transmit and/or receiving functions in the satellite ground terminal ST for real time operations. For dynamic operations, such as mobile terminals or terminals for non-stationary satellites including those in low earth orbit (LEO), those in medium earth orbit (MEO), and/or those in non-geostationary orbit (non-GEO), these beam-forming network (BFN) functions must be dynamically optimized. In these scenarios, a real time optimization is warranted. Referring to the radiation patterns depicted in FIGS. 4A, 4B and 4C, the horizontal axis represents the azimuth ranging from X−10 to X+10 degrees; the vertical axis represents the radiation power gain ranging from −30 dBi to 45 dBi.

Referring to FIGS. 4A, 4B and 4C, the three simultaneous orthogonal beams B1, B2 and B3 are orthogonal to each other and may be, but not limited to, three horizontally polarized (HP) beams, three vertically polarized (VP) beams, three right hand circular polarized (RHCP) beams, or three left hand circular polarized (LHCP) beams. Each of the orthogonal beams B1, B2 and B3 has a beam peak pointed to a corresponding one of the above-mentioned satellites S1, S2 and S3 (e.g. three Ka DBS satellites) in the satellite orbital slots of X−2°, X° (borsight), and X+2°.

The satellite ground terminal ST includes an antenna and an analogue or digital beam forming network to simultaneously form the orthogonal beams B1, B2 and B3 each featuring an enhanced gain in a direction of incoming data streams or received signals originated from one of the satellites S1-S3 and suppressed gains in the directions of incoming undesired data streams or undesired received signals originated from the others of the satellites S1-S3 as well as from the satellites S4 and S5. The antenna of the satellite ground terminal ST may be, for example, a multiple-beam antenna (MBA) including an offset parabolic reflector with an aperture size of, e.g., x1 cm in azimuth and x2 cm in elevation and a feed array with at least five closely-separated waveguide/horn feeds arranged on or closely on a focal arc of the offset parabolic reflector, where “x1” ranges from 55 cm to 85 cm, and “x2” ranges from 45 cm to 75 cm. For example, the aperture may have a dimension of 80-cm by 50-cm, 65-cm by 65-cm, 65-cm by 50-cm, or 55-cm by 50-cm. The spacing between neighboring two of the feeds shall be about 1 wavelength of the carrier apart, wherein a minimum spacing between the neighboring two of the feeds may be slightly greater than 0.5 wavelengths of the carrier normally to avoid “cutoff” in the waveguide/horn feeds. The five feeds may be designed for a Ka-band reflector antenna with the ratio F/D of its focal length F to an aperture diameter D being approximately 1, which controls the aperture taper efficiency and the spillover efficiency of the antenna, and with an aperture of approximately 80 cm. Thereby, multiple beams may be formed with beam spacing of about 2° in azimuth. For example, the optimal spacing between the neighboring two of the feeds may be about 2 cm, greater than the wavelength of the carrier, in the case that the feeds are arranged on its focal arc and receive signals at 20 GHz in Ka band. These feeds are arranged along an axis parallel to the local geosynchronous earth orbit (GEO) arc extending in the equatorial plane of the earth. The offset parabolic reflector features but not limited to a focal length of 50 cm, and each feed generates a radiation pattern having a main lobe with a peak, i.e. unshaped beam peak, pointed to a specific satellite orbital slot (e.g. GEO slot). In this case, a first one of the feeds may generate a radiation pattern with an unshaped beam peak pointed to the satellite orbital slot of X−2°; a second one of the feeds may generate a radiation pattern with an unshaped beam peak pointed to the satellite orbital slot of X°; a third one of the feeds may generate a radiation pattern with an unshaped beam peak pointed to the satellite orbital slot of X+2°; a fourth one of the feeds may generate a radiation pattern with an unshaped beam peak pointed to the satellite orbital slot of X−4°; a fifth one of the feeds may generate a radiation pattern with a beam peak pointed to the satellite orbital slot of X+4°. Alternatively, the antenna of the satellite ground terminal ST may be a direct radiating array including multiple flat panels having a uniform size (e.g. 10-cm by 50-cm) or various sizes.

Referring to FIG. 4A, the radiation pattern for the beam B1 is designed with a peak of its main lobe in the direction of a desired satellite, i.e. the satellite S1 in the orbital slot of X−2°, and four nulls in the four respective directions of potential interferences radiated from the satellites S2, S3, S4 and S5 in the four respective orbital slots of X°, X+2°, X−4°, and X+4°. For the beam B1, the peak gain of its main lobe is above 40 dBi pointed in the direction of the orbital slot of X−2° while its nulls with suppressed gains in the directions pointed to the orbital slots of X−4°, X°, X+2° and X+4° are all less than −30 dBi. In accordance with the beam B1, the isolations of the desired data streams or signals originated from the satellite S1 in the orbital slot of X−2° against its potential interference from any one of the satellites S2, S3, S4 and S5 in the respective orbital slots of X°, X+2°, X−4° and X+4° are better than 70 dB.

Referring to FIG. 4B, the radiation pattern for the beam B2 is designed with a peak of its main lobe in the direction of a desired satellite, i.e. the satellite S2 in the orbital slot of X°, and four nulls in the four respective directions of potential interferences radiated from the satellites S1, S3, S4 and S5 in the four respective orbital slots of X−2°, X+2°, X−4° and X+4°. For the beam B2, the peak gain of its main lobe is above 40 dBi pointed in the direction of the orbital slot of X° while its nulls with suppressed gains in the directions pointed to the orbital slots of X−4°, X−2°, X+2°, and X+4° are all less than −30 dBi. In accordance with the beam B2, the isolations of the desired data streams or signals originated from the satellite S2 in the orbital slot of X° against its potential interference from any one of the satellites S1, S3, S4 and S5 in the respective orbital slots of X−2°, X+2°, X−4° and X+4° is better than 70 dB.

Referring to FIG. 4C, the radiation pattern for the beam B3 is designed with a peak of its main lobe in the direction of a desired satellite, i.e. the satellite S3 in the orbital slot of X+2°, and four nulls in the four respective directions of potential interferences radiated from the satellites S1, S2, S4 and S5 in the four respective orbital slots of X−2°, X°, X−4° and X+4°. For the beam B3, the peak gain of its main lobe is above 40 dBi pointed in the direction of the orbital slot of X+2° while its nulls with suppressed gains in the directions pointed to the orbital slots of X−2°, X°, X−4° and X+4° are all less than −30 dBi. In accordance with the beam B3, the isolations of the desired data streams or signals originated from the satellite S3 in the orbital slot of X+2° against its potential interference from any one of the satellites S1, S2, S4 and S5 in the respective orbital slots of X−2°, X°, X−4° and X+4° is better than 70 dB.

Referring to FIGS. 4A, 4B and 4C, solid circles depict the directions of desired satellites, in which their peaks shall be pointed respectively, and solid diamonds depict the directions of potential interferences, in which their nulls shall be pointed respectively. For each of the three beams B1-B3, its beam peak in the direction of the desired data streams or signals from one of the satellites S1-S5 is optimized for maximum gain while its beam nulls are formed and steered to the directions of potential interferences from the others of the satellites S1-S5. The isolation of the receiving beam B1 against either one of the receiving beams B2 and B3 in the angular direction of X−2° is better than 70 dB. The isolation of the receiving beam B2 against either one of the receiving beams B1 and B3 in the angular direction of X° is better than 70 dB. The isolation of the receiving beam B3 against either one of the receiving beams B1 and B2 in the angular direction of X+2° is better than 70 dB. Therefore, the isolations among the beams B1, B2 and B3 are better than 70 dB.

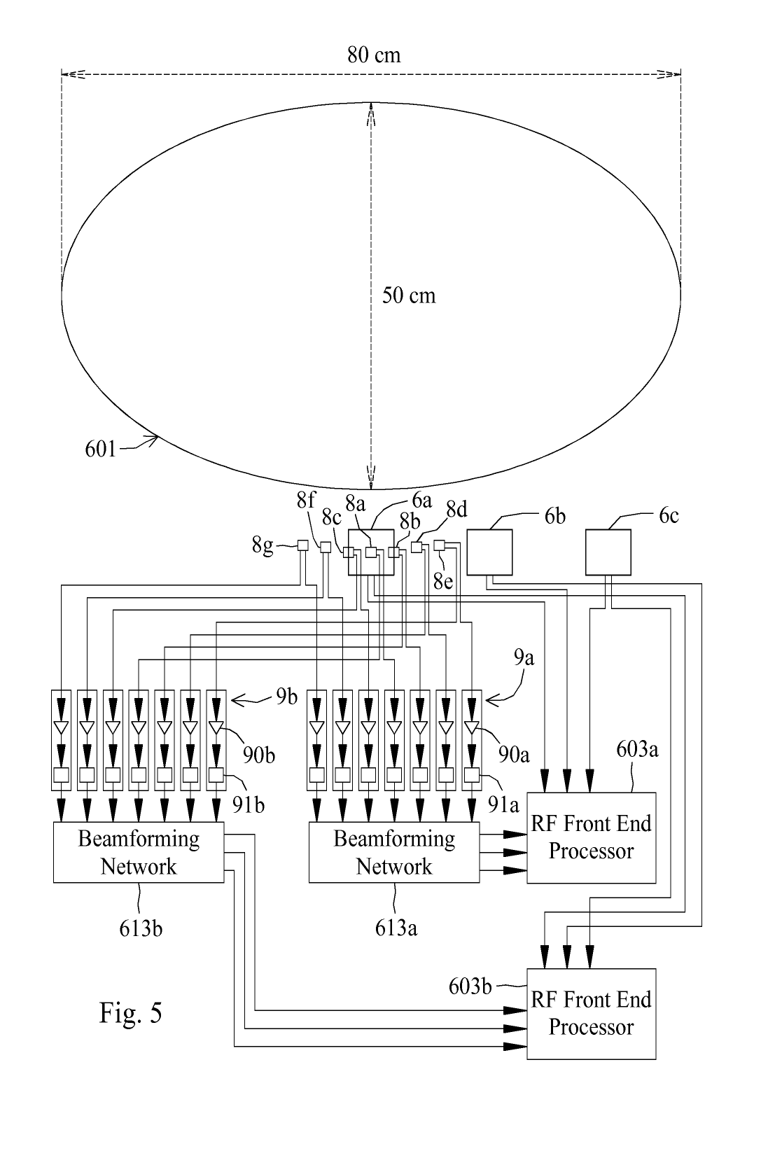

FIG. 5 depicts a simplified block diagram of receiving functions of an outdoor unit of a satellite ground terminal for simultaneously receiving signals or data streams originated from the Ka-band satellites S1, S2, and S3 in the orbital slots at X−2°, X°, and X+2° by three concurrent orthogonal beams at the same frequency in Ka band. In this embodiment, the satellite ground terminal may be, but not limited to, a DBS TV terminal capable of concurrently communicating with satellites in Ka bands and Ku bands and may be reference to the ground terminal (GT) as mentioned above.

Referring to FIG. 5, the outdoor unit includes two RF front end processors 603a and 603b, two analogue beamforming networks (BFNs) 613a and 613b, seven conditioners 9a, seven conditioners 9b, and a multiple-beam antenna (MBA) having, e.g., an offset parabolic dish or reflector 601 with a suitable aperture size, three Ku-band feeds 6a-6c, and seven Ka-band feeds 8a-8g. Each of the conditioners 9a includes, for example, a Ka-band low-noise amplifier (LNA) 90a and a band-pass filter (BPF) 91a. Each of the conditioners 9b includes, for example, a Ka-band LNA 90b and a BPF 91b. Each of the feeds 6a-6c and 8a-8g may be a receiving dual polarization feed and includes first and second output ports.

The seven Ka-band LNAs 90a of the conditioners 9a are coupled to and arranged downstream of the seven first output ports of the Ka-band feeds 8a-8g, respectively. The seven Ka-band LNAs 90b of the conditioners 9b are coupled to and arranged downstream of the second output ports of the Ka-band feeds 8a-8g, respectively. The seven band-pass filters 91a are coupled to and arranged downstream of the seven Ka-band LNAs 90a, respectively. The seven band-pass filters 91b are coupled to and arranged downstream of the seven Ka-band LNAs 90b, respectively. The analogue BFN 613a is coupled to and arranged downstream of the seven band-pass filters 91a. The analogue BFN 613b is coupled to and arranged downstream of the seven band-pass filters 91b. The RF front end processor 603a is coupled to and arranged downstream of the analogue BFN 613a and the first output ports of the Ku-band feeds 6a-6c. The RF front end processor 603b is coupled to and arranged downstream of the analogue BFN 613b and the second output ports of the Ku-band feeds 6a-6c.

The aperture size of the parabolic dish or reflector 601 is optimally decided according to two requirements of the desired directional gains, i.e. beam peaks of orthogonal beams generated by the analogue BFN 613a or 613b, each enhancing a corresponding one of the signals or data streams from the Ka-band satellites S1-S3 and minimum isolations of the signals or data streams from one of the Ka-band satellites S1-S5 against those from the others of the Ka-band satellites S1-S5. In this embodiment, the aperture size of the parabolic dish or reflector 601 is 80 cm in azimuth by 50 cm in elevation, or 32 inches in azimuth by 20 inches in elevation. For a group of the targeted satellite orbital slots of X−4°, X−2°, X°, X+2° and X+4° uniformly spaced by 2° with distributions as depicted in FIG. 2, the aperture of the parabolic dish or reflector 601 with a dimension of 54 wavelengths in azimuth by 33 wavelengths in elevation, for example, is adequate of meeting the above-mentioned two requirements when the aperture receives the signals or data streams in Ka band from the satellites S1-S5. In addition, the aperture may also service three orbital slots of Ku band satellites which are separated by 9°. Alternatively, the aperture size of the parabolic dish or reflector 601 may be x1 cm in azimuth and x2 cm in elevation, where “x1” ranges from 55 cm to 85 cm, and “x2” ranges from 45 cm to 75 cm. Each of the Ku-band feeds 6a-6c generates a beam with a peak pointed to a Ku-band satellite in one of orbital slots of X°, X+9°, and X+18°. The number of the Ka-band feeds 8a-8g is more than the number of the satellite orbital slots of X−2°, X°, X+2°, X−4° and X+4° allocated for the satellites S1, S2, S3, S4 and S5.

The three Ka-band feeds 8a-8c are placed on the focus arc of the reflector 601, but the four Ka-band feeds 8d-8g are placed slightly off the focus arc of the reflector 601. The four defocused feeds 8d-8g feature broader coverage and lower gains. The three Ka-band feeds 8a-8c are referred to as focus feeds, which feature three element beams with main lobes pointed at X°, X−2°, and X+2°, respectively. The four Ka-band feeds 8d-8g are referred to as defocused feeds, each featuring a broad beam covering satellites in multiple satellite orbital slots either of a group of X°, X−2°, and X−4° or of another group of X°, X+2°, and X+4°. The Ka-band feeds 8a-8g are, but limited to, nearly equally spaced. At Ka band, neighboring two of these feeds 8a-8g may be spaced by 2 cm. The Ka-band feeds 8a-8g may be, for example, circularly or linearly polarized feeds with, e.g., a spacing ranging from 0.5 to 3 wavelengths. A simple Gaussian feed model or precision feed model at Ka band may be used to set up proper edge tapers on reflector illumination. For many Ka band applications operating over a wide bandwidth, isolations via nulling among multiple beams operating over a broad bandwidth are required. One cost effectively technique is to enable the outdoor unit capable of forming multiple orthogonal beams with broad nulls (in angles) for Ka band operations in receiving. In order to gain more degrees of freedoms in designs of shaped patterns, these approaches shall require more feeds than the number of the satellite orbital slots in the field of the view of the antenna. With regard to the defocusing techniques, these feeds 8d-8g may be arranged away from the focal arc of the reflector 601, and the reflector 601 may be under-sized, or equivalently over-illuminated by the feeds 8a-8g, with respect to a −10 dB optimal aperture taper of the reflector 601. Thereby, the element beams of the feeds 8d-8g each may feature a corresponding main lobe with a peak gain lower than those of the main lobes of the element beams of the feeds 8a-8c arranged on the focal arc of the reflector 601 and feature a broad coverage for their individual secondary radiation patterns of the feeds 8d-8g illuminating the reflector 601.

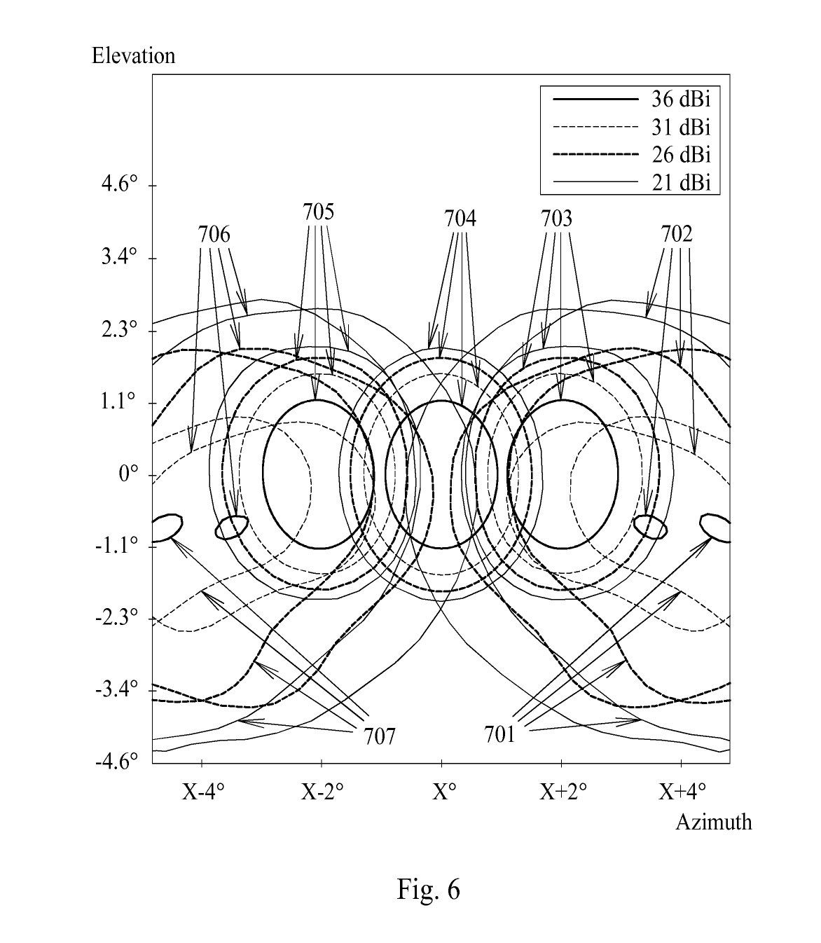

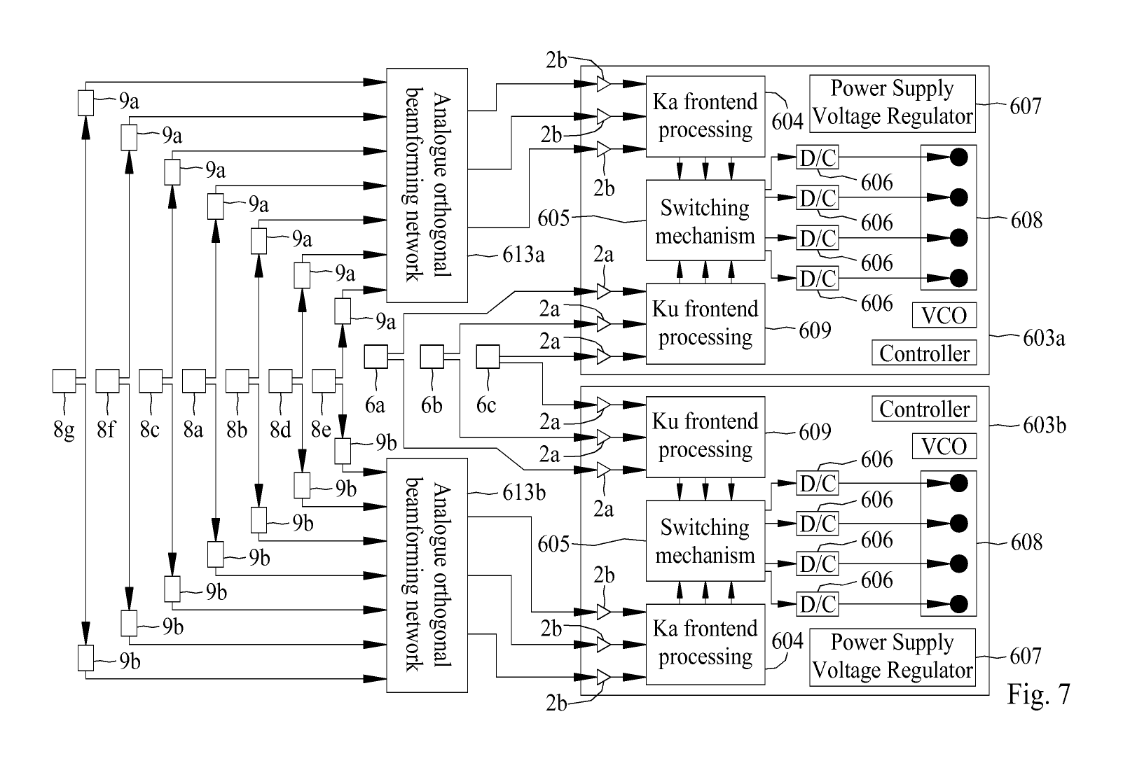

FIG. 6 depicts seven (simulated) secondary radiation/reception patterns of the seven feeds 8a-8g for Ka band illuminating the 80-cm by 50-cm reflector 601. They include contours 701 of a secondary radiation/reception pattern of the feed 8g, contours 702 of a secondary radiation/reception pattern of the feed 8f, contours 703 of a secondary radiation/reception pattern of the feed 8c, contours 704 of a secondary radiation/reception pattern of the feed 8a, contours 705 of a secondary radiation/reception pattern of the feed 8b, contours 706 of a secondary radiation/reception pattern of the feed 8d, and contours 707 of a secondary radiation/reception pattern of the feed 8e. The secondary radiation/reception patterns defined by the contours 703, 704 and 705 are produced by the focus feeds 8a-8c near or on the focal arc of the reflector 601 and feature elliptical beams with beam peaks in the directions of the satellite orbital slots of X+2°, X° and X−2° respectively. The peaks of the three element patterns defined by the contours 703, 704 and 705 are on 0° elevation angle. Furthermore, the element beam, pointed to X° in azimuth, defined by the contours 704 features a peak gain slightly over 41 dBi while the two element beams, respectively pointed to X−2° and X+2° in azimuth, defined by the contours 703 and 705 each feature a peak gain slightly less but very near 41 dBi. The secondary radiation/reception patterns defined by the contours 701, 702, 706 and 707 feature de-focused radiation characteristics and each feature a broad beam covering satellites in satellite orbital slots either of a group of X°, X−2°, and X−4° or of another group of X°, X+2°, and X+4°.

Referring to FIGS. 5 and 6, the feed 8g features an element beam pointed at X+4.6°, covering multiple orbital slots including the orbital slots at the angles of X−2°, X°, X+2°, X−4° and X+4°, defined by the contours 701 of the secondary radiation/reception pattern. The feed 8f features an element beam pointed at X+3.4°, covering the orbital slots including the orbital slots at the angles of X−2°, X°, X+2°, X−4° and X+4°, defined by the contours 702 of the secondary radiation/reception pattern. The feed 8c features an element beam pointed at X+2° defined by the contours 703 of the secondary radiation/reception pattern. The feed 8a features an element beam pointed at X° defined by the contours 704 of the secondary radiation/reception pattern. The feed 8b features an element beam pointed at X−2° defined by the contours 705 of the secondary radiation/reception pattern. The feed 8d features an element beam pointed at X−3.4°, covering orbital slots including the orbital slots at the angles of X−2°, X°, X+2°, X−4° and X+4°, defined by the contours 706 of the secondary radiation/reception pattern. The feed 8e features an element beam pointed at X−4.6°, covering orbital slots including the orbital slots at the angles of X−2°, X°, X+2°, X−4° and X+4°, defined by the contours 707 of the secondary radiation/reception pattern.

Referring to FIG. 5, Ka-band signals or data streams of dual polarizations (e.g. horizontal and vertical polarizations, or right hand and left hand circular polarizations) from Ka-band satellites (e.g. the satellites S1-S5 depicted in FIG. 2) are received or collected by each of the Ka-band feeds 8a-8g. Next, each of the feeds 8a-8g features two outputs, i.e., a first Ka-band signal or data stream of a first polarization in an analog format from its first output port and a second Ka-band signal or data stream of a second polarization in an analog format from its second output port. For example, the first polarization may be a vertical polarization, and the second polarization may be a horizontal polarization. Alternatively, the first polarization may be a right hand circular polarization, and the second polarization may be a left hand circular polarization. The first Ka-band signals or data streams of the first polarization from the first output ports of the feeds 8a-8g are sent to the conditioners 9a, each of which conditions the corresponding one of the first Ka-band signals or data streams of the first polarization and features a corresponding output, i.e. a corresponding first conditioned signal or data stream of the first polarization in Ka band, to the analogue BFN 613a. Concurrently, the second Ka-band signals or data streams of the second polarization from the second output ports of the feeds 8a-8g are sent to the conditioners 9b, each of which conditions the corresponding one of the second Ka-band signals or data streams of the second polarization and features a corresponding output, i.e. a corresponding second conditioned signal or data stream of the second polarization in Ka band, to the analogue BFN 613b.

In this embodiment, the first Ka-band signals or data streams of the first polarization from the first output ports of the feeds 8a-8g are amplified by the LNAs 90a of the conditioners 9a so as to form first amplified signals or data streams of the first polarization in Ka band. The first amplified signals or data streams of the first polarization are then sent to the band-pass filters 91a of the conditioners 9a, which pass the first amplified signals or data streams of the first polarization only in a certain band of frequencies while attenuating the first amplified signals or data streams of the first polarization outside the certain band so as to form first band-pass filtered signals or data streams, i.e. the first conditioned signals or data streams of the first polarization, as the outputs of the conditioner 9a. The second Ka-band signals or data streams of the second polarization from the second output ports of the feeds 8a-8g are amplified by the LNAs 90b of the conditioners 9b so as to form second amplified signals or data streams of the second polarization in Ka band. The second amplified signals or data streams of the second polarization are then sent to the band-pass filters 91b of the conditioners 9b, which pass the second amplified signals or data streams of the second polarization only in a certain band of frequencies while attenuating the second amplified signals or data streams of the second polarization outside the certain band so as to form second band-pass filtered signals or data streams, i.e. the second conditioned signals or data streams of the second polarization, as the outputs of the conditioner 9b.

The analogue BFN 613a generates at least three simultaneous fixed or dynamic orthogonal beams (hereinafter referred to as orthogonal beams A1, A2, and A3) in the first polarization at a specified frequency band (e.g. Ka band in this embodiment) based on the above first conditioned signals or data streams from the conditioners 9a. Concurrently, the analogue BFN 613b generates at least three simultaneous fixed or dynamic orthogonal beams (hereinafter referred to as orthogonal beams A4, A5, and A6) in the second polarization at the specified frequency band based on the above second conditioned second signals or data streams from the conditioners 9b. The orthogonal beams (OBs) A1-A3 are orthogonal to one another and sent to the RF front end processor 603a, and the orthogonal beams (OBs) A4-A6 are orthogonal to one another and sent to the RF front end processor 603b. The orthogonal beams (OBs) B1-B3 depicted in FIGS. 4A-4C may be reference to the respective OBs A1-A3 generated by the analogue BFN 613a and the respective OBs A4-A6 generated by the analogue BFN 613b. The beam A1 may be substantially the same as the beam A4; the beam A2 may be substantially the same as the beam A5; the beam A3 may be substantially the same as the beam A6.

Each of the concurrent OBs A1-A6, generated from the analogue BFNs 613a and 613b, features a peak of a main lobe in a desired direction for enhancing gain for concurrently collected signals or data streams from the desired direction at a specific frequency slot in the specified frequency band and multiple nulls in the other directions for suppressing gain for concurrently collected signals or data streams from the other directions at the same frequency slot. The analogue BFN 613a performs three sets of weighting and summing operations concurrently on received element signals, i.e. the corresponding ones of the above first conditioned signals or data streams, so as to simultaneously form the orthogonal beams A1-A3. The analogue BFN 613b performs three sets of weighting and summing operations concurrently on received element signals, i.e. the corresponding ones of the above second conditioned signals or data streams, so as to simultaneously form the orthogonal beams A4-A6. Each operation of a weighted sum, or equivalently a linear combination, of the received element signals, i.e. the first conditioned signals or data streams, performed by the analogue BFN 613a is to form a corresponding one of the orthogonal beams A1-A3. Each operation of a weighted sum, or equivalently a linear combination, of the received element signals, i.e. the second conditioned signals or data streams, performed by the analogue BFN 613b is to form a corresponding one of the orthogonal beams A4-A6. Each set of in-phase/quadrature-phase (I/Q) weighting coefficients, or equivalently simple amplitude and phase weightings, performed in the analogue BFN 613a, may be used to weigh the received element signals, i.e. the first conditioned signals or data streams, so as to form a corresponding one of the orthogonal beams A1-A3. Each set of in-phase/quadrature-phase (I/Q) weighting coefficients, or equivalently simple amplitude and phase weightings, performed in the analogue BFN 613b, may be used to weigh the received element signals, i.e. the second conditioned signals or data streams, so as to form a corresponding one of the orthogonal beams A4-A6. The amplitude and phase weightings are calculated or altered based on performance constraints, such as directions and gain values of various beam peak and beam nulls, via an optimization process. Each of the OBs A1-A6 is formed by a linear combination of the element beams, defined by the contours 701-707 of the secondary radiation/reception patterns, illustrated in FIG. 6. In one example, the OBs B1, B2 and B3 illustrated in FIGS. 4A, 4B and 4C may be the three respective OBs A1-A3 or A4-A6.

FIG. 7 depicts a simplified block diagram of two RF front end processors 603a and 603b. Each of the RF front end processors 603a and 603b includes: (1) at least three Ku-band LNAs 2a connected to and arranged downstream of the first or second output ports of the Ku-band feeds 6a-6c; (2) at least three Ka-band buffer amplifiers 2b connected to and arranged downstream of the analog BFN 613a or 613b; (3) a Ka-band front end electronic or processing unit 604 coupled to and arranged downstream of the buffer amplifiers 2b; (4) a Ku-band front end electronic or processing unit 609 coupled to and arranged downstream of the LNAs 2a; (5) a switching mechanism 605 coupled to and arranged downstream of the units 604 and 609; (6) multiple frequency down converters (D/Cs) 606 (e.g. for converting input signals or data streams from Ku/Ka band to L band) coupled to and arranged downstream of the switching mechanism 605; (7) a controller controlling which of the inputs from the units 604 and 609 to the switch mechanism 605 are selected by the switch mechanism 605; (8) a voltage-controlled oscillator (VCO) generating a reference clock, based on a voltage controlled by the controller, to the units 604 and 609, the switch mechanism 605, the D/Cs 606 and the controller; (9) a power supply 607 supplying power to the LNAs 2a, the buffer amplifiers 2b, the units 604 and 609, the switching mechanism 605, the D/Cs 606, the controller and the VCO; and (10) multiple input/output (I/O) ports 608 coupled to and arranged downstream of the D/Cs 606 for connections to an indoor unit of the satellite ground terminal via, e.g., parallel coaxial cables, optical fibers, wireless transmission, or a cable or optical fiber by using time division multiplexing transmission, frequency division multiplexing transmission, or code division multiplexing transmission. The switching mechanism 605 has N inputs coupled to the units 604 and 609 and M outputs coupled to the D/Cs 606, where “N” is a positive integer such as 6, and “M” is a positive integer such as 4.

Referring to FIGS. 5 and 7, the Ka-band orthogonal beams A1-A3 from the analogue BFN 613a to the processor 603a and Ku-band signals or data streams from the first output ports of the Ku-band feeds 6a-6c to the processor 603a may have the same linear polarization format, such as vertical polarization, while the Ka-band orthogonal beams A4-A6 from the analogue BFN 613b to the processor 603b and Ku-band signals or data streams from the second output ports of the Ku-band feeds 6a-6c to the processor 603b may have the same linear polarization format, such as horizontal polarization. Alternatively, the Ka-band orthogonal beams A1-A3 from the analogue BFN 613a to the processor 603a and the Ku-band signals or data streams from the first output ports of the Ku-band feeds 6a-6c to the processor 603a may have the same circular polarization format, such as right hand circular polarization, while the Ka-band orthogonal beams A4-A6 from the analogue BFN 613b to the processor 603b and the Ku-band signals or data streams from the second output ports of the Ku-band feeds 6a-6c to the processor 603b may have the same circular polarization format, such as left hand circular polarization. Alternatively, the Ka-band orthogonal beams A1-A3 from the analogue BFN 613a to the processor 603a and the Ku-band signals or data streams from the first output ports of the Ku-band feeds 6a-6c to the processor 603a may have different polarization formats, while the Ka-band orthogonal beams A4-A6 from the analogue BFN 613b to the processor 603b and the Ku-band signals or data streams from the second output ports of the Ku-band feeds 6a-6c to the processor 603b may have different polarization formats. For example, the Ka-band orthogonal beams A1-A3 from the analogue BFN 613a to the processor 603a may have vertical polarization; the Ka-band orthogonal beams A4-A6 from the analogue BFN 613b to the processor 603b may have horizontal polarization; the Ku-band signals or data streams from the first output ports of the Ku-band feeds 6a-6c to the processor 603a may have right hand circular polarization; the Ku-band signals or data streams from the second output ports of the Ku-band feeds 6a-6c to the processor 603b may have left hand circular polarization.

Referring to FIG. 7, the Ku-band LNAs 2a in the respective processors 603a and 603b amplify the Ku-band signals or data streams from the Ku-band feeds 6a-6c and output the amplified Ku-band signals or data streams to the units 609 in the respective processors 603a and 603b. The Ka-band buffer amplifiers 2b in the processor 603a amplify Ka-band signals or data streams, i.e. the OBs A1-A3 in Ka band, from the analogue BFN 613a the and output the amplified Ka-band signals or data streams, i.e. the amplified OBs A1-A3 in Ka band, to the unit 604 in the processor 603a. The Ka-band buffer amplifiers 2b in the processor 603b may amplify Ka-band signals or data streams, i.e. the OBs A4-A6 in Ka band, from the analogue BFN 613b and output the amplified Ka-band signals or data streams, the amplified OBs A4-A6 in Ka band, to the unit 604 in the processor 603b.

Referring to FIG. 7, each of the units 604 may include frequency down converters to convert the amplified Ka-band signals or data streams from the Ka-band buffer amplifiers 2a or 2b into ones in Ku band such that the switching mechanism 605 may be simplified as both the inputs from the units 604 and 609 are in Ku band. Alternatively, each of the units 609 may include frequency up converters to convert the amplified Ku-band signals or data streams from the LNAs 2a into ones in a Ka band such that the switching mechanism 605 may be simplified as both the inputs from the units 604 and 609 are in Ka band. Optionally, both of the units 604 in the processors 603a and 603b may include analog-to-digital converters to convert the amplified orthogonal beams in an analog format into a digital format; both of the units 609 in the processors 603a and 603b may include analog-to-digital converters to convert the amplified Ka-band signals or data streams in an analog format into a digital format. Thereby, the switching mechanism 605 may process the inputs in a digital format. Otherwise, the switching mechanism 605 may process the inputs in an analog format. The switching mechanism 605 may select one of the inputs to be output to one of the D/Cs 606. The output signals or data streams at Ku or Ka band from the switching mechanism 605 are frequency-down-converted by the D/Cs 606 into multiple down-converted signals at a lower frequency band, such as L band, and then the down-converted signals are sent to the I/O ports 608, which are connected to an indoor unit of the satellite ground terminal via, e.g., parallel coaxial cables, optical fibers, or other means including wireless transmission. The two BFNs 613a and 613b and the two RF front end processors 603a and 603b are for processing of dual polarized received signals concurrently, that is, the first conditioned signals or data streams of the first polarization and the second conditioned signals or data streams of the second polarization may be concurrently processed by the BFNs 613a and 613b respectively, and the OBs A1-A3 of the first polarization and the OBs A4-A6 of the second polarization may be concurrently processed by the RF front end processors 603a and 603b respectively. The dual polarizations may be arranged as two linearly polarized (LP) signals; usually horizontally polarized (HP) and vertically polarized (VP) signals. They may also be circularly polarized (CP) signals in forms of right-hand CP (RHCP) and left-hand CP (LHCP) signals.

Referring to FIG. 5, the two analogue BFNs 613a and 613b may be two beam forming networks for linearly polarized (LP) signals: for example, the analogue BFN 613a may be configured to process the conditioned signals or data streams in a vertical polarization (VP) from the conditioners 9a, and the analogue BFN 613b may be configured to process the conditioned signals or data streams in a horizontal polarization (HP) from the conditioners 9b. Alternatively, the two analogue BFNs 613a and 613b may be two beam forming networks for circularly polarized (CP) signals: for example, the analogue BFN 613a may be configured to process the conditioned signals or data streams in a right hand circular polarization (RHCP) from the conditioners 9a, and the analogue BFN 613b may be configured to process the conditioned signals or data streams in a left hand circular polarization (LHCP) from the conditioners 9b. In the case of the above analogue BFNs 613a and 613b for LP signals, the OBs A1-A3 may be vertically polarized (VP) beams, and the OBs A4-A6 may be horizontally polarized (HP) beams. In the case of the above analogue BFNs 613a and 613b for CP signals, the OBs A1-A3 may be right hand circular polarized (RHCP) beams, and the OBs A4-A6 may be left hand circular polarized (LHCP) beams.

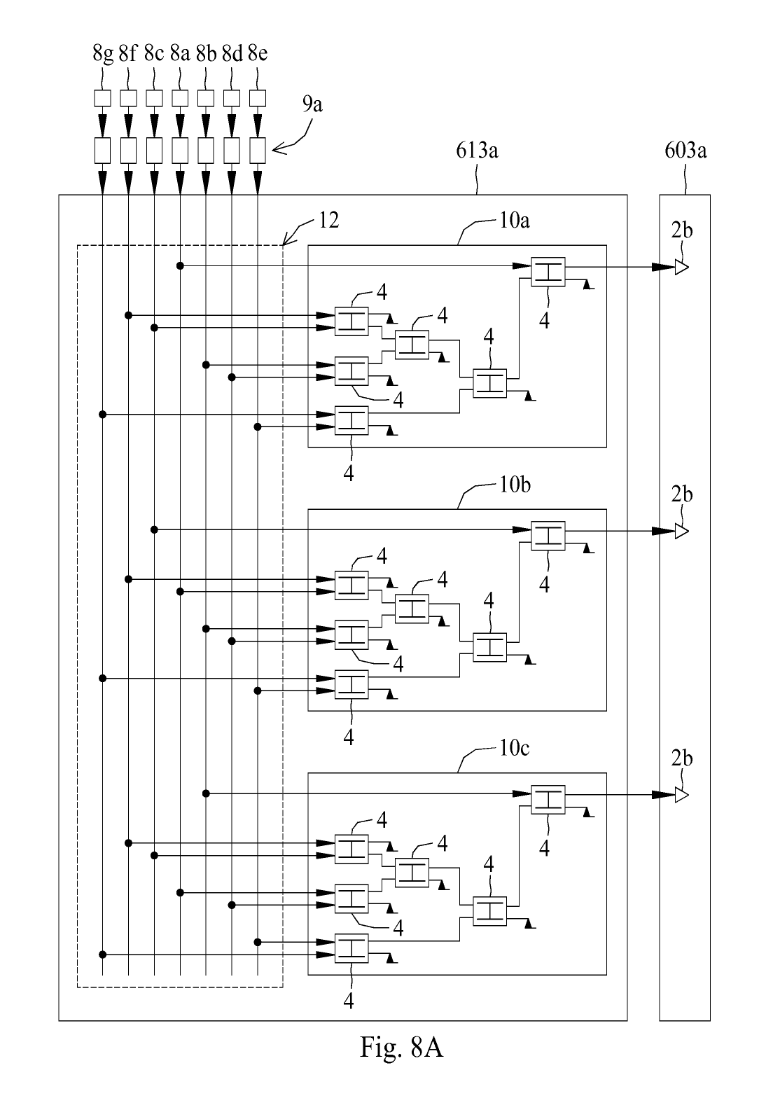

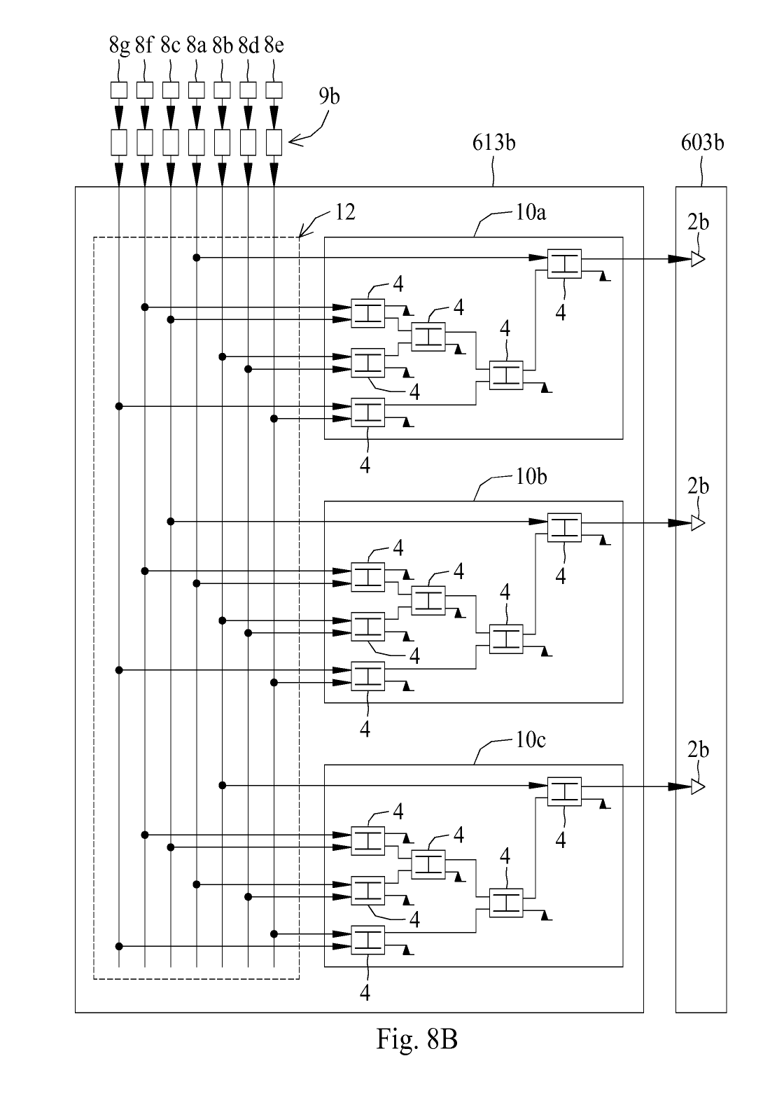

Each of the analogue BFNs 613a and 613b operates in a given frequency band (e.g. Ka band in this embodiment, Ku band, L band, C band, or X band) and may be implemented in a low-temperature co-fired ceramic (LTCC), a printed circuit board (PCB), or a semiconductor chip. As shown in FIGS. 8A and 8B, each of the analogue BFNs 613a and 613b includes, but not limited to, a power dividing network or matrix 12 coupled to the conditioners 9a or 9b and at least three hybrid networks 10a, 10b and 10c coupled to the power dividing network or matrix 12. Each of the hybrid networks 10a, 10b and 10c includes multiple hybrids 4 (e.g. six hybrids in this embodiment) and may be implemented by multi-layered circuits, such as microstrips, strip-lines, and/or coplanar waveguides, acting as transmission lines, formed in the LTCC, PCB or semiconductor chip. Each of the hybrids 4 has two inputs (hereinafter referred to as input A and input B) and two outputs (hereinafter referred to as output A and output B) each containing information associated with its two inputs A and B. That is, the output A may be a linear combination of the input A weighted or multiplied by a first complex number plus the input B weighted or multiplied by a second complex number, and the output B may be a linear combination of the input A weighted or multiplied by a third complex number plus the input B weighted or multiplied by a fourth complex number. The lengths of the transmission lines interconnecting the hybrids 4 are used for “phasing”, or phase weighting on various element signals. In this embodiment, each of the hybrids 4 includes: (1) a first input coupled to an output of another one of the hybrids 4 or to one of the conditioners 9a or 9b; and (2) a second input coupled to an output of another one of the hybrids 4 or to another one of the conditioners 9a or 9b. Also, each of the hybrids 4 includes: (1) a first output coupled to the ground; and (2) a second output coupled to an input of another one of the hybrids 4 or to the processor 603a or 603b.

Referring to FIG. 8A, using the power dividing network or matrix 12, each of the first conditioned signals or data streams from the conditioners 9a is divided into at least three power-divided signals or data streams with equal or unequal amplitude or power, which are then sent to the hybrid networks 10a, 10b and 10c, respectively. Therefore, each of the hybrid networks 10a, 10b and 10c receives at least seven power-divided signals or data streams, containing information associated with the seven respective signals or data streams received or collected by the feeds 8a-8g, from the power dividing network or matrix 12, each of which may be sent to one of the hybrids 4. The hybrid networks 10a, 10b and 10c of the analogue BFN 613a generate the OBs A1, A2, and A3, respectively, based on the power-divided signals or data streams from the power dividing network or matrix 12 of the analogue BFN 613a. Next, the Ka-band signals or data streams, i.e. the OBs A1-A3, are sent to the buffer amplifiers 2b of the processor 603a depicted in FIG. 7, respectively, so as to be amplified by the buffer amplifiers 2b of the processor 603a, respectively, and then be processed by the unit 604 of the processor 603a depicted in FIG. 7.

FIG. 8A depicts an architecture of forming the three orthogonal beams A1-A3 in the first polarization based on the first Ka-band signals or data streams of the first polarization from the seven elements or feeds 8a-8g via three respective analogue beam-forming units, each of which includes one of the three hybrid networks 10a-10c for combining seven corresponding Ka-band inputs (i.e. the seven corresponding power-divided signals or data streams) into one Ka-band output (i.e. the corresponding one of the OBs A1-A3). Each of the analogue beam-forming units performs a linear combination (equivalently a weighted sum), as its Ka-band output, of the seven corresponding Ka-band inputs with a beam weighting vector (BWV) specifying weighting components for the linear combination. The Ka-band output may be a linear combination of the Ka-band inputs weighted or multiplied by the respective weighting components in the BWV. There are three BWVs for the three orthogonal beams A1-A3. In order to design an orthogonal beam in the output from one of the beam-forming units, coupling coefficients of the six hybrids 4 of the BFN 613a may be optimized to efficiently control the amplitudes of input signals, i.e. the Ka-band inputs, while phase adjustments of the input signals, i.e. the Ka-band inputs, are accomplished by trimming path lengths in and/or between the hybrids 4.

Referring to FIG. 8B, using the power dividing network or matrix 12, each of the second conditioned signals or data streams from the conditioners 9b is divided into at least three power-divided signals or data streams with equal or unequal amplitude or power, which are then sent to the hybrid networks 10a, 10b and 10c, respectively. Therefore, each of the hybrid networks 10a, 10b and 10c receives at least seven power-divided signals or data streams, containing information associated with the seven respective signals or data streams received or collected by the feeds 8a-8g, from the power dividing network or matrix 12, each of which may be sent to one of the hybrids 4. The hybrid networks 10a, 10b and 10c of the analogue BFN 613b generate the OBs A4, A5, and A6, respectively, based on the power-divided signals or data streams from the power dividing network or matrix 12 of the analogue BFN 613b. Next, the Ka-band signals or data streams, i.e. the OBs A4-A6, are sent to the buffer amplifiers 2b of the processor 603b depicted in FIG. 7, respectively, so as to be amplified by the buffer amplifiers 2b of the processor 603b, respectively, and then be processed by the unit 604 of the processor 603b.

FIG. 8B depicts an architecture of forming the three orthogonal beams A4-A6 in the second polarization based on the second Ka-band signals or data streams of the second polarization from the seven elements or feeds 8a-8g via three respective analogue beam-forming units, each of which includes one of the three hybrid networks 10a-10c for combining seven Ka-band inputs (i.e. the seven corresponding power-divided signals or data streams) into one Ka-band output (i.e. the corresponding one of the OBs A4-A6). Each of the analogue beam-forming units performs a linear combination (equivalently a weighted sum), as its Ka-band output, of the seven corresponding Ka-band inputs with a beam weighting vector (BWV) specifying weighting components for the linear combination. The Ka-band output may be a linear combination of the Ka-band inputs weighted or multiplied by the respective weighting components in the BWV. There are three BWVs for the three orthogonal beams A4-A6. In order to design an orthogonal beam in the output from one of the beam-forming units, coupling coefficients of the six hybrids 4 of the BFN 613b may be optimized to efficiently control the amplitudes of input signals, i.e. the Ka-band inputs, while phase adjustments of the input signals, i.e. the Ka-band inputs, are accomplished by trimming path lengths in and/or between the hybrids 4.

Alternatively, the outdoor unit depicted in FIGS. 5 and 7 may include (1) multiple first frequency-down converters (not shown) coupled to and arranged downstream of the BFN 613a, coupled to and arranged upstream of the processor 603a and configured to convert the beams A1-A3 in Ka band into ones in Ku band and (2) multiple second frequency-down converters (not shown) coupled to and arranged downstream of the BFN 613b, coupled to and arranged upstream of the processor 603b and configured to convert the beams A4-A6 in Ka band into ones in Ku band while each of the processors 603a and 603b includes (1) at least three Ku-band buffer amplifiers, instead of the amplifiers 2b, coupled to and arranged downstream of the first or second frequency-down converters and configured to amplify the corresponding frequency-down converted beams A1-A3 or A4-A6 and (2) a Ku-band front end electronic or processing unit (hereinafter referred to as Ku-band frontend unit FN), instead of the unit 604, coupled to and arranged downstream of the Ku-band buffer amplifiers and coupled to and arranged upstream of the switching mechanism 605. In this case, the first frequency-down converters down convert the respective OBs A1-A3 in Ka band into ones in Ku band, which are respectively sent to the Ku-band buffer amplifiers of the processor 603a; concurrently, the second frequency-down converters down convert the respective OBs A4-A6 in Ka band into ones in Ku band, which are respectively sent to the Ku-band buffer amplifiers of the processor 603b. Next, the Ku-band buffer amplifiers of the processor 603a, coupled to and arranged downstream of the first frequency-down converters, amplify the frequency-down converted beams A1-A3 in Ku band so as to generate multiple first amplified Ku-band signals or data streams, which are sent to the Ku-band frontend unit FN of the processor 603a. Concurrently, the Ku-band buffer amplifiers of the processor 603b, coupled to and arranged downstream of the second frequency-down converters, amplify the frequency-down converted beams A4-A6 in Ku band so as to generate multiple second amplified Ku-band signals or data streams, which are sent to the Ku-band frontend unit FN of the processor 603b. After that, each of the switching mechanisms 605 of the processors 603a and 603b may be simplified as its inputs from the two Ku-band units FN and 609 of the processor 603a or 603b are all in Ku band.

Alternatively, the above-mentioned first frequency-down converters may be built in the BFN 613a and configured to convert the first conditioned signals or data streams in Ka band into ones in Ku band, and the above-mentioned second frequency-down converters may be built in the BFN 613b and configured to convert the second conditioned signals or data streams in Ka band into ones in Ku band. The first frequency-down converters built in the BFN 613a may be coupled to and arranged upstream of the power dividing network or matrix 12 and coupled to and arranged downstream of the conditioners 9a, and the second frequency-down converters built in the BFN 613b may be coupled to and arranged upstream of the power dividing network or matrix 12 and coupled to and arranged downstream of the conditioners 9b. In this case, the BFN 613a features its outputs coupled to the above-mentioned Ku-band buffer amplifiers of the processor 603a, and the BFN 613b features its outputs coupled to the above-mentioned Ku-band buffer amplifiers of the processor 603b.

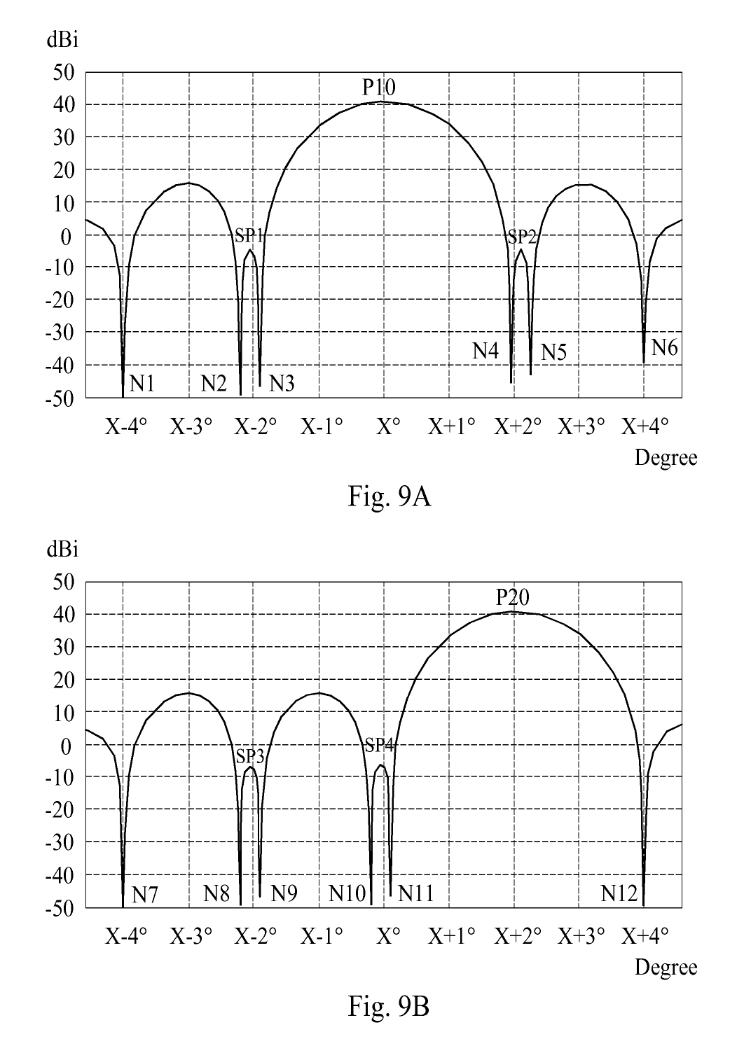

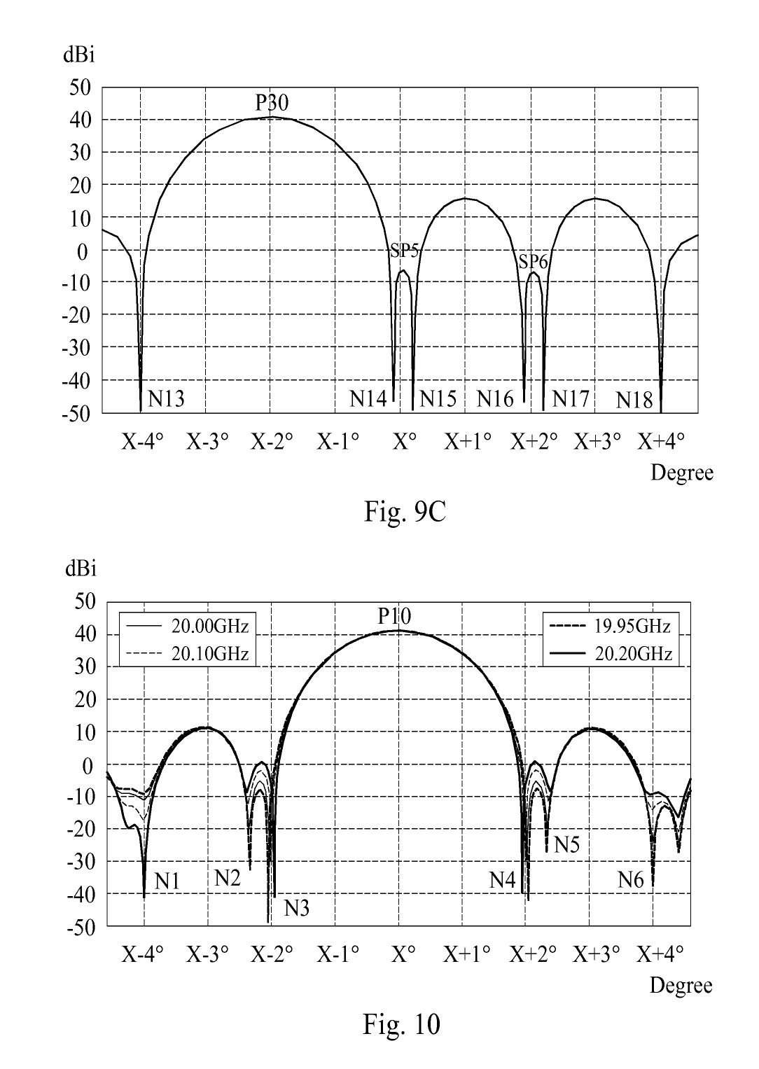

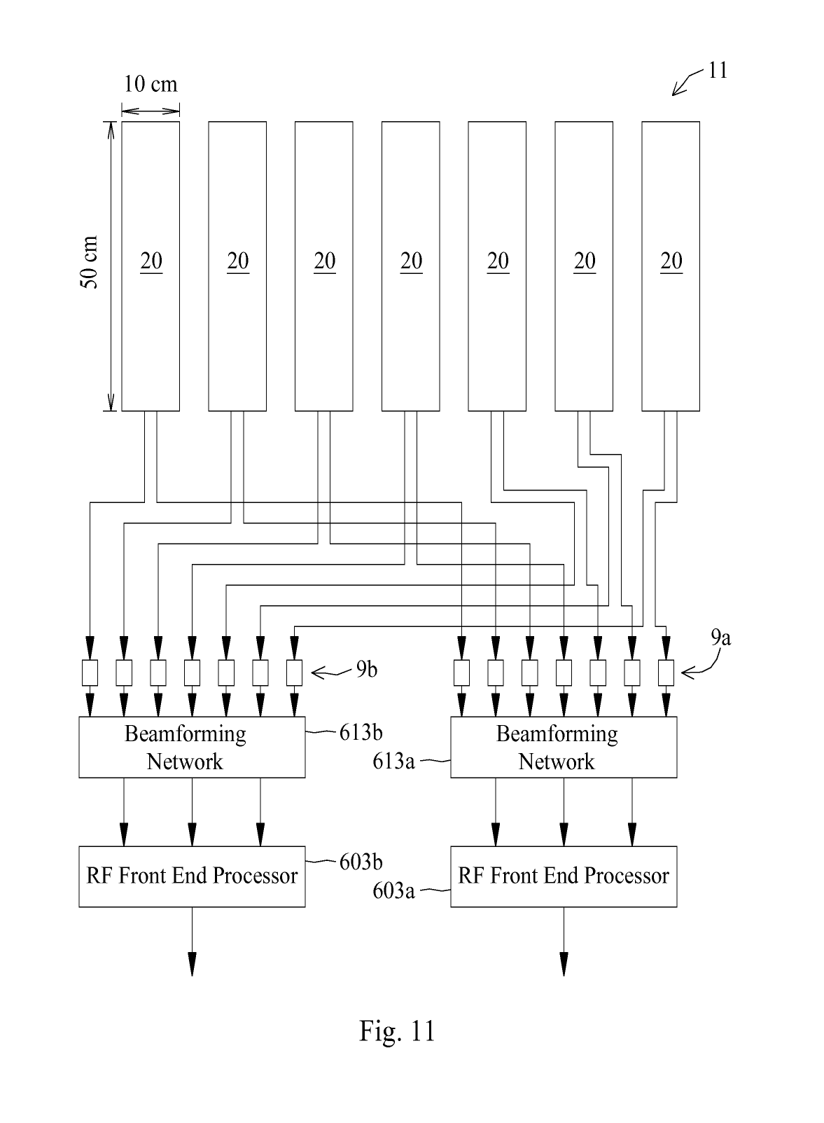

FIGS. 9A, 9B and 9C depicts three concurrent broad-null beams generated by an analogue or digital beamforming network (e.g. the analogue BFN 613a or 613b) processing signals or data streams received or collected by an antenna via a beam shaping technique such as orthogonal-beam technique. The shapes of the three broad-null beams depicted in FIGS. 9A-9C are based on beam weighting vectors (BWVs) calculated by an optimization algorithm. The antenna may be the multiple-beam antenna (MBA) illustrated in FIG. 5 including the offset parabolic dish or reflector 601, the Ku-band feeds 6a-6c, and the Ka-band feeds 8a-8g. Alternatively, the antenna may be a direct radiating array, as depicted in FIG. 11, including multiple flat panels having a uniform size (e.g. 10-cm by 50-cm) or various sizes. The antenna and the analogue or digital BFN are provided in a satellite ground terminal (e.g. the above terminal GT). The three beams depicted in FIGS. 9A-9C are orthogonal to each other, and the peak gains for the three beams depicted in FIGS. 9A-9C are greater than 40 dBi (e.g. ˜41 dBi in this embodiment).

Referring to FIG. 9A, the beam, such as boresight beam, features a peak, i.e. P10, of a main lobe in a desired direction, i.e. in the space slot of X°, of the satellite S2 for enhancing gain for signals or data streams, at a specific frequency slot in a frequency band (e.g. Ka band in the embodiment, Ku band, L band, C band, or X band), received from the satellite S2 and six deep nulls, i.e. N1-N6, in other corresponding directions for suppressing gain for signals or data streams, at the specific frequency slot, received from the satellites S1, S3, S4 and S5. The broad-null beam depicted in FIG. 9A may be formed by, e.g., using multiple sets of simple I/Q weightings or equivalently simple amplitude and phase weightings in an orthogonal beam forming technique, wherein the weightings of each set multiply or weigh respective signals or data streams received or collected from the antenna so as to form a corresponding set of weighted signals or data streams, and by summing the corresponding set of weighted signals.

Referring to FIG. 9A, the beam includes a beam peak P10 in the direction of X° (boresight), a null N1 in the direction of X−4°, two nulls N2 and N3 in the directions between X−1.5° and X−2.5°, two nulls N4 and N5 in the directions between X+1.5° and X+2.5°, and a null N6 in the direction of X+4°. The angular width between the nulls N2 and N3 may be defined as the angle between the nulls N2 and N3, which is between 0.05 and 0.5 degrees, between 0.05 and 1 degree, or between 0.1 and 0.6 degrees. The angular width between the nulls N4 and N5 may be defined as the angle between the nulls N4 and N5, which is between 0.05 and 0.5 degrees, between 0.05 and 1 degree, or between 0.1 and 0.6 degrees. There may be one or more nulls between the nulls N2 and N3 and one or more nulls between the nulls N4 and N5. Signals from the satellites S4 and S5 in the satellite orbital slots at X−4° and X+4° may be suppressed below −40 dBi based on the nulls N1 and N6, respectively.

The two nulls N2 and N3 are within 1 degree at a center of X−2° and separate from each other by less than 1 degree such as less than 0.5 degrees, between 0.05 and 0.5 degrees, between 0.05 and 1 degree, or between 0.1 and 0.6 degrees, for example, such that the gain at X−2° may be suppressed below 0 dBi no matter where the satellite ground terminal is set in the world and no matter which frequency slot in a frequency band (e.g. Ka band, Ku band, L band, C band, or X band) is used to communicate between the satellite ground terminal and the satellite S2 in the satellite orbital slot at X°. Particularly, the beam depicted in FIG. 9A has a peak SP1 of a side lobe, below greater than 30 dB or 40 dB from the beam peak P10, between the two nulls N2 and N3, which may be suppressed at a gain level less than 0 dBi. Thereby, the beam depicted in FIG. 9A has a first broad null substantially in the satellite orbital slot of X−2°, and thus Ka-band signals from the satellite S1 in the satellite orbital slot X−2° may be suppressed by a radiation pattern null with directional gain less than 0 dBi.

The two nulls N4 and N5 are within 1 degree at a center of X+2° and separate from each other by less than 1 degree such as less than 0.5 degrees, between 0.05 and 0.5 degrees, between 0.05 and 1 degree, or between 0.1 and 0.6 degrees, for example, such that the gain at X+2° may be suppressed below 0 dBi no matter where the satellite ground terminal is set in the world and no matter which frequency slot in a frequency band (e.g. Ka band, Ku band, L band, C band, or X band) is used to communicate between the satellite ground terminal and the satellite S2 in the satellite orbital slot at X°. Particularly, the beam depicted in FIG. 9A has a peak SP2 of a side lobe, below greater than 30 dB or 40 dB from the beam peak P10, between the two nulls N4 and N5, which may be suppressed at a gain level less than 0 dBi. Thereby, the beam depicted in FIG. 9A has a second broad null substantially in the satellite orbital slot of X+2°, and thus Ka-band signals from the satellite S3 in the satellite orbital slot X+2° may be suppressed by a radiation pattern null with directional gain less than 0 dBi.

The isolation of the gain for the desired data streams of signals from the satellite S2 in the satellite orbital slot of X°, i.e. at the beam peak P10, as illustrated in FIG. 9A, against the gain for potential interference from either of the satellites S1 and S3 in the respective satellite orbital slots of X−2° and X+2° is better than 30 or 40 dB, and the isolation of the gain for the desired data streams of signals from the satellite S2 in the satellite orbital slot of X°, i.e. at the beam peak P10, as illustrated in FIG. 9A, against the gain for potential interference from either of the satellites S4 and S5 in the respective satellite orbital slots of X−4° and X+4° is better than 70 dB. Therefore, the beam illustrated in FIG. 9A with the first and second broad nulls substantially in the satellite orbital slots of X±2° features spatial isolation better than 30 or 40 dB, between the gain for the desired data streams of signals from the satellite S2 in the satellite orbital slot of X°, i.e. at the beam peak P10, and the gain for potential interference radiated by either of the satellites S1 and S3 in the respective satellite orbital slots at X−2° and X+2°, and spatial isolation better than 70 dB, between the gain for the desired data streams of signals from the satellite S2 in the satellite orbital slot of X°, i.e. at the beam peak P10, and the gain for potential interference radiated by either of the satellites S4 and S5 in the respective satellite orbital slots at X−4° and X+4°.

Referring to FIG. 9B, the beam features a peak, i.e. P20, of a main lobe in a desired direction, i.e. in the space slot of X+2°, of the satellite S3 for enhancing gain for signals or data streams, at the specific frequency slot, received from the satellite S3 and six deep nulls, i.e. N7-N12, in other corresponding directions for suppressing gain for signals or data streams, at the specific frequency slot, received from the satellites S1, S2, S4 and S5. The broad-null beam depicted in FIG. 9B may be formed by, e.g., using multiple sets of simple I/Q weightings or equivalently simple amplitude and phase weightings in an orthogonal beam forming technique, wherein the weightings of each set multiply or weigh respective signals or data streams received or collected from the antenna so as to form a corresponding set of weighted signals or data streams, and by summing the corresponding set of weighted signals.

Referring to FIG. 9B, the beam includes a beam peak P20 in the direction of X+2°, a null N7 in the direction of X−4°, two nulls N8 and N9 in the directions between X−1.5° and X−2.5°, two nulls N10 and N11 in the directions between X−0.5° and X+0.5°, and a null N12 in the direction of X+4°. The angular width between the nulls N8 and N9 may be defined as the angle between the nulls N8 and N9, which is between 0.05 and 0.5 degrees, between 0.05 and 1 degree, or between 0.1 and 0.6 degrees. The angular width between the nulls N10 and N11 may be defined as the angle between the nulls N10 and N11, which is between 0.05 and 0.5 degrees, between 0.05 and 1 degree, or between 0.1 and 0.6 degrees. There may be one or more nulls between the nulls N8 and N9 and one or more nulls between the nulls N10 and N11. Signals from the satellites S4 and S5 in the satellite orbital slots at X−4° and X+4° may be suppressed below −40 dBi based on the nulls N7 and N12, respectively.

The two nulls N8 and N9 are within 1 degree at a center of X−2° and separate from each other by less than 1 degree such as less than 0.5 degrees, between 0.05 and 0.5 degrees, between 0.05 and 1 degree, or between 0.1 and 0.6 degrees, for example, such that the gain at X−2° may be suppressed below 0 dBi no matter where the satellite ground terminal is set in the world and no matter which frequency slot in a frequency band (e.g. Ka band, Ku band, L band, C band, or X band) is used to communicate between the satellite ground terminal and the satellite S3 in the satellite orbital slot at X+2°. Particularly, the beam depicted in FIG. 9B has a peak SP3 of a side lobe, below greater than 30 dB or 40 dB from the beam peak P20, between the two nulls N8 and N9, which may be suppressed at a gain level less than 0 dBi. Thereby, the beam depicted in FIG. 9B has a first broad null substantially in the satellite orbital slot of X−2°, and thus Ka-band signals from the satellite S1 in the satellite orbital slot X−2° may be suppressed by a radiation pattern null with directional gain less than 0 dBi.

The two nulls N10 and N11 are within 1 degree at a center of X° and separate from each other by less than 1 degree such as less than 0.5 degrees, between 0.05 and 0.5 degrees, between 0.05 and 1 degree, or between 0.1 and 0.6 degrees, for example, such that the gain at X° may be suppressed below 0 dBi no matter where the satellite ground terminal is set in the world and no matter which frequency slot in a frequency band (e.g. Ka band, Ku band, L band, C band, or X band) is used to communicate between the satellite ground terminal and the satellite S3 in the satellite orbital slot at X+2°. Particularly, the beam depicted in FIG. 9B has a peak SP4 of a side lobe, below greater than 30 dB or 40 dB from the beam peak P20, between the two nulls N10 and N11, which may be suppressed at a gain level less than 0 dBi. Thereby, the beam depicted in FIG. 9B has a second broad null substantially in the satellite orbital slot of X°, and thus Ka-band signals from the satellite S2 in the satellite orbital slot X° may be suppressed by a radiation pattern null with directional gain less than 0 dBi.

The isolation of the gain for the desired data streams of signals from the satellite S3 in the satellite orbital slot of X+2°, i.e. at the beam peak P20, as illustrated in FIG. 9B, against the gain for potential interference from either of the satellites S1 and S2 in the respective satellite orbital slots of X−2° and X° is better than 30 or 40 dB, and the isolation of the gain for the desired data streams of signals from the satellite S3 in the satellite orbital slot of X+2°, i.e. at the beam peak P20, as illustrated in FIG. 9B, against the gain for potential interference from either of the satellites S4 and S5 in the respective satellite orbital slots of X−4° and X+4° is better than 70 dB. Therefore, the beam illustrated in FIG. 9B with the first and second broad nulls substantially in the satellite orbital slots of X−2° and X° features spatial isolation better than 30 or 40 dB, between the gain for the desired data streams of signals from the satellite S3 in the satellite orbital slot of X+2°, i.e. at the beam peak P20, and the gain for potential interference radiated by either of the satellites S1 and S2 in the respective satellite orbital slots at X−2° and X°, and spatial isolation better than 70 dB, between the gain for the desired data streams of signals from the satellite S3 in the satellite orbital slot of X+2°, i.e. at the beam peak P20, and the gain for potential interference radiated by either of the satellites S4 and S5 in the respective satellite orbital slots at X−4° and X+4°.

Referring to FIG. 9C, the beam features a peak, i.e. P30, of a main lobe in a desired direction, i.e. in the space slot of X−2°, of the satellite S1 for enhancing gain for signals or data streams, at the specific frequency slot, received from the satellite S1 and six deep nulls, i.e. N13-N18, in other corresponding directions for suppressing gain for signals or data streams, at the specific frequency slot, received from the satellites S2, S3, S4 and S5. The broad-null beam depicted in FIG. 9C may be formed by, e.g., using multiple sets of simple I/Q weightings or equivalently simple amplitude and phase weightings in an orthogonal beam forming technique, wherein the weightings of each set multiply or weigh respective signals or data streams received or collected from the antenna so as to form a corresponding set of weighted signals or data streams, and by summing the corresponding set of weighted signals.

Referring to FIG. 9C, the beam includes a beam peak P30 in the direction of X−2°, a null N13 in the direction of X−4°, two nulls N14 and N15 in the directions between X−0.5° and X+0.5°, two nulls N16 and N17 in the directions between X+1.5° and X+2.5°, and a null N18 in the direction of X+4°. The angular width between the nulls N14 and N15 may be defined as the angle between the nulls N14 and N15, which is between 0.05 and 0.5 degrees, between 0.05 and 1 degree, or between 0.1 and 0.6 degrees. The angular width between the nulls N16 and N17 may be defined as the angle between the nulls N16 and N17, which is between 0.05 and 0.5 degrees, between 0.05 and 1 degree, or between 0.1 and 0.6 degrees. There may be one or more nulls between the nulls N14 and N15 and one or more nulls between the nulls N16 and N17. Signals from the satellites S4 and S5 in the satellite orbital slots at X−4° and X+4° may be suppressed below −40 dBi based on the nulls N13 and N18, respectively.

The two nulls N14 and N15 are within 1 degree at a center of X° and separate from each other by less than 1 degree such as less than 0.5 degrees, between 0.05 and 0.5 degrees, between 0.05 and 1 degree, or between 0.1 and 0.6 degrees, for example, such that the gain at X° may be suppressed below 0 dBi no matter where the satellite ground terminal is set in the world and no matter which frequency slot in a frequency band (e.g. Ka band, Ku band, L band, C band, or X band) is used to communicate between the satellite ground terminal and the satellite S1 in the satellite orbital slot at X−2°. Particularly, the beam depicted in FIG. 9C has a peak SP5 of a side lobe, below greater than 30 dB or 40 dB from the beam peak P30, between the two nulls N14 and N15, which may be suppressed at a gain level less than 0 dBi. Thereby, the beam depicted in FIG. 9C has a first broad null substantially in the satellite orbital slot of X°, and thus Ka-band signals from the satellite S2 in the satellite orbital slot X° may be suppressed by a radiation pattern null with directional gain less than 0 dBi.

The two nulls N16 and N17 are within 1 degree at a center of X+2° and separate from each other by less than 1 degree such as less than 0.5 degrees, between 0.05 and 0.5 degrees, between 0.05 and 1 degree, or between 0.1 and 0.6 degrees, for example, such that the gain at X+2° may be suppressed below 0 dBi no matter where the satellite ground terminal is set in the world and no matter which frequency slot in a frequency band (e.g. Ka band, Ku band, L band, C band, or X band) is used to communicate between the satellite ground terminal and the satellite S1 in the satellite orbital slot at X−2°. Particularly, the beam depicted in FIG. 9C has a peak SP6 of a side lobe, below greater than 30 dB or 40 dB from the beam peak P30, between the two nulls N16 and N17, which may be suppressed at a gain level less than 0 dBi. Thereby, the beam depicted in FIG. 9C has a second broad null substantially in the satellite orbital slot of X+2°, and thus Ka-band signals from the satellite S3 in the satellite orbital slot X+2° may be suppressed by a radiation pattern null with directional gain less than 0 dBi.

The isolation of the gain for the desired data streams of signals from the satellite S1 in the satellite orbital slot of X−2°, i.e. at the beam peak P30, as illustrated in FIG. 9C, against the gain for potential interference from either of the satellites S2 and S3 in the respective satellite orbital slots of X° and X+2° is better than 30 or 40 dB, and the isolation of the gain for the desired data streams of signals from the satellite S1 in the satellite orbital slot of X−2°, i.e. at the beam peak P30, as illustrated in FIG. 9C, against the gain for potential interference from either of the satellites S4 and S5 in the respective satellite orbital slots of X−4° and X+4° is better than 70 dB. Therefore, the beam illustrated in FIG. 9C with the first and second broad nulls substantially in the satellite orbital slots of X° and X+2° features spatial isolation better than 30 or 40 dB, between the gain for the desired data streams of signals from the satellite S1 in the satellite orbital slot of X−2°, i.e. at the beam peak P30, and the gain for potential interference radiated by either of the satellites S2 and S3 in the respective satellite orbital slots at X° and X+2°, and spatial isolation better than 70 dB, between the gain for the desired data streams of signals from the satellite S1 in the satellite orbital slot of X−2°, i.e. at the beam peak P30, and the gain for potential interference radiated by either of the satellites S4 and S5 in the respective satellite orbital slots at X−4° and X+4°.

In one example, the orthogonal beams A1, A2, and A3 may be the three broad-null orthogonal beams depicted in FIGS. 9A, 9B, and 9C, respectively. In addition, the orthogonal beams A4, A5, and A6 may be the three broad-null orthogonal beams depicted in FIGS. 9A, 9B, and 9C, respectively.

FIG. 10 depicts four beams generated by employing the same amplitude and phase weightings to weigh or multiply the received signals or data streams at various frequency slots of 19.95 GHz, 20.00 GHz, 20.10 GHz, and 20.20 GHz. Referring to FIG. 10, the four beams, such as boresite beams, each have a beam peak P10 in the direction of X° for enhancing gain for signals or data streams received from the space slot of X°, two deep nulls N2 and N3 in the directions between X−1.5° and X−2.5° for suppressing gain for signals or data streams received from the space slot of X−2°, two nulls N4 and N5 in the directions between X+1.5° and X+2.5° for suppressing gain for signals or data streams received from the space slot of X+2°, and two nulls N1 and N6 in the directions of X−4° and X+4° for suppressing gain for signals or data streams received from the space slots of X−4° and X+4°. The beam depicted in FIG. 9A may be reference to the respective beams depicted in FIG. 10, that is, each beam depicted in FIG. 10 has a beam peak, i.e. P10, with the same specification as that of the beam illustrated in FIG. 9A, six deep nulls, i.e. N1-N6, with the same specification as those of the beam illustrated in FIG. 9A, and first and second broad nulls, substantially in the satellite orbital slots of X+2° and X−2°, with the same specification as those of the beam illustrated in FIG. 9A.

As shown in FIG. 10, the gains at X+2°, X−2°, X+4°, and X−4° may be suppressed below 0 dBi no matter which frequency band in Ka band is used to communicate between the satellite ground terminal and the satellite S2 in the satellite orbital slot at X°. Each beam depicted in FIG. 10 with the first and second broad nulls substantially in the satellite orbital slots of X+2° and X−2° features spatial isolation better than 30 or 40 dB, between the gain for the desired data streams of signals from the satellite S2 in the satellite orbital slot of X°, i.e. at the beam peak P10, and the gain for potential interference radiated by either of the satellites S1, S3, S4, and S5 in the respective satellite orbital slots at X−2°, X+2°, X−4°, and X+4°.

Alternatively, a multiple-aperture technology may be employed herein. The multiple-beam antenna depicted in FIG. 5 may have multiple parabolic dishes or reflectors, each illuminated by one or more of the three Ku-band feeds 6a-6c and the seven Ka-band feeds 8a-8g, instead of the parabolic dish or reflector 601. For example, the multiple-beam antenna has two parabolic dishes or reflectors; one of the parabolic dish or reflector is illuminated by the feeds 8a-8g and the other one of the parabolic dish or reflector is illuminated by the feeds 6a-6c. Alternatively, the multiple-beam antenna has three parabolic dishes or reflectors; one of the parabolic dish or reflector is illuminated by the feeds 6a, 8a and 8b, another one of the parabolic dish or reflector is illuminated by the feeds 6b, 8c and 8d, and the other one of the parabolic dish or reflector is illuminated by the feeds 6c, 8e, 8f and 8g. Alternatively, a toroidal reflector may be used to instead of the offset parabolic dish or reflector 601.

FIG. 11 depicts another outdoor unit of a satellite ground terminal for simultaneously receiving signals or data streams originated from the above-mentioned Ka-band satellites S1, S2, and S3 in the satellite orbital slots at X−2°, X°, and X+2° by concurrent orthogonal beams at the same frequency in Ka band. Referring to FIG. 11, a direct radiating array 11 with seven elements or feeds 20 are used instead of the multiple-beam antenna (MBA) having the reflector 601 and the feeds 6a-6c and 8a-8g depicted in FIGS. 5, 7, 8A, and 8B. In this embodiment of FIG. 11, the Ka-band LNAs 90a of the conditioners 9a depicted in FIG. 5 are coupled to and arranged downstream of first input ports of the elements or feeds 20, respectively, and the Ka-band LNAs 90b of the conditioners 9b depicted in FIG. 5 are coupled to and arranged downstream of second input ports of the elements or feeds 20, respectively. Each of the elements or feeds 20 receives or collects Ka-band signals or data streams of dual polarizations from the Ka-band satellites S1-S5 and outputs a first Ka-band signal or data stream of a first polarization in an analog format from its first output port and a second Ka-band signal or data stream of a second polarization in an analog format from its second output port. The first polarization may be vertical polarization, and the second polarization may be horizontal polarization. Alternatively, the first polarization may be right hand circular polarization, and the second polarization may be left hand circular polarization. The first and second Ka-band signals or data streams from the first and second output ports of the seven elements or feeds 20 are then sent to the conditioners 9a and 9b and conditioned by the conditioners 9a and 9b, as illustrated in FIG. 5. The seven elements or feeds 20 may be seven flat panels having a uniform size (e.g. 10-cm by 50-cm) or various sizes. Next, as illustrated in FIGS. 5, 7, 8A and 8B, the conditioned signals or data streams from the conditioners 9a and 9b are sent to the analogue BFNs 613a and 613b to generate the above-mentioned concurrent orthogonal beams A1-A6 to be sent to the RF front end processors 603a and 603b in the outdoor unit for performing the interfacing processing to the orthogonal beams A1-A6 as above mentioned. The outputs from the RF front end processors 603a and 603b shall be sent to an indoor unit of the satellite ground terminal for further receiving processing.

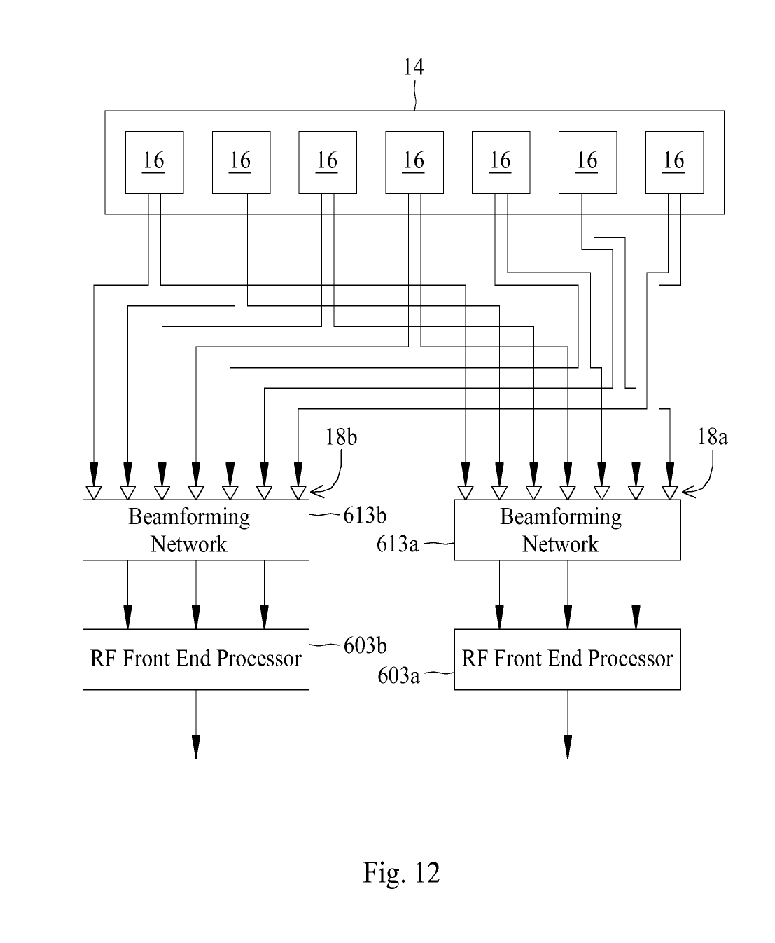

FIG. 12 depicts another outdoor unit of a satellite ground terminal for simultaneously receiving signals or data streams originated from the above-mentioned Ka-band satellites S1, S2, and S3 in the satellite orbital slots at X−2°, X°, and X+2° by three concurrent orthogonal beams at the same frequency in an alternative frequency band (e.g. L band, C band, X band, or Ku band). Referring to FIG. 12, the outdoor unit of the satellite ground terminal includes: (1) an antenna 14 with multiple elements or feeds 16; (2) multiple low-noise block down-converters (LNBs) 18a and 18b; (3) the two above-mentioned analogue BFNs 613a and 613b coupled to and arranged downstream of the two respective sets of LNBs 18a and 18b; and (4) the two above-mentioned RF front end processors 603a and 603b coupled to and arranged downstream of the two respective analogue BFNs 613a and 613b. Each of the processors 603a and 603b has input/output (I/O) ports for connection to an indoor unit of the satellite ground terminal via, e.g., parallel coaxial cables, optical fibers, wireless transmission, or a cable or optical fiber by using time division multiplexing transmission, frequency division multiplexing transmission, or code division multiplexing transmission. The LNBs 18a are coupled to and arranged downstream of first output ports of the elements or feeds 16, respectively, and the LNBs 18b are coupled to and arranged downstream of second output ports of the elements or feeds 16, respectively. The antenna 14 may be, for example, the multiple-beam antenna (MBA) depicted in FIG. 5, which includes the offset parabolic dish or reflector 601, the Ku-band feeds 6a-6c (not shown in FIG. 12), and the Ka-band feeds 8a-8g as the elements or feeds 16. Alternatively, the antenna 14 may be the direct radiating array 11 depicted in FIG. 11, which includes the flat panels 20 as the elements or feeds 16. Comparing to the architecture depicted in FIG. 5 or 11, the conditioners 9a and 9b are replaced with the LNBs 18a and 18b for not only amplifying the first and second Ka-band signals or data streams output from the feeds 8a-8g or the elements 20 but converting the first and second Ka-band signals or data streams into ones in an intermediate frequency (IF) at a lower frequency band, such as L band, C band, X band, or Ku band. Thereby, the analogue BFNs 613a and 613b process the received signals or data streams in the IF band, as illustrated in FIGS. 8A and 8B, so as to generate the concurrent orthogonal beams A1-A3 in the IF band to the buffer amplifiers 2b of the processor 603a and generate the concurrent orthogonal beams A4-A6 in the IF band to the buffer amplifiers 2b of the processor 603b. The RF front end processor 603a may perform interfacing processing functions to the orthogonal beams A1-A3 in the IF band; the RF front end processor 603b may perform interfacing processing functions to the orthogonal beams A4-A6 in the IF band. The outputs from the RF front end processors 603a and 603b may be sent to the indoor unit for further receiving processing through various transmission media, such as parallel coaxial cables, optical fibers, or short range wireless communication. Alternatively, referring to FIG. 12, the LNBs 18a may be built in the analogue BFN 613a, and the LNBs 18b may be built in the analogue BFN 613b.

Referring to FIG. 12, in each of the RF front end processors 603a and 603b depicted in FIG. 7, the front end processing units 604 may include frequency-down converters or frequency-up converters to convert the orthogonal beams A1-A6 in the lower frequency band into ones in another frequency band, such as L band, C band, X band, Ku band or Ka band, that may be the same as the signals or data streams output from the Ku front end processing units 609 to the switching mechanism 605 such that the switching mechanism 605 may process the signals or data streams in the same frequency band from the units 604 and 609. Alternatively, in each of the RF front end processors 603a and 603b depicted in FIG. 7, the Ku front end processing units 609 may include frequency-down converters or frequency-up converters to convert the signals or data streams in Ku band from the feeds 6a-6c into ones in another frequency band, such as L band, C band, X band, or Ka band, that may be the same as the signals or data streams output from the Ka front end processing units 604 to the switching mechanism 605 such that the switching mechanism 605 may process the signals or data streams in the same frequency band from the units 604 and 609.

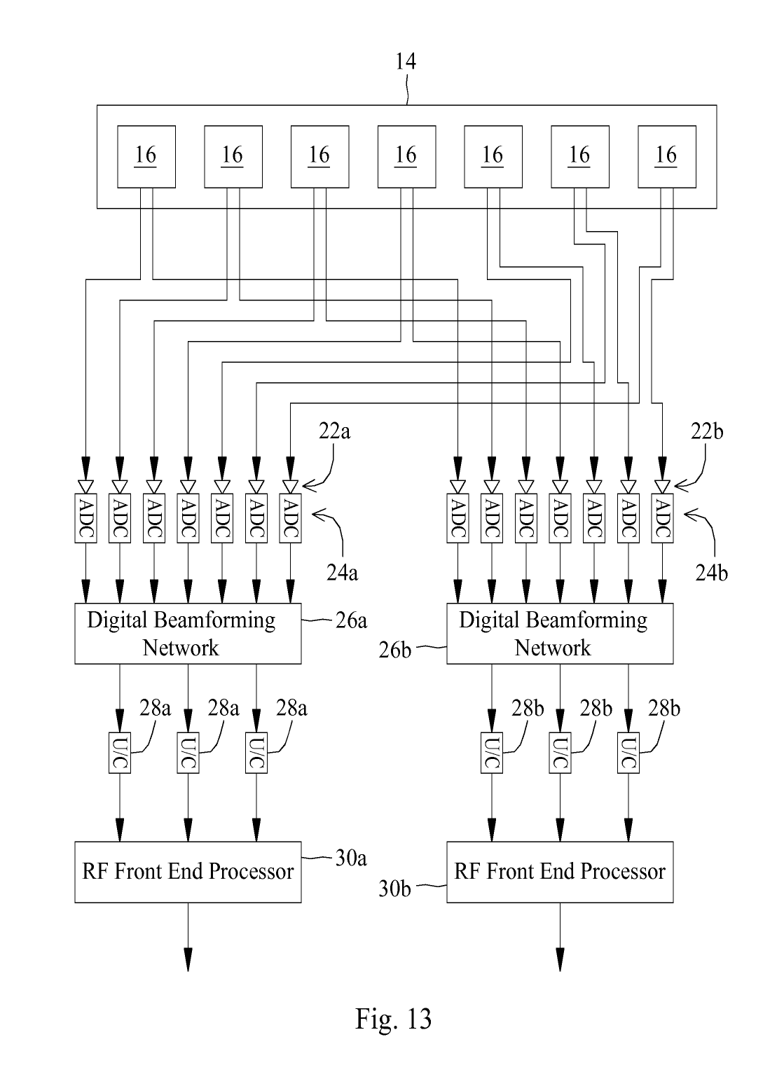

FIG. 13 depicts another outdoor unit of a satellite ground terminal for simultaneously receiving signals or data streams originated from the above-mentioned Ka-band satellites S1, S2, and S3 in the satellite orbital slots at X−2°, X°, and X+2° by three concurrent orthogonal beams at the same frequency in a certain frequency band such as baseband. Referring to FIG. 13, the outdoor unit of the satellite ground terminal includes: (1) the antenna 14 with the Ka-band elements or feeds 16 as depicted in FIG. 12; (2) multiple low-noise block down-converters (LNBs) 22a and 22b coupled to and arranged downstream of the Ka-band feeds 16; (3) multiple analog-to-digital converters (ADCs) 24a and 24b coupled to and arranged downstream of the two respective sets of LNBs 22a and 22b; (4) two digital beamforming networks (DBFNs) 26a and 26b coupled to and arranged downstream of the two respective sets of ADCs 24a and 24b; (5) multiple frequency up converters (U/Cs) 28a and 28b coupled to and arranged downstream of the two respective digital beamforming networks 26a and 26b; and (6) two RF front end processors 30a and 30b coupled to and arranged downstream of the two respective sets of U/Cs 28a and 28b. Each of the RF front end processors 30a and 30b performing the above-mentioned interfacing processing functions has input/output (I/O) ports for connection to an indoor unit of the satellite ground terminal via, e.g., parallel coaxial cables, optical fibers, wireless transmission, or a cable or optical fiber by using time division multiplexing transmission, frequency division multiplexing transmission, or code division multiplexing transmission. The outdoor unit features the DBFNs 26a and 26b for processing signals or data streams of dual respective polarizations from the respective ADCs 24a and 24b. The dual polarizations may be circular polarizations (CP) including a right hand CP (RHCP) and a left hand CP (LHCP); and they may also be linear polarization (LP) including a vertical polarization (VP) and a horizontal polarization (HP).

In this embodiment of FIG. 13, Ka-band signals or data streams of dual polarizations (e.g. horizontal and vertical polarizations, or right hand and left hand circular polarizations) from the satellites S1-S5 depicted in FIG. 2 are received or collected by each of the elements or feeds 16. Next, each of the elements or feeds 16 features two outputs, i.e., a first Ka-band signal or data stream of a first polarization in an analog format from its first output port and a second Ka-band signal or data stream of a second polarization in an analog format from its second output port. The first polarization may be vertical polarization, and the second polarization may be horizontal polarization. Alternatively, the first polarization may be right hand circular polarization, and the second polarization may be left hand circular polarization. The first Ka-band signals or data streams of the first polarization from the first output ports of the elements or feeds 16 are sent to the LNBs 22a, respectively, and the second Ka-band signals or data streams of the second polarization from the second output ports of the elements or feeds 16 are sent to the LNBs 22b, respectively. The LNBs 22a and 22b amplify the first and second Ka-band signals or data streams from the first and second output ports of the elements or feeds 16 and down convert the amplified signals or data streams in Ka band into ones in a lower frequency band such as baseband. The amplified, down-converted signals or data streams in an analog format from the LNBs 22a (hereinafter referred to as analog signals or data streams L1) are sent to the ADCs 24a, which convert the analog signals or data streams L1 in the first polarization into first digital signals or data streams in the first polarization. The first digital signals or data streams are digital representations of the analog signals or data streams L1, respectively. Concurrently, the amplified, down-converted signals or data streams in an analog format from the LNBs 22b (hereinafter referred to as analog signals or data streams L2) are sent to the ADCs 24b, which convert the analog signals or data streams L2 in the second polarization into second digital signals or data streams in the second polarization. The second digital signals or data streams are digital representations of the analog signals or data streams L2, respectively.

The first digital signals or data streams in the first polarization from the ADCs 24a are sent to the DBFN 26a, which generates at least three simultaneous fixed or dynamic orthogonal beams (hereinafter referred to as orthogonal beams DO1) in the first polarization at the lower frequency band such as baseband. In addition, the second digital signals or data streams in the second polarization from the ADCs 24b are sent to the DBFN 26b, which generates at least three simultaneous fixed or dynamic orthogonal beams (hereinafter referred to as orthogonal beams DO2) in the second polarization at the lower frequency band such as baseband.

Beam shaping techniques are used in designing the orthogonal beams DO1 and DO2. The shapes of the orthogonal beams DO1 are based on a first set of beam weighting vectors (BWVs) calculated by an optimization algorithm, and the shapes of the orthogonal beams DO2 are based on a second set of beam weighting vectors (BWVs) calculated by the optimization algorithm. For example, one of the orthogonal beams DO1 may be formed by the DBFN 26a multiplying or weighting first amplitude and phase weightings, i.e. the corresponding BWV in the first set, on the respective first digital signals or data streams so as to form a set of first weighted signals or data streams, and summing the set of first weighted signals or data streams. One of the orthogonal beams DO2 may be formed by the DBFN 26b multiplying or weighting second amplitude and phase weightings, i.e. the corresponding BWV in the second set, on the respective second digital signals or data streams so as to form a set of second weighted signals or data streams, and summing the set of second weighted signals or data streams. The first set of BWVs for the first digital signals or data streams may be the same as the second set of BWVs for the second digital signals or data streams.

The orthogonal beams DO1 may be vertically polarized (VP) beams while the orthogonal beams DO2 may be horizontally polarized (HP) beams. Alternatively, the orthogonal beams DO1 may be right hand circular polarized (RHCP) beams while the orthogonal beams DO2 may be left hand circular polarized (LHCP) beams. Each of the orthogonal beams DO1 in the first polarization may be formed by enhancing or suppressing gain of the element beams defined by the contours 701-707 of the secondary radiation/reception patterns depicted in FIG. 6 based on a corresponding set of amplitude and phase weightings (e.g. the first amplitude and phase weightings) that may be calculated or altered based on an optimization process. Each of the orthogonal beams DO2 in the second polarization may be formed by enhancing or suppressing gain of the element beams defined by the contours 701-707 of the secondary radiation/reception patterns depicted in FIG. 6 based on a corresponding set of amplitude and phase weightings (e.g. the second amplitude and phase weightings) that may be calculated or altered based on an optimization process.

In one example, the orthogonal beams DO1 in the first polarization may have the same radiation patterns as the above-mentioned orthogonal beams A1-A3, respectively; the orthogonal beams DO2 in the second polarization may have the same radiation patterns as the above-mentioned orthogonal beams A4-A6, respectively. Alternatively, the orthogonal beams DO1 may have the same radiation patterns as the three broad-null orthogonal beams depicted in FIGS. 9A, 9B, and 9C, respectively; the orthogonal beams DO2 may have the same radiation patterns as the three broad-null orthogonal beams depicted in FIGS. 9A, 9B, and 9C, respectively.

Next, referring to FIG. 13, the signals or data streams, i.e. the orthogonal beams DO1, from the DBFN 26a are sent to the U/Cs 28a, respectively, and then up-converted from the lower frequency band (such as baseband) to a higher frequency band (such as Ku band, L band, C band, or X band) so as to form first up-converted signals or data streams in the first polarization. Concurrently, the signals or data streams, i.e. the orthogonal beams DO2, from the DBFN 26b are sent to the U/Cs 28b, respectively, and then up-converted from the lower frequency band (such as baseband) to the higher frequency band (such as Ku band, L band, C band, or X band) so as to form second up-converted signals or data streams in the second polarization. The first up-converted signals or data streams from the U/Cs 28a are sent to the RF front end processor 30a, which may include a switch mechanism for selecting one or more of the first up-converted signals or data streams in a digital format to be output to the indoor unit via, e.g., parallel coaxial cables, optical fibers, or other means including wireless transmission. The second up-converted signals or data streams from the U/Cs 28b are sent to the RF front end processor 30b, which may include a switch mechanism for selecting one or more of the second up-converted signals or data streams in a digital format to be output to the indoor unit via, e.g., parallel coaxial cables, optical fibers, or other means including wireless transmission.

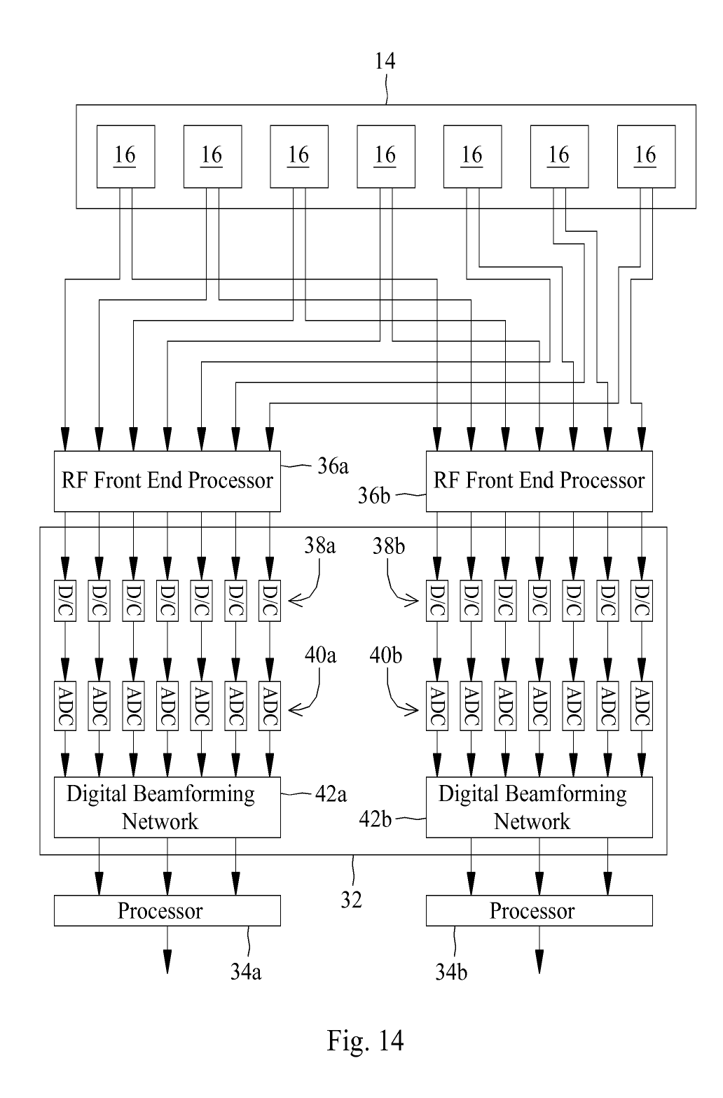

FIG. 14 depicts a simplified block diagram of a satellite ground terminal for simultaneously receiving signals or data streams originated from the above-mentioned Ka-band satellites S1, S2, and S3 in the satellite orbital slots at X−2°, X°, and X+2° by three concurrent orthogonal beams at the same frequency in baseband. Referring to FIG. 14, the satellite ground terminal includes: (1) a setup box including an indoor unit 32 and two processors 34a and 34b; and (2) an outdoor unit including the antenna 14 with the elements or feeds 16 as depicted in FIG. 12 and two RF front end processors 36a and 36b coupled to and arranged downstream of the elements or feeds 16.

The indoor unit 32 includes (1) multiple frequency down converters (D/Cs) 38a coupled to and arranged downstream of the RF front end processor 36a, (2) multiple frequency down converters (D/Cs) 38b coupled to and arranged downstream of the RF front end processor 36b, (3) multiple analog-to-digital converters (ADCs) 40a coupled to and arranged downstream of the frequency down converters 38a, (4) multiple analog-to-digital converters (ADCs) 40b coupled to and arranged downstream of the frequency down converters 38b, (5) a digital beamforming network (DBFN) 42a coupled to and arranged downstream of the ADCs 40a, and (6) a digital beamforming network (DBFN) 42b coupled to and arranged downstream of the ADCs 40b. The two processors 34a and 34b are coupled to and arranged downstream of the two DBFNs 42a and 42b, respectively. Each of the RF front end processors 36a and 36b may be coupled to the frequency down converters 38a or 38b of the indoor unit 32 via, e.g., parallel coaxial cables, optical fibers, wireless transmission, or a cable or optical fiber by using time division multiplexing transmission, frequency division multiplexing transmission, or code division multiplexing transmission.

This is an architecture using remote beamforming techniques and will require transport all received element signals from the elements 16 to the remote DBFNs 42a and 42b of the indoor unit 32. There shall be multiple parallel paths between the elements 16 and any one of the remote DBFNs 42a and 42b. For the seven elements 16, there are seven parallel paths from the elements 16 to any one of the remote DBFNs 42a and 42b. As a result, equalizations among the seven parallel paths are essential for remote beam forming and will be key concerns for the remote DBFNs 42a and 42b. There are many techniques in digital beamforming networks for parallel paths calibrations and equalizations for both design and implementation phases and during operations.

In this embodiment of FIG. 14, Ka-band signals or data streams of dual polarizations (e.g. horizontal and vertical polarizations, or right hand and left hand circular polarizations) from the satellites S1-S5 depicted in FIG. 2 are received or collected by each of the elements or feeds 16. Next, each of the elements or feeds 16 features two outputs, i.e., a first Ka-band signal or data stream of a first polarization in an analog format from its first output port and a second Ka-band signal or data stream of a second polarization in an analog format from its second output port. The first polarization may be vertical polarization, and the second polarization may be horizontal polarization. Alternatively, the first polarization may be right hand circular polarization, and the second polarization may be left hand circular polarization. The first Ka-band signals or data streams of the first polarization from the first output ports of the elements or feeds 16 are sent to the RF front end processor 36a, and the second Ka-band signals or data streams of the second polarization from the second output ports of the elements or feeds 16 are sent to the RF front end processor 36b.

Referring to FIG. 14, the RF front end processors 36a and 36b may be implemented in many ways. In one approach, each of the RF front end processors 36a and 36b may include (1) seven Ka-band low-noise amplifiers (LNAs) coupled to and arranged downstream of the corresponding first or second output ports of the feed elements 16 respectively, (2) seven Ka-band band-pass filters (BPFs) coupled to and arranged downstream of the respective corresponding Ka-band LNAs, (3) seven frequency down convertors (e.g. for converting input signals or data streams in Ka band into ones in an intermediate frequency (IF) at L or C band) coupled to and arranged downstream of the respective corresponding Ka-band BPFs, (4) seven IF buffer amplifiers coupled to and arranged downstream of the respective corresponding frequency down convertors, and (5) seven output ports coupled to and arranged downstream of the respective corresponding IF buffer amplifiers. The output ports of each of the processors 36a and 36b may be coupled to seven respective inputs of seven parallel coaxial cables. At the other ends of the parallel coaxial cables coupled to the processor 36a, seven outputs of the parallel coaxial cables coupled to the processor 36a are sent to the DBFN 42a after they are frequency down converted by the D/Cs 38a and digitized by the ADCs 40a. Concurrently, at the other ends of the parallel coaxial cables coupled to the processor 36b, seven outputs of the parallel coaxial cables coupled to the processor 36b are sent to the DBFN 42b after they are frequency down converted by the D/Cs 38b and digitized by the ADCs 40b.

In this approach, the Ka-band LNAs of the processor 36a amplify the first Ka-band signals or data streams of the first polarization from the first output ports of the elements or feeds 16, respectively, to generate first amplified Ka-band signals or data streams of the first polarization. Concurrently, the Ka-band LNAs of the processor 36b amplify the second Ka-band signals or data streams of the second polarization from the second output ports of the elements or feeds 16, respectively, to generate second amplified Ka-band signals or data streams of the second polarization. Next, the BPFs of the processor 36a pass the first amplified Ka-band signals or data streams of the first polarization only in a certain band of frequencies while attenuating the first amplified Ka-band signals or data streams of the first polarization outside the certain band so as to form first band-pass filtered signals or data streams in Ka band; concurrently, the BPFs of the processor 36b pass the second amplified Ka-band signals or data streams of the second polarization only in the certain band of frequencies while attenuating the second amplified signals or data streams of the second polarization outside the certain band so as to form second band-pass filtered signals or data streams in Ka band.

Next, the frequency down convertors of the processor 36a respectively down convert the first band-pass filtered signals or data streams in Ka band into ones in an intermediate frequency (IF) at L or C band so as to generate first IF signals or data streams; concurrently, the frequency down convertors of the processor 36b respectively down convert the second band-pass filtered signals or data streams in Ka band into ones in an intermediate frequency (IF) at L or C band so as to generate second IF signals or data streams. Next, the IF buffer amplifiers of the processor 36a respectively amplify the first IF signals or data streams to generate first amplified IF signals or data streams to be respectively sent to the output ports of the processor 36a; concurrently, the IF buffer amplifiers of the processor 36b respectively amplify the second IF signals or data streams to generate second amplified IF signals or data streams to be respectively sent to the output ports of the processor 36b. The first amplified IF signals or data streams are respectively sent to the D/Cs 38a of the indoor unit 32 through the seven parallel coaxial cables connecting the processor 36a and the D/Cs 38a of the indoor unit 32; the second amplified IF signals or data streams are respectively sent to the D/Cs 38b of the indoor unit 32 through the seven parallel coaxial cables connecting the processor 36b and the D/Cs 38b of the indoor unit 32.

Alternatively, the RF front end processors 36a and 36b may be designed to be implemented by more advanced technologies to provide broader bandwidth with lower cost. In an alternate and more advanced approach, each of the processors 36a and 36b may include (1) seven Ka-band LNAs coupled to and arranged downstream of the corresponding first or second output ports of the feed elements 16 respectively, (2) seven Ka-band band-pass filters (BPFs) coupled to and arranged downstream of the respective corresponding Ka-band LNAs, (3) seven Ka-band buffer amplifiers coupled to and arranged downstream of the respective corresponding Ka-band BPFs, (4) a 7-to-1 multiplexer coupled to and arranged downstream of the corresponding Ka-band buffer amplifiers, and (5) a radio frequency (RF) to optical converter (or RF-to-optical converter) coupled to and arranged downstream of the corresponding 7-to-1 multiplexer. The RF-to-optical converters of the processors 36a and 36b may be coupled to two optical fibers, respectively. In this case, the indoor unit 32 may include (1) two optical-to-RF converters respectively coupled to the other ends of the optical fibers and (2) two 1-to-7 de-multiplexers respectively coupled to and arranged downstream of the optical-to-RF converters. The de-multiplexed signals or data streams output from the 1-to-7 de-multiplexers are sent to the DBFNs 42a and 42b after they are frequency down converted by the D/Cs 38a and 38b and digitized by the ADCs 40a and 40b.

The two 7-to-1 multiplexers of the processors 36a and 36b may be two 7-to-1 time division multiplexers respectively, each of which is configured to multiplex its seven inputs in parallel into an output, containing its inputs in serial, based on time division, while the two 1-to-7 de-multiplexers of the indoor unit 32 may be two 1-to-7 time division demultiplexers respectively, each of which is configured to output seven outputs in parallel by demultiplexing an input, i.e. the output of the corresponding 7-to-1 multiplexer, based on time division. Alternatively, the two 7-to-1 multiplexers of the processors 36a and 36b may be two 7-to-1 frequency division multiplexers respectively, each of which is configured to multiplex its seven inputs in parallel into an output, i.e. the output of the corresponding 7-to-1 multiplexer, based on frequency division while the two 1-to-7 de-multiplexers of the indoor unit 32 may be two 1-to-7 frequency division demultiplexers respectively, each of which is configured to output seven outputs in parallel by demultiplexing an input, containing its seven outputs in different frequencies, based on frequency division. Alternatively, the two 7-to-1 multiplexers of the processors 36a and 36b may be two 7-to-1 code division multiplexers respectively, each of which is configured to multiplex its seven inputs in parallel into an output, combining its inputs multiplied or weighted by codes, based on code division while the two 1-to-7 de-multiplexers of the indoor unit 32 may be two 1-to-7 code division demultiplexers respectively, each of which is configured to output seven outputs in parallel by demultiplexing an input, i.e. the output of the corresponding 7-to-1 multiplexer, based on code division.

In the alternate and more advanced approach, the Ka-band LNAs of the processor 36a respectively amplify the first Ka-band signals or data streams of the first polarization from the first output ports of the elements or feeds 16 to generate first amplified Ka-band signals or data streams of the first polarization; concurrently, the Ka-band LNAs of the processor 36b respectively amplify the second Ka-band signals or data streams of the second polarization from the second output ports of the elements or feeds 16 to generate second amplified Ka-band signals or data streams of the second polarization. Next, the BPFs of the processor 36a respectively pass the first amplified Ka-band signals or data streams of the first polarization only in a certain band of frequencies while attenuating the first amplified Ka-band signals or data streams of the first polarization outside the certain band so as to form first band-pass filtered signals or data streams in Ka band; concurrently, the BPFs of the processor 36b respectively pass the second amplified Ka-band signals or data streams of the second polarization only in the certain band of frequencies while attenuating the second amplified signals or data streams of the second polarization outside the certain band so as to form second band-pass filtered signals or data streams in Ka band.

Next, the Ka-band buffer amplifiers of the processor 36a respectively amplify the first band-pass filtered signals or data streams to generate first amplified, filtered signals or data streams; concurrently, the Ka-band buffer amplifiers of the processor 36b respectively amplify the second band-pass filtered signals or data streams to generate second amplified, filtered signals or data streams. Next, the 7-to-1 multiplexer of the processor 36a combines the first amplified, filtered signals or data streams in parallel into a first RF output signal or data stream based on the above time division, frequency division or code division and sends the first RF output signal or data stream to the RF-to-optical converter of the processor 36a; concurrently, the 7-to-1 multiplexer of the processor 36b combines the second amplified, filtered signals or data streams in parallel into a second RF output signal or data stream based on the above time division, frequency division or code division and sends the second RF output signal or data stream to the RF-to-optical converter of the processor 36b. Next, the RF-to-optical converter of the processor 36a converts the first RF output signal or data stream in an electronic mode into a first optical signal or data stream in an optical mode, which is sent to one of the optical fibers; concurrently, the RF-to-optical converter of the processor 36b converts the second RF output signal or data stream in an electronic mode into a second optical signal or data stream in an optical mode, which is sent to the other one of the optical fibers.

Next, one of the optical-to-RF converters of the indoor unit 32 converts the first optical signal or data stream in an optical mode into a first RF signal or data stream (hereinafter referred to as signal or data stream RS1) in an electronic mode, which is sent to one of the 1-to-7 de-multiplexers of the indoor unit 32; concurrently, the other one of the optical-to-RF converters of the indoor unit 32 converts the second optical signal or data stream in an optical mode into a second RF signal or data stream (hereinafter referred to as signal or data stream RS2) in an electronic mode, which is sent to the other one of the 1-to-7 de-multiplexers of the indoor unit 32. Next, one of the 1-to-7 de-multiplexers splits the signal or data stream RS1 carrying multiple payloads up into multiple first de-multiplexed signals or data streams in parallel, which are sent to the D/Cs 38a of the indoor unit 32; the other one of the 1-to-7 de-multiplexers splits the signal or data stream RS2 carrying multiple payloads up into multiple second de-multiplexed signals or data streams in parallel, which are sent to the D/Cs 38b of the indoor unit 32.

Referring to FIG. 14, the signals or data streams output from the processor 36a, i.e. the above first amplified IF signals or data streams or the above first de-multiplexed signals or data streams, are down-converted into ones in baseband by the D/Cs 38a; concurrently, the signals or data streams output from the processor 36b, i.e. the above second amplified IF signals or data streams or the above second de-multiplexed signals or data streams, are down-converted into ones in baseband by the D/Cs 38b. Next, inside the indoor unit 32, the down-converted signals or data streams in an analog format output from the D/Cs 38a (hereinafter referred to as signals or data streams L3) are sent to the ADCs 40a and then converted into first digital signals or data streams, which are digital representations of the signals or data streams L3. The down-converted signals or data streams in an analog format output from the D/Cs 38b (hereinafter referred to as signals or data streams L4) are sent to the ADCs 40b and then converted into second digital signals or data streams, which are digital representations of the signals or data streams L4. The first digital signals or data streams output from the ADCs 40a are sent to the DBFN 42a, which generates at least three first simultaneous fixed or dynamic orthogonal beams (hereinafter referred to as orthogonal beams DO3) at baseband. In addition, the second digital signals or data streams output from the ADCs 40b are sent to the DBFN 42b, which generates at least three second simultaneous fixed or dynamic orthogonal beams (hereinafter referred to as orthogonal beams DO4) at baseband. Next, the orthogonal beams DO3 are sent to the first processor 34a for further receiving functions such as synchronization, channalizations, and demodulations; concurrently, the orthogonal beams DO4 are sent to the second processor 34b for further receiving functions such as synchronization, channalizations, and demodulations.

Beam shaping techniques are used in designing these orthogonal beams DO3 and DO4. The shapes of the orthogonal beams DO3 are based on a first set of beam weighting vectors (BWVs) calculated by an optimization algorithm, and the shapes of the orthogonal beams DO4 are based on a second set of beam weighting vectors (BWVs) calculated by the optimization algorithm. For example, one of the orthogonal beams DO3 may be formed by the DBFN 42a multiplying or weighting first amplitude and phase weightings, i.e. the beam weighting vector in the first set, on the respective first digital signals or data streams so as to form a set of first weighted signals or data streams, and summing the set of first weighted signals or data streams. One of the orthogonal beams DO4 may be formed by the DBFN 42b multiplying or weighting second amplitude and phase weightings, i.e. the beam weighting vector in the second set, on the respective second digital signals or data streams so as to form a set of second weighted signals or data streams, and summing the set of second weighted signals or data streams. The beam weighting vectors in the first set may be, for example, the same as the beam weighting vectors in the second set.

The orthogonal beams DO3 may be vertically polarized (VP) beams, and the orthogonal beams DO4 may be horizontally polarized (HP) beams. Alternatively, the first orthogonal beams DO3 may be right hand circular polarized (RHCP) beams, and the second orthogonal beams DO4 may be left hand circular polarized (LHCP) beams. Each of the first orthogonal beams DO3 may be formed by enhancing or suppressing gain of the element beams defined by the contours 701-707 of the secondary radiation/reception patterns depicted in FIG. 6 based on a corresponding set of amplitude and phase weightings (e.g. the first amplitude and phase weightings) that may be calculated or altered based on an optimization process. Each of the second orthogonal beams DO4 may be formed by enhancing or suppressing gain of the element beams defined by the contours 701-707 of the secondary radiation/reception patterns depicted in FIG. 6 based on a corresponding set of amplitude and phase weightings (e.g. the second amplitude and phase weightings) that may be calculated or altered based on an optimization process. In one example, the orthogonal beams DO3 may have the same radiation patterns as the above orthogonal beams A1-A3, respectively; the orthogonal beams DO4 may have the same radiation patterns as the above orthogonal beams A4-A6, respectively. Alternatively, the orthogonal beams DO3 may have the same radiation patterns as the three broad-null orthogonal beams depicted in FIGS. 9A, 9B, and 9C, respectively; the orthogonal beams DO4 may have the same radiation patterns as the three broad-null orthogonal beams depicted in FIGS. 9A, 9B, and 9C, respectively.

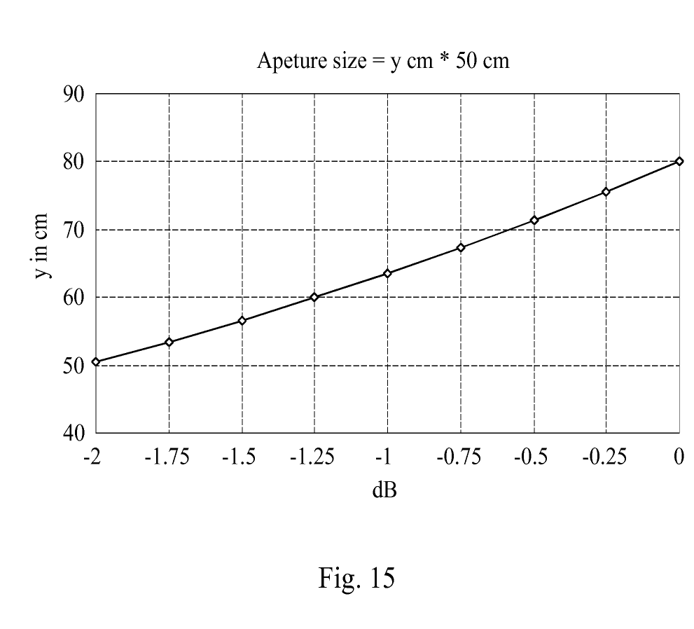

FIG. 15 illustrates a theoretical plot showing the relation between the radio of carrier to interference plus noise, i.e. isolation index, and aperture sizes of a reflector or dish. In FIG. 15, the aperture size has an ellipse shape with a fixed dimension (i.e. 50 cm) in a vertical axis thereof and a variable dimension in (i.e. y cm) in a horizontal axis thereof. Referring to FIG. 15, when the radio of carrier to interference plus noise, i.e. C/(I+N), improves 0.5 dB, i.e. moves from 0 dB to −0.5 dB, the aperture size can drop from 80 cm to 72 cm in the horizontal axis thereof. When the radio of carrier to interference plus noise, i.e. C/(I+N), improves 1 dB, i.e. moves from 0 dB to −1 dB, the aperture size can drop from 80 cm to 65 cm in the horizontal axis thereof. Therefore, by using a beam shaping technique (e.g. orthogonal-beam technique based on amplitude and phase weightings that may be calculated or altered via an optimization algorithm) to form the above-mentioned orthogonal beams, a reflector or dish may be designed with a relatively-small aperture size, e.g. smaller than 80 cm in the horizontal axis thereof, and the same isolation/discriminations capability as ever may be provided or maintained. Depending on the above result, the aperture size of the parabolic dish or reflector 601 depicted in FIG. 5 may have an ellipse shape with 50 cm in an vertical axis thereof and smaller than 80 cm in an horizontal axis thereof (e.g. between 50 cm and 79 cm in the horizontal axis thereof) or equal to or smaller than 65 cm in the horizontal axis thereof (e.g. between 50 cm and 65 cm in the horizontal axis thereof) and good discrimination capability against signal sources separate by only 2 degrees away can also be achieved. For example, the aperture size of the parabolic dish or reflector 601 depicted in FIG. 5 may be 65-cm by 65-cm, 65-cm by 50-cm, or 55-cm by 50-cm.

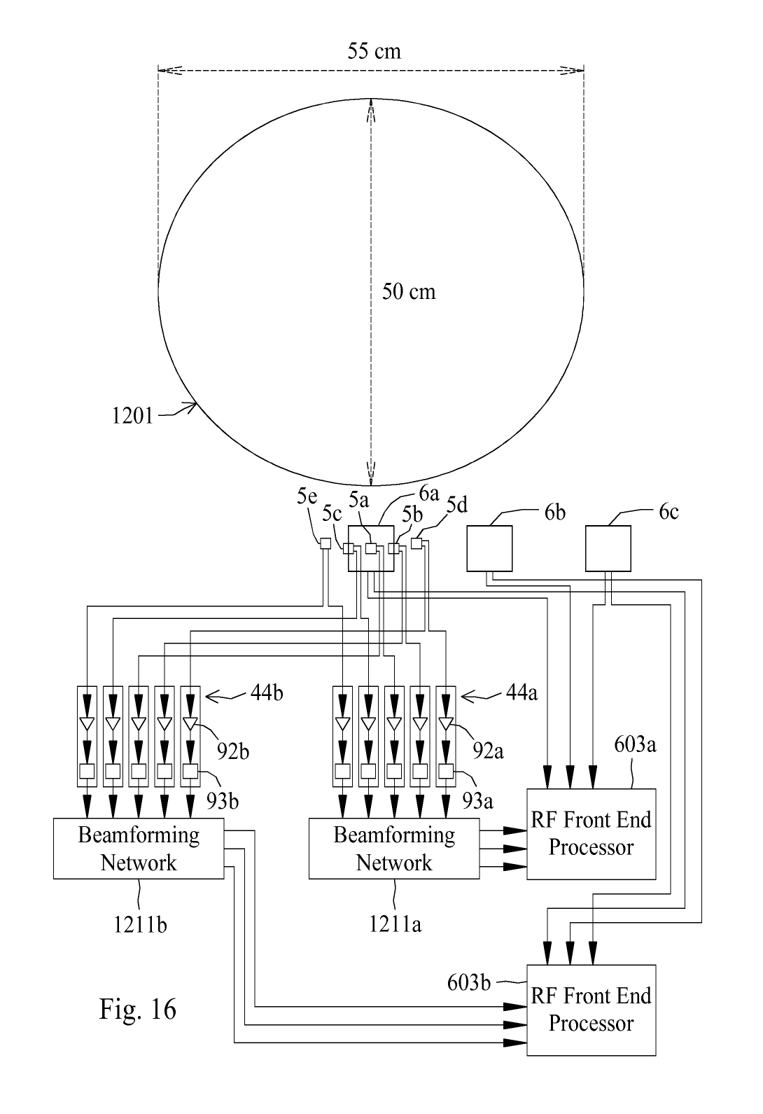

FIG. 16 depicts a simplified block diagram of receiving functions of an outdoor unit of a satellite ground terminal for simultaneously receiving signals or data streams originated from the Ka-band satellites S1, S2, and S3 in the orbital slots at X−2°, X°, and X+2° by three concurrent orthogonal beams at the same frequency in Ka band. In this embodiment, the satellite ground terminal may be, but not limited to, a DBS TV terminal capable of concurrently communicating with satellites in Ka bands and Ku bands and may be reference to the ground terminal (GT) as mentioned above.

Referring to FIG. 16, the outdoor unit includes the RF front end processors 603a and 603b depicted in FIG. 7, two analogue BFNs 1211a and 1211b, five conditioners 44a, five conditioners 44b, and a multiple-beam antenna (MBA) having, e.g., an offset parabolic dish or reflector 1201 with a suitable aperture size, the above-mentioned Ku-band feeds 6a-6c, and five Ka-band feeds 5a-5e. Each of the conditioners 44a includes, for example, a Ka-band LNA 92a and a BPF 93a. Each of the conditioners 44b includes, for example, a Ka-band LNA 92b and a BPF 93b. Each of the Ka-band feeds 5a-5e may be a receiving dual polarization feed and includes first and second output ports.

The five Ka-band LNAs 92a of the conditioners 44a are coupled to and arranged downstream of the five first output ports of the Ka-band feeds 5a-5e, respectively. The five Ka-band LNAs 92b of the conditioners 44b are coupled to and arranged downstream of the five second output ports of the Ka-band feeds 5a-5e, respectively. The five band-pass filters 93a are coupled to and arranged downstream of the five Ka-band LNAs 92a, respectively. The five band-pass filters 93b are coupled to and arranged downstream of the five Ka-band LNAs 92b, respectively. The analogue BFN 1211a is coupled to and arranged downstream of the five band-pass filters 93a. The analogue BFN 1211b is coupled to and arranged downstream of the five band-pass filters 93b. The RF front end processor 603a is coupled to and arranged downstream of the analogue BFN 1211a and the first output ports of the Ku-band feeds 6a-6c. The RF front end processor 603b is coupled to and arranged downstream of the analogue BFN 1211b and the second output ports of the Ku-band feeds 6a-6c.

The aperture size of the parabolic dish or reflector 1201 is optimally decided according to two requirements of the desired directional gains, i.e. beam peaks of orthogonal beams generated by the analogue BFN 1211a or 1211b, each enhancing a corresponding one of the signals or data streams from the Ka-band satellites S1-S3 and minimum isolations of the signals or data streams from one of the Ka-band satellites S1-S5 against those from the others of the Ka-band satellites S1-S5. In this embodiment, the aperture size of the parabolic dish or reflector 1201 is 55 cm in azimuth by 50 cm in elevation. In addition, the aperture may also service three orbital slots of Ku band satellites which are separated by 9°. Alternatively, the aperture size of the parabolic dish or reflector 1201 may be x1 cm in azimuth and x2 cm in elevation, where “x1” ranges from 55 cm to 85 cm, and “x2” ranges from 45 cm to 75 cm. Each of the Ku-band feeds 6a-6c generates a beam with a peak pointed to a Ku-band satellite in one of orbital slots of X°, X+9°, and X+18°. The number of the Ka-band feeds 5a-5e is equal to the number of the orbital slots of X−2°, X°, X+2°, X−4°, and X+4° allocated for the satellites S1, S2, S3, S4, and S5.

The three Ka-band feeds 5a-5c are placed on the focus arc of the reflector 1201, but the two Ka-band feeds 5d and 5e are placed slightly off the focus arc of the reflector 12011. The three Ka-band feeds 5a, 5b and 5c are referred to as focus feeds, which feature three element beams with main lobes pointed at X°, X−2°, and X+2°, respectively. The two Ka-band feeds 5d and 5e are referred to as defocused feeds, which feature two element beams with main lobes pointed at X−4°, and X+4°, respectively. The Ka-band feeds 5a-5e are, but not limited to, nearly equally spaced. At Ka band, neighboring two of these feeds 5a-5e may be spaced by 2 cm. The Ka-band feeds 5a-5e may be, for example, circularly or linearly polarized feeds with, e.g., a spacing ranging from 0.5 to 3 wavelengths. A simple Gaussian feed model or precision feed model at Ka band may be used to set up proper edge tapers on reflector illumination. The outdoor unit may be capable of forming multiple concurrent orthogonal beams with specified nulls for Ka band operations in receiving.

Referring to FIG. 16, Ka-band signals or data streams of dual polarizations (e.g. horizontal and vertical polarizations, or right hand and left hand circular polarizations) from Ka-band satellites (e.g. the satellites S1-S5 depicted in FIG. 2) are received or collected by each of the Ka-band feeds 5a-5e. Next, each of the feeds 5a-5e may feature two outputs, i.e. a first Ka-band signal or data stream of a first polarization in an analog format from its first output port and a second Ka-band signal or data stream of a second polarization in an analog format from its second output port. The first polarization may be a vertical polarization, and the second polarization may be a horizontal polarization. Alternatively, the first polarization may be a right hand circular polarization, and the second polarization may be a left hand circular polarization. The first Ka-band signals or data streams of the first polarization from the first output ports of the feeds 5a-5e are sent to the conditioners 44a, each of which conditions the corresponding one of the first Ka-band signals or data streams of the first polarization and features a corresponding output, i.e. a corresponding first conditioned signal or data stream of the first polarization in Ka band, to the analogue BFN 1211a. Concurrently, the second Ka-band signals or data streams of the second polarization from the second output ports of the feeds 5a-5e are sent to the conditioners 44b, each of which conditions the corresponding one of the second Ka-band signals or data streams of the second polarization and features a corresponding output, i.e. a corresponding second conditioned signal or data stream of the second polarization in Ka band, to the analogue BFN 1211b.

In this embodiment, the first Ka-band signals or data streams of the first polarization from the first output ports of the feeds 5a-5e are amplified by the LNAs 92a of the conditioners 44a so as to form first amplified signals or data streams of the first polarization in Ka band. The first amplified signals or data streams of the first polarization are then sent to the band-pass filters 93a of the conditioners 44a, which pass the first amplified signals or data streams of the first polarization only in a certain band of frequencies while attenuating the first amplified signals or data streams of the first polarization outside the certain band so as to form first band-pass filtered signals or data streams, i.e. the first conditioned signals or data streams of the first polarization, as the outputs of the conditioner 44a. The second Ka-band signals or data streams of the second polarization from the second output ports of the feeds 5a-5e are amplified by the LNAs 92b of the conditioners 44b so as to form second amplified signals or data streams of the second polarization in Ka band. The second amplified signals or data streams of the second polarization are then sent to the band-pass filters 93b of the conditioners 44b, which pass the second amplified signals or data streams of the second polarization only in a certain band of frequencies while attenuating the second amplified signals or data streams of the second polarization outside the certain band so as to form second band-pass filtered signals or data streams, i.e. the second conditioned signals or data streams of the second polarization, as the outputs of the conditioner 44b.

The analogue BFN 1211a generates at least three simultaneous fixed or dynamic orthogonal beams (hereinafter referred to as orthogonal beams A11, A12 and A13) in the first polarization at a specified frequency band (e.g. Ka band in this embodiment) based on the above first conditioned signals or data streams from the conditioners 44a. Concurrently, the analogue BFN 1211b generates at least three simultaneous fixed or dynamic orthogonal beams (hereinafter referred to as orthogonal beams A14, A15 and A16) in the second polarization at the specified frequency band based on the above second conditioned second signals or data streams from the conditioners 44b. The orthogonal beams (OBs) A11-A13 are orthogonal to one another and sent to the RF front end processor 603a, and the orthogonal beams (OBs) A14-A16 are orthogonal to one another and sent to the RF front end processor 603b. The orthogonal beams B1-B3 illustrated in FIGS. 4A-4C may be reference to the respective OBs A11-A13 generated by the analogue BFN 1211a and the respective OBs A14-A16 generated by the analogue BFN 1211b. The beam A11 may be substantially the same as the beam A14; the beam A12 may be substantially the same as the beam A15; the beam A13 may be substantially the same as the beam A16.

Each of the orthogonal beams A11-A16, generated from the analogue BFNs 1211a and 1211b, features a peak of a main lobe in a desired direction for enhancing gain for concurrently collected signals or data streams from the desired direction at a specific frequency slot in the specified frequency band and multiple nulls in the other directions for suppressing gain for concurrently collected signals or data streams from the other directions at the same frequency slot. The analogue BFN 1211a performs three sets of weighting and summing operations concurrently on received element signals, i.e. the corresponding ones of the above first conditioned signals or data streams, so as to simultaneously form the orthogonal beams A11-A13. The analogue BFN 1211b performs three sets of weighting and summing operations concurrently on received element signals, i.e. the corresponding ones of the above second conditioned signals or data streams, so as to simultaneously form the orthogonal beams A14-A16. Each operation of a weighted sum, or equivalently a linear combination, of the received element signals, i.e. the first conditioned signals or data streams, performed by the analogue BFN 1211a is to form a corresponding one of the orthogonal beams A11-A13. Each operation of a weighted sum, or equivalently a linear combination, of the received element signals, i.e. the second conditioned signals or data streams, performed by the analogue BFN 1211b is to form a corresponding one of the orthogonal beams A14-A16. Each set of in-phase/quadrature-phase (I/Q) weighting coefficients, or equivalently simple amplitude and phase weightings, performed in the analogue BFN 1211a, may be used to weigh the received element signals, i.e. the first conditioned signals or data streams, so as to form a corresponding one of the orthogonal beams A11-A13. Each set of in-phase/quadrature-phase (I/Q) weighting coefficients, or equivalently simple amplitude and phase weightings, performed in the analogue BFN 1211b, may be used to weigh the received element signals, i.e. the second conditioned signals or data streams, so as to form a corresponding one of the orthogonal beams A14-A16. The amplitude and phase weightings are calculated or altered based on performance constraints, such as directions and gain values of various beam peak and beam nulls, via an optimization process. In one example, the OBs B1, B2 and B3 illustrated in FIGS. 4A, 4B and 4C may be the three respective OBs A11-A13 or A14-A16.

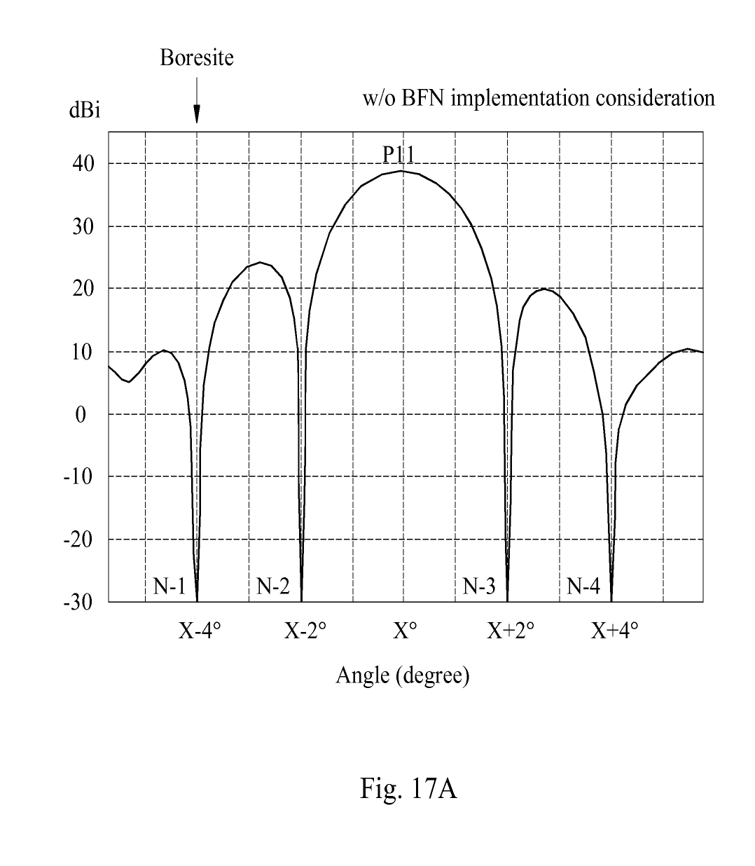

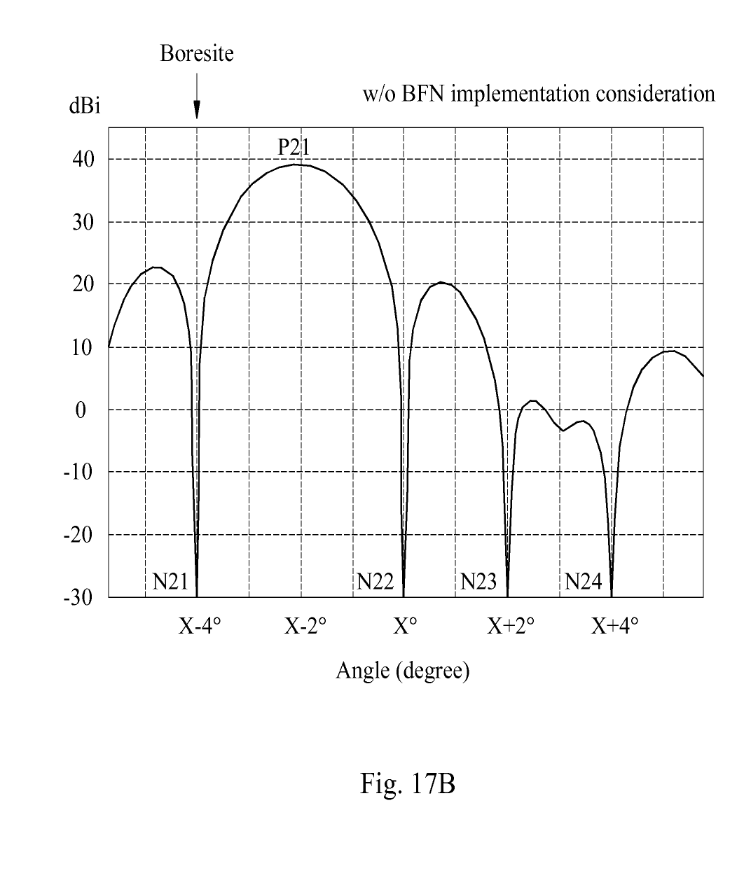

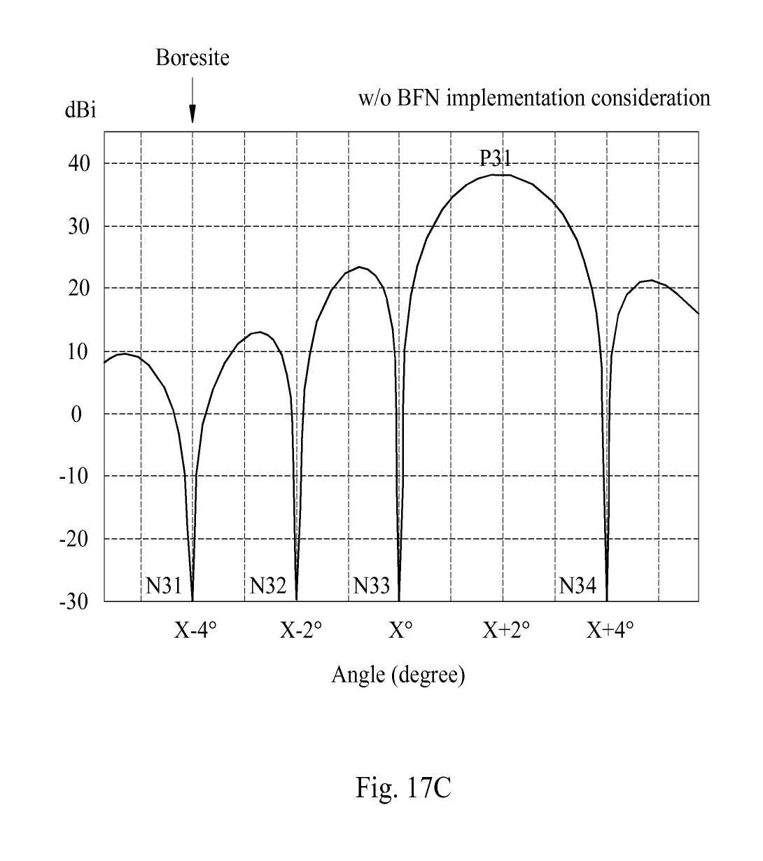

Referring to FIG. 17A, each of the orthogonal beams A11 and A14 features a peak P11 of a main lobe in the direction of a desired satellite, i.e. the satellite S2 in the satellite orbital slot of X° as depicted in FIG. 2, for enhancing gain of data streams or signals radiated from the satellite S2 and four nulls N−1, N−2, N−3, and N−4 in the four respective directions of potential interferences radiated from the satellites S1, S3, S4, and S5 in the four respective satellite orbital slots of X−2°, X+2°, X−4°, and X+4° as depicted in FIG. 2 for suppressing gain of data streams or signals radiated from the satellites S1, S3, S4, and S5. The peak gain of the main lobe for each of the beams A11 and A14 is above 38 dBi in the satellite orbital slot of X° while the gains in the satellite orbital slots of X−4°, X−2°, X+2°, and X+4° are all suppressed to less than −30 dBi. The isolation of the gain for desired data streams or signals from the satellite S2 in the orbital slot of X° against the gain for potential interference from either of the satellites S1, S3, S4, and S5 in the respective orbital slots of X−2°, X+2°, X−4°, and X+4° may be better than 30 dB or 60 dB. In the other words, each of the beams A11 and A14 features spatial isolation greater than 30 dB or 60 dB between the gain for the desired data streams or signals from the satellite S2 in the orbital slot of X° and the gain for potential interference radiated by any one of the satellites S1, S3, S4, and S5 at respective angles of X−2°, X+2°, X−4°, and X+4°.

Referring to FIG. 17B, each of the orthogonal beams A12 and A15 features a peak P21 of a main lobe in the direction of a desired satellite, i.e. the satellite S1 in the satellite orbital slot of X−2° as depicted in FIG. 2, for enhancing gain of data streams or signals radiated from the satellite S1 and four nulls N21, N22, N23, and N24 in the four respective directions of potential interferences radiated from the satellites S2, S3, S4, and S5 in the four respective satellite orbital slots of X−2°, X+2°, X−4°, and X+4° as depicted in FIG. 2 for suppressing gain of data streams or signals radiated from the satellites S2, S3, S4, and S5. The peak gain of the main lobe for each of the beams A12 and A15 is above 39 dBi in the satellite orbital slot of X−2° while the gains in the satellite orbital slots of X−4°, X°, X+2°, and X+4° are all suppressed to less than −30 dBi. The isolation of the gain for desired data streams or signals from the satellite S1 in the orbital slot of X−2° against the gain for potential interference from either of the satellites S2, S3, S4, and S5 in the respective orbital slots of X°, X+2°, X−4°, and X+4° may be better than 30 dB or 60 dB. In the other words, each of the beams A12 and A15 features spatial isolation greater than 30 dB or 60 dB between the gain for the desired data streams or signals from the satellite S1 in the orbital slot of X−2° and the gain for potential interference radiated by any one of the satellites S2, S3, S4, and S5 at respective angles of X°, X+2°, X−4°, and X+4°.

Referring to FIG. 17C, each of the orthogonal beams A13 and A16 features a peak P31 of a main lobe in the direction of a desired satellite, i.e. the satellite S3 in the satellite orbital slot of X+2° as depicted in FIG. 2, for enhancing gain of data streams or signals radiated from the satellite S3 and four nulls N31, N32, N33, and N34 in the four respective directions of potential interferences radiated from the satellites S1, S2, S4, and S5 in the four respective satellite orbital slots of X−2°, X°, X−4°, and X+4° as depicted in FIG. 2 for suppressing gain of data streams or signals radiated from the satellites S1, S2, S4, and S5. The peak gain of the main lobe for each of the beams A13 and A16 is above 38 dBi in the satellite orbital slot of X+2° while the gains in the satellite orbital slots of X−4°, X−2°, X°, and X+4° are all suppressed to less than −30 dBi. The isolation of the gain for desired data streams or signals from the satellite S3 in the orbital slot of X+2° against the gain for potential interference from either of the satellites S1, S2, S4, and S5 in the respective orbital slots of X−2°, X°, X−4°, and X+4° may be better than 30 dB or 60 dB. In the other words, each of the beams A13 and A16 features spatial isolation greater than 30 dB or 60 dB between the gain for the desired data streams or signals from the satellite S3 in the orbital slot of X+2° and the gain for potential interference radiated by any one of the satellites S1, S2, S4 and S5 at respective angles of X−2°, X°, X−4°, and X+4°.

In comparing the three Ka-band element beams pointed at X−2°, X°, and X+2° generated via the 80-cm by 50-cm aperture 601 with pattern contours shown in FIG. 6 to the three Ka-band orthogonal beams pointed to X−2°, X°, and X+2° generated via the 55-cm by 50-cm aperture 1201 shown in FIGS. 17A-17C, we may make the following observations: (1) the peak gains of the element beams of the feeds 8a-8c illuminating the aperture 601 is about 41 dBi while those for the orthogonal beams A11-A16 generated via the feeds 5a-5e illuminating the smaller aperture 1201 is about 39 dBi; and (2) isolations or S/I of the element beams of the feeds 8a-8c illuminating the aperture 601 is about 25 dB while those of the orthogonal beams A11-A16 generated via the feeds 5a-5e illuminating the smaller aperture 1201 is better than 60 dB. Due to recent advancement in modulations, such as the protocol of DVB S2, the key design drivers for ground terminals may not be based on equivalent isotropically radiated power (EIRP). In fact, in many satellite communications where key design driver may be based on the S/I or S-to-I ratio, instead of the peak gain, that is, a ground terminals with a smaller aperture and multiple orthogonal beams may become better choices.

Referring back to FIG. 16, the two analogue BFNs 1211a and 1211b may be two beam forming networks for linearly polarized (LP) signals: for example, the analogue BFN 1211a may be configured to process the conditioned signals or data streams in a vertical polarization (VP) from the conditioners 44a, and the analogue BFN 1211b may be configured to process the conditioned signals or data streams in a horizontal polarization (HP) from the conditioners 44b. Alternatively, the two analogue BFNs 1211a and 1211b may be two beam forming networks for circularly polarized (CP) signals: for example, the analogue BFN 1211a may be configured to process the conditioned signals or data streams in a right hand circular polarization (RHCP) from the conditioners 44a, and the analogue BFN 1211b may be configured to process the conditioned signals or data streams in a left hand circular polarization (LHCP) from the conditioners 44b. In the case of the above analogue BFNs 1211a and 1211b for LP signals, the OBs A11-A13 may be vertically polarized (VP) beams, and the OBs A14-A16 may be horizontally polarized (HP) beams. In the case of the above analogue BFNs 1211a and 1211b for CP signals, the OBs A11-A13 may be right hand circular polarized (RHCP) beams, and the OBs A14-A16 may be left hand circular polarized (LHCP) beams.

Referring to FIG. 16, the Ka-band orthogonal beams A11-A13 from the analogue BFN 1211a to the processor 603a and Ku-band signals or data streams from the first output ports of the Ku-band feeds 6a-6c to the processor 603a may have the same linear polarization format, such as vertical polarization, while the Ka-band orthogonal beams A14-A16 from the analogue BFN 1211b to the processor 603b and Ku-band signals or data streams from the second output ports of the Ku-band feeds 6a-6c to the processor 603b may have the same linear polarization format, such as horizontal polarization. Alternatively, the Ka-band orthogonal beams A11-A13 from the analogue BFN 1211a to the processor 603a and the Ku-band signals or data streams from the first output ports of the Ku-band feeds 6a-6c to the processor 603a may have the same circular polarization format, such as right hand circular polarization, while the Ka-band orthogonal beams A14-A16 from the analogue BFN 1211b to the processor 603b and the Ku-band signals or data streams from the second output ports of the Ku-band feeds 6a-6c to the processor 603b may have the same circular polarization format, such as left hand circular polarization. Alternatively, the Ka-band orthogonal beams A11-A13 from the analogue BFN 1211a to the processor 603a may have vertical polarization; the Ka-band orthogonal beams A14-A16 from the analogue BFN 1211b to the processor 603b may have horizontal polarization; the Ku-band signals or data streams from the first output ports of the Ku-band feeds 6a-6c to the processor 603a may have right hand circular polarization; the Ku-band signals or data streams from the second output ports of the Ku-band feeds 6a-6c to the processor 603b may have left hand circular polarization.

Each of the analogue BFNs 1211a and 1211b operates in a given frequency band (e.g. Ka band in this embodiment, Ku band, L band, C band, or X band) and may be implemented in a low-temperature co-fired ceramic (LTCC), a printed circuit board (PCB), or a semiconductor chip. For example, each of the analogue BFNs 1211a and 1211b may be implemented using an analogue printed circuit at 20 GHz to achieve better than −30 dB isolations.

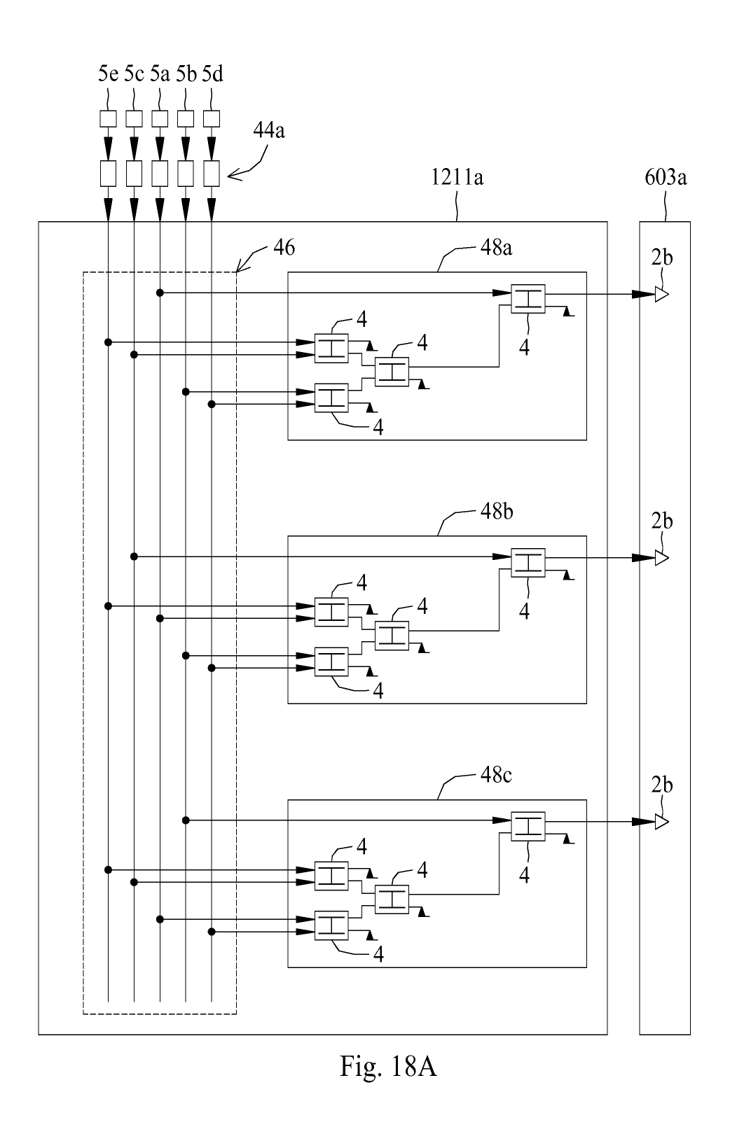

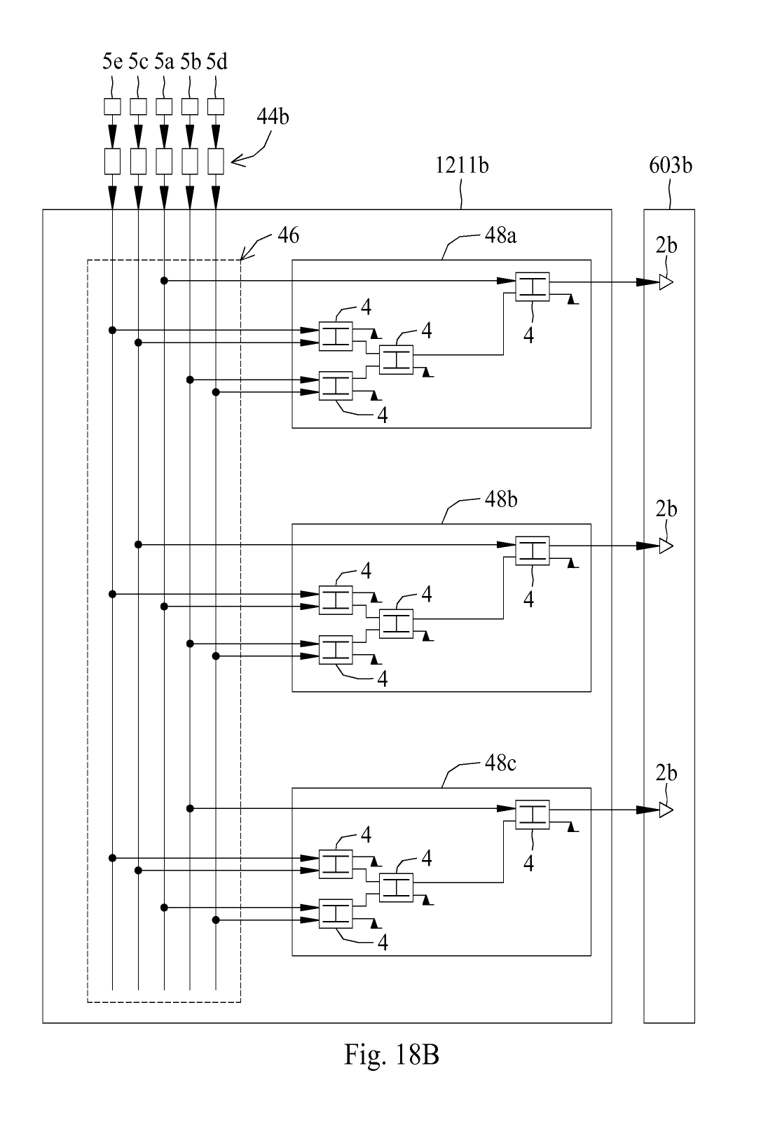

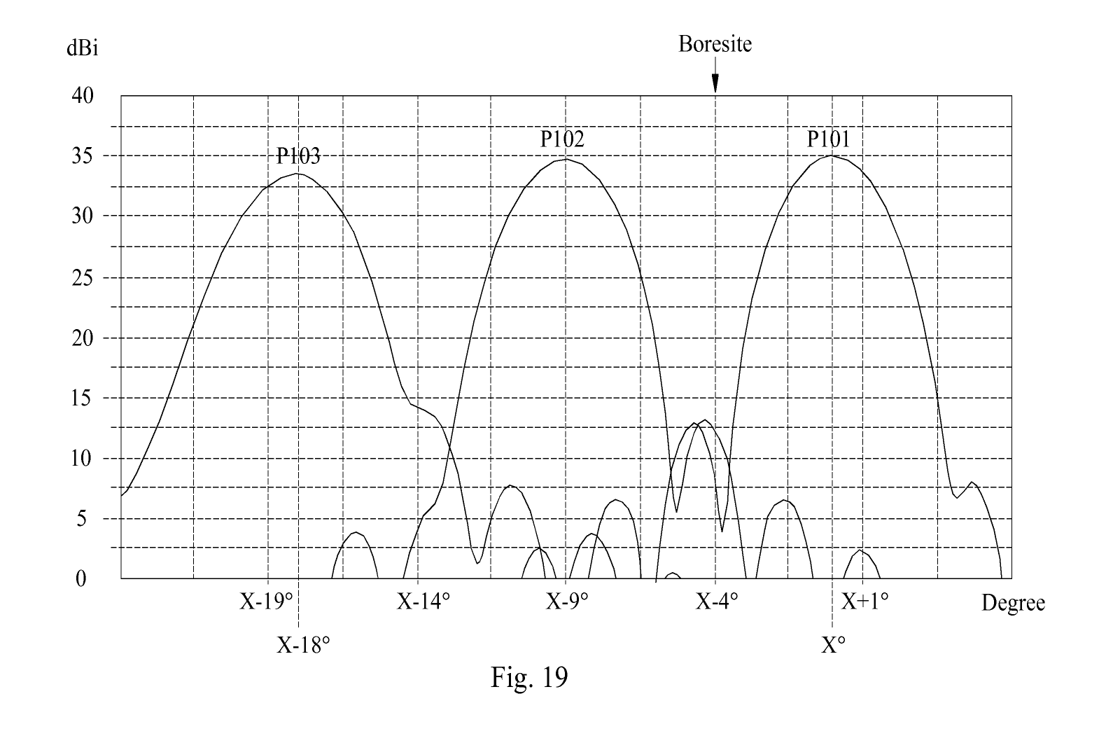

Referring to FIGS. 18A and 18B, each of the analogue BFNs 1211a and 1211b includes, but not limited to, a power dividing network or matrix 46 coupled to the conditioners 44a or 44b and at least three hybrid networks 48a, 48b and 48c coupled to the power dividing network or matrix 46. Each of the hybrid networks 48a, 48b and 48c includes multiple hybrids 4 (e.g. four hybrids in this embodiment) and may be implemented by multi-layered circuits, such as microstrips, strip-lines, and/or coplanar waveguides, acting as transmission lines, formed in the LTCC, PCB or semiconductor chip. Each of the hybrids 4 has two inputs (hereinafter referred to as input A and input B) and two outputs (hereinafter referred to as output A and output B) each containing information associated with its two inputs A and B. That is, the output A may be a linear combination of the input A weighted or multiplied by a first complex number plus the input B weighted or multiplied by a second complex number, and the output B may be a linear combination of the input A weighted or multiplied by a third complex number plus the input B weighted or multiplied by a fourth complex number. The lengths of the transmission lines interconnecting the hybrids 4 are used for “phasing”, or phase weighting on various element signals. In this embodiment, each of the hybrids 4 includes: (1) a first input coupled to an output of another one of the hybrids 4 or to one of the conditioners 44a or 44b; and (2) a second input coupled to an output of another one of the hybrids 4 or to another one of the conditioners 44a or 44b. Also, each of the hybrids 4 includes: (1) a first output coupled to the ground; and (2) a second output coupled to an input of another one of the hybrids 4 or to the processor 603a or 603b.

Referring to FIG. 18A, using the power dividing network or matrix 46, each of the first conditioned signals or data streams from the conditioners 44a is divided into at least three power-divided signals or data streams with equal or unequal amplitude or power, which are then sent to the hybrid networks 48a, 48b and 48c, respectively. Therefore, each of the hybrid networks 48a, 48b and 48c receives at least five power-divided signals or data streams, containing information associated with the five respective signals or data streams received or collected by the Ka-band feeds 5a-5e, from the power dividing network or matrix 46, each of which may be sent to one of the hybrids 4. The hybrid networks 48a, 48b and 48c of the analogue BFN 1211a generate the OBs A11, A12, and A13, respectively, based on the power-divided signals or data streams from the power dividing network or matrix 46 of the analogue BFN 1211a. Next, the Ka-band signals or data streams, i.e. the OBs A11-A13, are sent to the buffer amplifiers 2b of the processor 603a depicted in FIG. 7, respectively, so as to be amplified by the buffer amplifiers 2b of the processor 603a, respectively, and then be processed by the unit 604 of the processor 603a depicted in FIG. 7.

FIG. 18A depicts an architecture of forming the three orthogonal beams A11-A13 in the first polarization based on the first Ka-band signals or data streams of the first polarization from the five elements or feeds 5a-5e via three respective analogue beam-forming units, each of which includes one of the three hybrid networks 48a-48c for combining five corresponding Ka-band inputs (i.e. the five corresponding power-divided signals or data streams) into one Ka-band output (i.e. the corresponding one of the OBs A11-A13). Each of the analogue beam-forming units performs a linear combination (equivalently a weighted sum), as its Ka-band output, of the five corresponding Ka-band inputs with a beam weighting vector (BWV) specifying weighting components for the linear combination. The Ka-band output may be a linear combination of the Ka-band inputs weighted or multiplied by the respective weighting components in the BWV. There are three BWVs for the three orthogonal beams A11-A13. In order to design an orthogonal beam in the output from one of the beam-forming units, coupling coefficients of the four hybrids 4 of the BFN 1211a may be optimized to efficiently control the amplitudes of input signals, i.e. the Ka-band inputs, while phase adjustments of the input signals, i.e. the Ka-band inputs, are accomplished by trimming path lengths in and/or between the hybrids 4.

Referring to FIG. 18B, using the power dividing network or matrix 46, each of the second conditioned signals or data streams from the conditioners 44b is divided into at least three power-divided signals or data streams with equal or unequal amplitude or power, which are then sent to the hybrid networks 48a, 48b and 48c, respectively. Therefore, each of the hybrid networks 48a, 48b and 48c receives at least five power-divided signals or data streams, containing information associated with the five respective signals or data streams received or collected by the Ka-band feeds 5a-5e, from the power dividing network or matrix 46, each of which may be sent to one of the hybrids 4. The hybrid networks 48a, 48b and 48c of the analogue BFN 1211b generate the OBs A14, A15, and A16, respectively, based on the power-divided signals or data streams from the power dividing network or matrix 46 of the analogue BFN 1211b. Next, the Ka-band signals or data streams, i.e. the OBs A14-A16, are sent to the buffer amplifiers 2b of the processor 603b depicted in FIG. 7, respectively, so as to be amplified by the buffer amplifiers 2b of the processor 603b, respectively, and then be processed by the unit 604 of the processor 603b.

FIG. 18B depicts an architecture of forming the three orthogonal beams A14-A16 in the second polarization based on the second Ka-band signals or data streams of the second polarization from the five elements or feeds 5a-5e via three respective analogue beam-forming units, each of which includes one of the three hybrid networks 48a-48c for combining five Ka-band inputs (i.e. the five corresponding power-divided signals or data streams) into one Ka-band output (i.e. the corresponding one of the OBs A14-A16). Each of the analogue beam-forming units performs a linear combination (equivalently a weighted sum), as its Ka-band output, of the five corresponding Ka-band inputs with a beam weighting vector (BWV) specifying weighting components for the linear combination. The Ka-band output may be a linear combination of the Ka-band inputs weighted or multiplied by the respective weighting components in the BWV. There are three BWVs for the three orthogonal beams A14-A16. In order to design an orthogonal beam in the output from one of the beam-forming units, coupling coefficients of the four hybrids 4 of the BFN 1211b may be optimized to efficiently control the amplitudes of input signals, i.e. the Ka-band inputs, while phase adjustments of the input signals, i.e. the Ka-band inputs, are accomplished by trimming path lengths in and/or between the hybrids 4.

Alternatively, the outdoor unit depicted in FIG. 16 may include (1) multiple first frequency-down converters (not shown) coupled to and arranged downstream of the BFN 1211a, coupled to and arranged upstream of the processor 603a and configured to convert the beams A11-A13 in Ka band into ones in Ku band and (2) multiple second frequency-down converters (not shown) coupled to and arranged downstream of the BFN 1211b, coupled to and arranged upstream of the processor 603b and configured to convert the beams A14-A16 in Ka band into ones in Ku band while each of the processors 603a and 603b depicted in FIG. 7 includes (1) at least three Ku-band buffer amplifiers, instead of the amplifiers 2b, coupled to and arranged downstream of the first or second frequency-down converters and configured to amplify the corresponding frequency-down converted beams A11-A13 or A14-A16 and (2) a Ku-band front end electronic or processing unit (hereinafter referred to as Ku-band frontend unit FU), instead of the unit 604, coupled to and arranged downstream of the Ku-band buffer amplifiers and coupled to and arranged upstream of the switching mechanism 605. In this case, the first frequency-down converters down convert the respective orthogonal beams A11-A13 in Ka band into ones in Ku band, which are respectively sent to the Ku-band buffer amplifiers of the processor 603a; concurrently, the second frequency-down converters down convert the respective orthogonal beams A14-A16 in Ka band into ones in Ku band, which are respectively sent to the Ku-band buffer amplifiers of the processor 603b. Next, the Ku-band buffer amplifiers of the processor 603a, coupled to and arranged downstream of the first frequency-down converters, amplify the frequency-down converted beams A11-A13 in Ku band so as to generate multiple first amplified Ku-band signals or data streams, which are sent to the Ku-band frontend unit FU of the processor 603a. Concurrently, the Ku-band buffer amplifiers of the processor 603b, coupled to and arranged downstream of the second frequency-down converters, amplify the frequency-down converted beams A14-A16 in Ku band so as to generate multiple second amplified Ku-band signals or data streams, which are sent to the Ku-band frontend unit FU of the processor 603b. After that, each of the switching mechanisms 605 of the processors 603a and 603b may be simplified as its inputs from the two Ku-band units FU and 609 of the processor 603a or 603b are all in Ku band.

Alternatively, the above-mentioned first frequency-down converters may be built in the BFN 1211a and configured to convert the first conditioned signals or data streams in Ka band into ones in Ku band, and the above-mentioned second frequency-down converters may be built in the BFN 1211b and configured to convert the second conditioned signals or data streams in Ka band into ones in Ku band. The first frequency-down converters built in the BFN 1211a may be coupled to and arranged upstream of the power dividing network or matrix 46 and coupled to and arranged downstream of the conditioners 44a, and the second frequency-down converters built in the BFN 1211b may be coupled to and arranged upstream of the power dividing network or matrix 46 and coupled to and arranged downstream of the conditioners 44b. In this case, the BFN 1211a features its outputs coupled to the above-mentioned Ku-band buffer amplifiers of the processor 603a, and the BFN 1211b features its outputs coupled to the above-mentioned Ku-band buffer amplifiers of the processor 603b.

Alternatively, a multiple-aperture technology may be employed in the embodiment of FIG. 16. The multiple-beam antenna depicted in FIG. 16 may have multiple parabolic dishes or reflectors, each illuminated by one or more of the three Ku-band feeds 6a-6c and the five Ka-band feeds 5a-5e, instead of the parabolic dish or reflector 1201. For example, the multiple-beam antenna has two parabolic dishes or reflectors; one of the parabolic dish or reflector is illuminated by the feeds 5a-5e and the other one of the parabolic dish or reflector is illuminated by the feeds 6a-6c. Alternatively, the multiple-beam antenna has three parabolic dishes or reflectors; one of the parabolic dish or reflector is illuminated by the feeds 6a, 5a, 5b and 5c, another one of the parabolic dish or reflector is illuminated by the feeds 6b and 5d, and the other one of the parabolic dish or reflector is illuminated by the feeds 6c and 5e. Alternatively, a toroidal reflector may be used to instead of the offset parabolic dish or reflector 1201.

FIG. 19 depicts three Ku-band spot beams, separated by ˜9° or ˜10°, generated by the offset parabolic dish or reflector 1201 with the Ku-band feeds 6a-6c. One of the Ku-band spot beams features a beam peak P101 at a gain level of greater than 33 dBi toward the direction of the satellite orbital slot at X°. Another one features a beam peak P102 at a gain level of greater than 33 dBi toward the direction of a satellite orbital slot at X−9°. The other one features a beam peak P103 at a gain level of greater than 33 dBi toward the direction of a satellite orbital slot at X−18°. The isolations among the Ku-band spot beams are better than 30 dB.

Depending on the results of FIGS. 17A, 17B, 17C and 19, the 55-cm by 50-cm dish or reflector 1201 can support the beam isolation requirements for both Ku and Ka band by using an orthogonal-beam technique for Ka band and a multi-beam technique for Ku band.

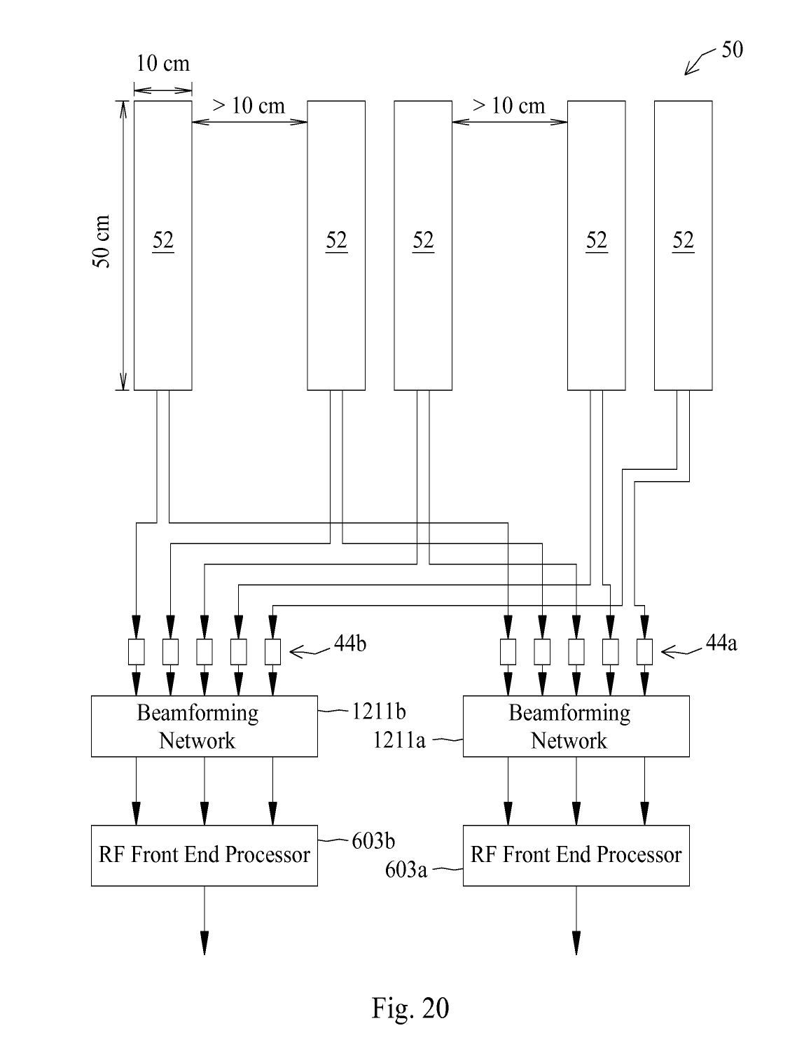

FIG. 20 depicts another outdoor unit of a satellite ground terminal for simultaneously receiving signals or data streams originated from the above-mentioned Ka-band satellites S1, S2, and S3 in the satellite orbital slots at X−2°, X°, and X+2° by three concurrent orthogonal beams at the same frequency in Ka band. Referring to FIG. 20, a direct radiating array 50 with five elements or feeds 52 are used instead of the multiple-beam antenna (MBA) having the reflector 1201 and the feeds 5a-5e and 6a-6c depicted in FIGS. 16, 18A and 18B. In this embodiment of FIG. 20, the Ka-band LNAs 92a of the conditioners 44a depicted in FIG. 16 are coupled to and arranged downstream of first input ports of the elements or feeds 52, respectively, and the Ka-band LNAs 92b of the conditioners 44b depicted in FIG. 16 are coupled to and arranged downstream of second input ports of the elements or feeds 52, respectively. In addition, the five elements or feeds 52 are non-equally spaced. Each of the five elements or feeds 52 receives or collects Ka-band signals or data streams of dual polarizations from the Ka-band satellites S1-S5 and outputs a first Ka-band signal or data stream of a first polarization in an analog format from its first output port and a second Ka-band signal or data stream of a second polarization in an analog format from its second output port. The first polarization may be vertical polarization, and the second polarization may be horizontal polarization. Alternatively, the first polarization may be right hand circular polarization, and the second polarization may be left hand circular polarization. The first and second Ka-band signals or data streams from the first and second output ports of the five elements or feeds 52 are then sent to the conditioners 44a and 44b and conditioned by the conditioners 44a and 44b, as illustrated in FIG. 16. The five elements or feeds 52 may be five flat panels having a uniform size (e.g. 10-cm by 50-cm) or various sizes. Next, as illustrated in FIGS. 16, 18A and 18B, the conditioned signals or data streams from the conditioners 44a and 44b are sent to the analogue BFNs 1211a and 1211b to generate the above-mentioned concurrent orthogonal beams A11-A16 to be sent to the RF front end processors 603a and 603b in the outdoor unit for performing the interfacing processing to the orthogonal beams A11-A16 as above mentioned. The outputs from the RF front end processors 603a and 603b shall be sent to an indoor unit of the satellite ground terminal for further receiving processing.

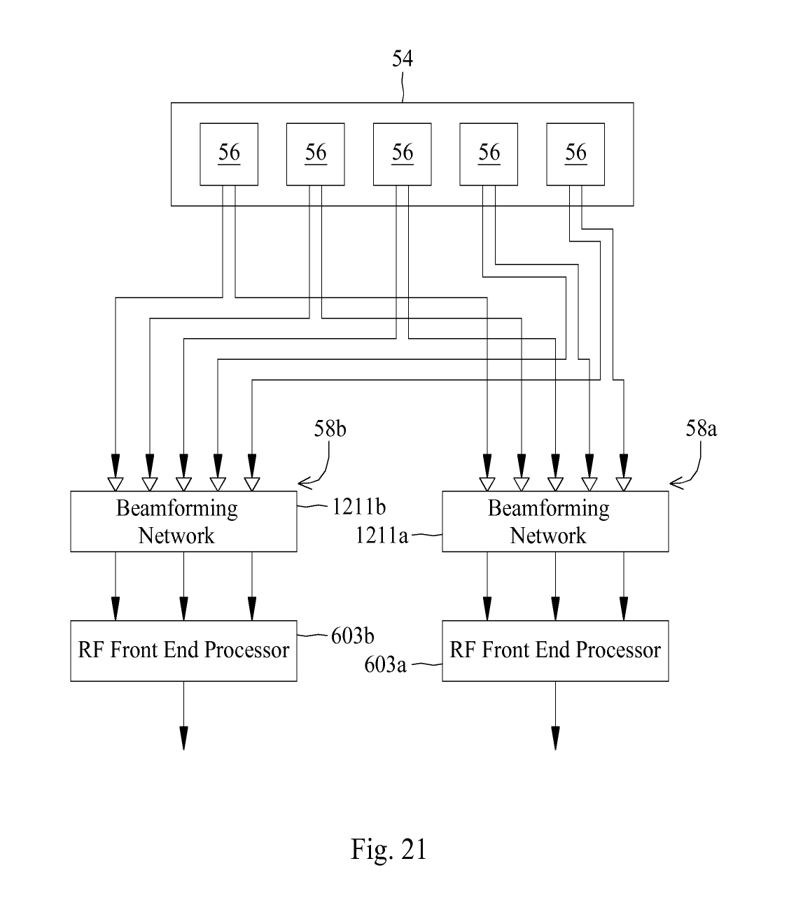

FIG. 21 depicts another outdoor unit of a satellite ground terminal for simultaneously receiving signals or data streams originated from the above-mentioned Ka-band satellites S1, S2, and S3 in the satellite orbital slots at X−2°, X°, and X+2° by three concurrent orthogonal beams at the same frequency in an alternative frequency band (e.g. L band, C band, X band, or Ku band). Referring to FIG. 21, the outdoor unit of the satellite ground terminal includes: (1) an antenna 54 with multiple elements or feeds 56; (2) multiple LNBs 58a and 58b; (3) the two above-mentioned analogue BFNs 1211a and 1211b coupled to and arranged downstream of the two respective sets of LNBs 58a and 58b; and (4) the two above-mentioned RF front end processors 603a and 603b coupled to and arranged downstream of the two respective analogue BFNs 1211a and 1211b. Each of the processors 603a and 603b has output ports coupled to an indoor unit of the satellite ground terminal via, e.g., parallel coaxial cables, optical fibers, wireless transmission, or a cable or optical fiber by using time division multiplexing transmission, frequency division multiplexing transmission, or code division multiplexing transmission. The LNBs 58a are coupled to and arranged downstream of first output ports of the elements or feeds 56, respectively, and the LNBs 58b are coupled to and arranged downstream of second output ports of the elements or feeds 56, respectively. The antenna 54 may be, for example, the multiple-beam antenna (MBA) depicted in FIG. 16, which includes the offset parabolic dish or reflector 1201 and the Ka-band feeds 5a-5e as the elements or feeds 56. Alternatively, the antenna 54 may be the direct radiating array 50 depicted in FIG. 20, which includes the flat panels 52 as the elements or feeds 56. Comparing to the architecture depicted in FIG. 16 or 20, the conditioners 44a and 44b are replaced with the LNBs 58a and 58b for not only amplifying the first and second Ka-band signals or data streams output from the feeds 5a-5e or the elements 52 but converting the first and second Ka-band signals or data streams into ones in an intermediate frequency (IF) at a lower frequency band, such as L band, C band, X band, or Ku band. Thereby, the analogue BFNs 1211a and 1211b process the received signals or data streams in the IF band, as illustrated in FIGS. 18A and 18B, so as to generate the concurrent orthogonal beams A11-A13 in the IF band to the buffer amplifiers 2b of the processor 603a and generate the concurrent orthogonal beams A14-A16 in the IF band to the buffer amplifiers 2b of the processor 603b. The RF front end processors 603a and 603b may perform interfacing processing functions to the orthogonal beams A1-A3 in the IF band; the RF front end processor 603b may perform interfacing processing functions to the orthogonal beams A14-A16 in the IF band. The outputs from the RF front end processors 603a and 603b may be sent to the indoor unit for further receiving processing through various transmission media, such as parallel coaxial cables, optical fibers, or short range wireless communication. Alternatively, referring to FIG. 21, the LNBs 58a may be built in the analogue BFN 1211a, and the LNBs 58b may be built in the analogue BFN 1211b.

Referring to FIG. 21, in each of the RF front end processors 603a and 603b depicted in FIG. 7, the front end processing units 604 may include frequency-down converters or frequency-up converters to convert the orthogonal beams A11-A16 in the lower frequency band into ones in another frequency band, such as L band, C band, X band, Ku band or Ka band, that may be the same as the signals or data streams output from the Ku front end processing units 609 to the switching mechanism 605 such that the switching mechanism 605 may process the signals or data streams in the same frequency band from the units 604 and 609. Alternatively, in each of the RF front end processors 603a and 603b depicted in FIG. 7, the Ku front end processing units 609 may include frequency-down converters or frequency-up converters to convert the signals or data streams in Ku band from the feeds 6a-6c into ones in another frequency band, such as L band, C band, X band, or Ka band, that may be the same as the signals or data streams output from the Ka front end processing units 604 to the switching mechanism 605 such that the switching mechanism 605 may process the signals or data streams in the same frequency band from the units 604 and 609.

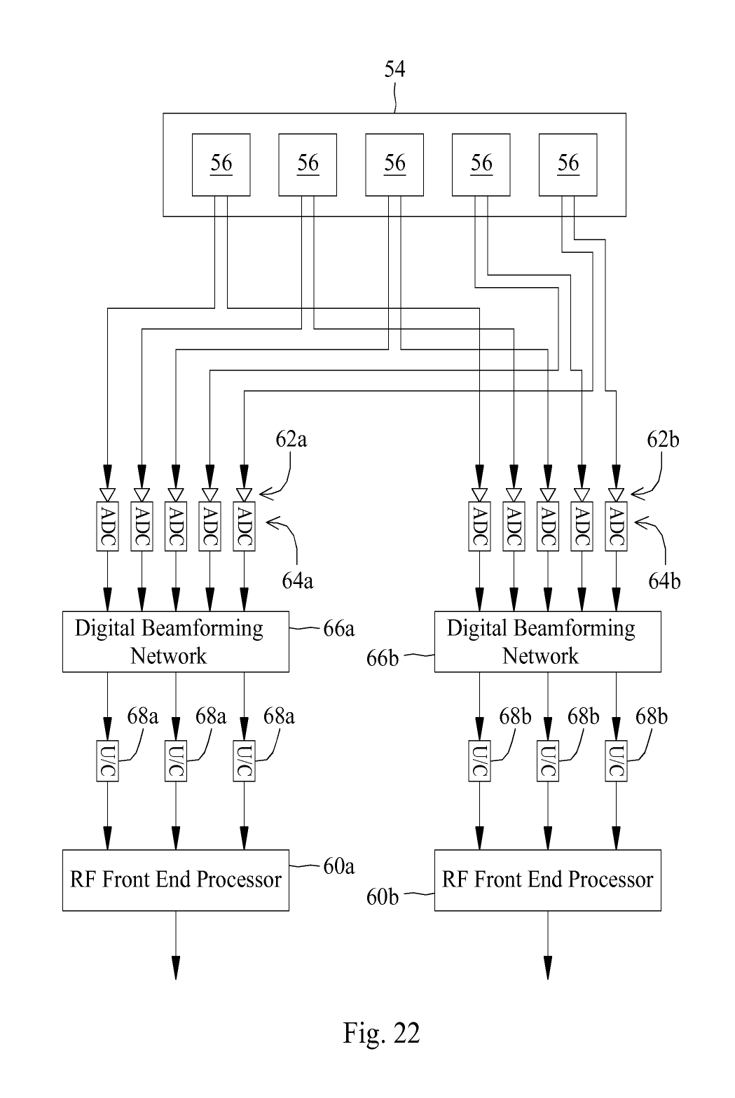

FIG. 22 depicts another outdoor unit of a satellite ground terminal for simultaneously receiving signals or data streams originated from the above-mentioned Ka-band satellites S1, S2, and S3 in the satellite orbital slots at X−2°, X°, and X+2° by three concurrent orthogonal beams at the same frequency in a certain frequency band such as baseband. Referring to FIG. 22, the outdoor unit of the satellite ground terminal includes: (1) the antenna 54 with the elements or feeds 56 as depicted in FIG. 21; (2) multiple LNBs 62a and 62b coupled to and arranged downstream of the Ka-band feeds 56; (3) multiple analog-to-digital converters (ADCs) 64a and 64b coupled to and arranged downstream of the two respective sets of LNBs 62a and 62b; (4) two digital beamforming networks (DBFNs) 66a and 66b coupled to and arranged downstream of the two respective sets of ADCs 64a and 64b; (5) multiple frequency up converters (U/Cs) 68a and 68b coupled to and arranged downstream of the two respective digital beamforming networks 66a and 66b; and (6) two RF front end processors 60a and 60b coupled to and arranged downstream of the two respective sets of U/Cs 68a and 68b. Each of the RF front end processors 60a and 60b performing the above-mentioned interfacing processing functions has output ports coupled to an indoor unit of the satellite ground terminal via, e.g., parallel coaxial cables, optical fibers, wireless transmission, or a cable or optical fiber by using time division multiplexing transmission, frequency division multiplexing transmission, or code division multiplexing transmission. The outdoor unit features the DBFNs 66a and 66b for processing signals or data streams of dual respective polarizations from the respective ADCs 64a and 64b. The dual polarizations may be circular polarizations (CP) including a right hand CP (RHCP) and a left hand CP (LHCP); and they may also be linear polarization (LP) including a vertical polarization (VP) and a horizontal polarization (HP).

In this embodiment of FIG. 22, Ka-band signals or data streams of dual polarizations (e.g. horizontal and vertical polarizations, or right hand and left hand circular polarizations) from the satellites S1-S5 depicted in FIG. 2 are received or collected by each of the elements or feeds 56. Next, each of the elements or feeds 56 features two outputs, i.e., a first Ka-band signal or data stream of a first polarization in an analog format from its first output port and a second Ka-band signal or data stream of a second polarization in an analog format from its second output port. For example, the first polarization may be vertical polarization, and the second polarization may be horizontal polarization. Alternatively, the first polarization may be right hand circular polarization, and the second polarization may be left hand circular polarization. The first Ka-band signals or data streams of the first polarization from the first output ports of the elements or feeds 56 are sent to the LNBs 62a, respectively, and the second Ka-band signals or data streams of the second polarization from the second output ports of the elements or feeds 56 are sent to the LNBs 62b, respectively. The LNBs 62a and 62b amplify the first and second signals or data streams from the first and second output ports of the elements or feeds 56 and down convert the amplified signals or data streams in Ka band into ones in a lower frequency band such as baseband. The amplified, down-converted signals or data streams in an analog format from the LNBs 62a (hereinafter referred to as signals or data streams L11) are sent to the ADCs 64a, which convert the analog signals or data streams L11 in the first polarization into first digital signals or data streams. The first digital signals or data streams are digital representations of the analog signals or data streams L11, respectively. The amplified, down-converted signals or data streams in an analog format from the LNBs 62b (hereinafter referred to as analog signals or data streams L12) are sent to the ADCs 64b, which convert the analog signals or data streams L12 into second digital signals or data streams. The second digital signals or data streams are digital representations of the analog signals or data streams L12, respectively.

The first digital signals or data streams in the first polarization from the ADCs 64a are sent to the DBFN 66a, which generates at least three simultaneous fixed or dynamic orthogonal beams (hereinafter referred to as orthogonal beams DO11) in the first polarization at the lower frequency band such as baseband. In addition, the second digital signals or data streams in the second polarization from the ADCs 64b are sent to the DBFN 66b, which generates at least three simultaneous fixed or dynamic orthogonal beams (hereinafter referred to as orthogonal beams DO12) in the second polarization at the lower frequency band such as baseband.

Beam shaping techniques are used in designing the orthogonal beams DO11 and DO12. The shapes of the orthogonal beams DO11 are based on a first set of beam weighting vectors (BWVs) calculated by an optimization algorithm, and the shapes of the orthogonal beams DO12 are based on a second set of beam weighting vectors (BWVs) calculated by the optimization algorithm. For example, one of the orthogonal beams DO11 may be formed by the DBFN 66a multiplying or weighting first amplitude and phase weightings, i.e. the corresponding BWV in the first set, on the respective first digital signals or data streams so as to form a set of first weighted signals or data streams, and summing the set of first weighted signals or data streams. One of the orthogonal beams DO12 may be formed by the DBFN 66b multiplying or weighting second amplitude and phase weightings, i.e. the corresponding BWV in the second set, on the respective second digital signals or data streams so as to form a set of second weighted signals or data streams, and summing the set of second weighted signals or data stream. The first BWVs for the first digital signals or data streams may be the same as the second optimized BWVs for the second digital signals or data streams.

The orthogonal beams DO11 may be vertically polarized (VP) beams while the orthogonal beams DO12 may be horizontally polarized (HP) beams. Alternatively, the orthogonal beams DO11 may be right hand circular polarized (RHCP) beams while the orthogonal beams DO12 may be left hand circular polarized (LHCP) beams. Each of the orthogonal beams DO11 in the first polarization may be formed by enhancing or suppressing gain of the element beams based on a corresponding set of amplitude and phase weightings (e.g. the first amplitude and phase weightings) that may be calculated or altered based on an optimization process. Each of the orthogonal beams DO12 in the second polarization may be formed by enhancing or suppressing gain of the element beams based on a corresponding set of amplitude and phase weightings (e.g. the second amplitude and phase weightings) that may be calculated or altered based on an optimization process. In one example, the orthogonal beams DO11 in the first polarization may have the same radiation patterns as the above-mentioned orthogonal beams A11-A13, respectively; the orthogonal beams DO12 in the second polarization may have the same radiation patterns as the above-mentioned orthogonal beams A14-A16, respectively.

Next, referring to FIG. 22, the signals or data streams, i.e. the orthogonal beams DO11, from the DBFN 66a are sent to the U/Cs 68a, respectively, and then up-converted from the lower frequency band (such as baseband) to a higher frequency band (such as Ku band, L band, C band, or X band) so as to form first up-converted signals or data streams in the first polarization. Concurrently, the signals or data streams, i.e. the orthogonal beams DO12, from the DBFN 66b are sent to the U/Cs 68b, respectively, and then up-converted from the lower frequency band (such as baseband) to the higher frequency band (such as Ku band, L band, C band, or X band) so as to form second up-converted signals or data streams in the second polarization. The first up-converted signals or data streams from the U/Cs 68a are sent to the RF front end processor 60a, which may include a switch mechanism for selecting one or more of the first up-converted signals or data streams in a digital format to be output to the indoor unit via, e.g., parallel coaxial cables, optical fibers, or other means including wireless transmission. The second up-converted signals or data streams from the U/Cs 68b are sent to the RF front end processor 60b, which may include a switch mechanism for selecting one or more of the second up-converted signals or data streams in a digital format to be output to the indoor unit via, e.g., parallel coaxial cables, optical fibers, or other means including wireless transmission.

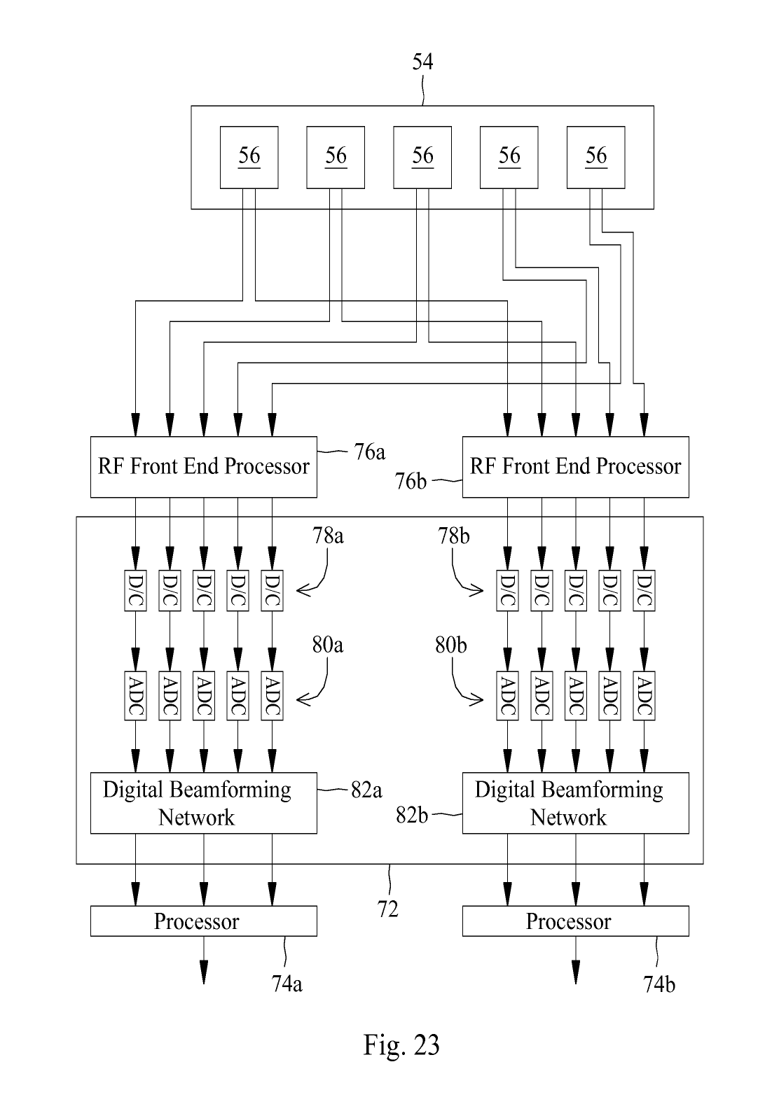

FIG. 23 depicts a simplified block diagram of a satellite ground terminal for simultaneously receiving signals or data streams originated from the above-mentioned Ka-band satellites S1, S2, and S3 in the satellite orbital slots at X−2°, X°, and X+2° by three concurrent orthogonal beams at the same frequency in baseband. Referring to FIG. 23, the satellite ground terminal includes: (1) a setup box including an indoor unit 72 and two processors 74a and 74b; and (2) an outdoor unit including the antenna 54 with the elements or feeds 56 as depicted in FIG. 21 and two RF front end processors 76a and 76b coupled to and arranged downstream of the elements or feeds 56.

The indoor unit 72 includes (1) multiple frequency down converters (D/Cs) 78a coupled to and arranged downstream of the RF front end processor 76a, (2) multiple frequency down converters (D/Cs) 78b coupled to and arranged downstream of the RF front end processor 76b, (3) multiple analog-to-digital converters (ADCs) 80a coupled to and arranged downstream of the frequency down converters 78a, (4) multiple analog-to-digital converters (ADCs) 80b coupled to and arranged downstream of the frequency down converters 78b, (5) a digital beamforming network (DBFN) 82a coupled to and arranged downstream of the ADCs 80a, and (6) a digital beamforming network (DBFN) 82b coupled to and arranged downstream of the ADCs 80b. The two processors 74a and 74b are coupled to and arranged downstream of the two DBFNs 82a and 82b, respectively. Each of the RF front end processors 76a and 76b may be coupled to the frequency down converters 78a or 78b of the indoor unit 72 via, e.g., parallel coaxial cables, optical fibers, wireless transmission, or a cable or optical fiber by using time division multiplexing transmission, frequency division multiplexing transmission, or code division multiplexing transmission.

This is an architecture using remote beamforming techniques and will require transport all received element signals from the elements 56 to the remote DBFNs 82a and 82b of the indoor unit 72. There shall be multiple parallel paths between the elements 56 and any one of the remote DBFNs 82a and 82b. For the five elements 56, there are five parallel paths from the elements 56 to any one of the remote DBFNs 82a and 82b. As a result, equalizations among the five parallel paths are essential for remote beam forming and will be key concerns for the remote DBFNs 82a and 82b. There are many techniques in digital beamforming networks for parallel paths calibrations and equalizations for both design and implementation phases and during operations.

In this embodiment of FIG. 23, Ka-band signals of dual polarizations (e.g. horizontal and vertical polarizations, or right hand and left hand circular polarizations) from the satellites S1-S5 depicted in FIG. 2 are received or collected by each of the elements or feeds 56. Next, each of the elements or feeds 56 features two outputs, i.e., a first Ka-band signal or data stream of a first polarization in an analog format from its first output port and a second Ka-band signal or data stream of a second polarization in an analog format from its second output port. The first polarization may be vertical polarization, and the second polarization may be horizontal polarization. Alternatively, the first polarization may be right hand circular polarization, and the second polarization may be left hand circular polarization. The first Ka-band signals or data streams of the first polarization from the first output ports of the elements or feeds 56 are sent to the RF front end processor 76a, and the second Ka-band signals or data streams of the second polarization from the second output ports of the elements or feeds 56 are sent to the RF front end processor 76b.

Referring to FIG. 23, the RF front end processors 76a and 76b may be implemented in many ways. In one approach, each of the RF front end processors 76a and 76b may include (1) five Ka-band LNAs coupled to and arranged downstream of the corresponding first or second output ports of the feed elements 56 respectively, (2) five Ka-band BPFs coupled to and arranged downstream of the Ka-band LNAs respectively, (3) five frequency down convertors (e.g. for converting input signals or data streams in Ka band into ones in an intermediate frequency (IF) at L or C band) coupled to and arranged downstream of the Ka-band BPFs respectively, (4) five IF buffer amplifiers coupled to and arranged downstream of the frequency down convertors respectively, and (5) five output ports coupled to and arranged downstream of the IF buffer amplifiers respectively. The five output ports of each of the processors 76a and 76b may be coupled to five inputs of five parallel coaxial cables, respectively. At the other ends of the five parallel coaxial cables coupled to the processor 76a, five outputs of the five parallel coaxial cables coupled to the processor 76a are sent to the DBFN 82a after they are frequency down converted by the D/Cs 78a and digitized by the ADCs 80a. Concurrently, at the other ends of the five parallel coaxial cables coupled to the processor 76b, five outputs of the five parallel coaxial cables coupled to the processor 76b are sent to the DBFN 82b after they are frequency down converted by the D/Cs 78b and digitized by the ADCs 80b.

In this approach, the Ka-band LNAs of the processor 76a amplify the first Ka-band signals or data streams of the first polarization from the first output ports of the elements or feeds 56, respectively, to generate first amplified Ka-band signals or data streams of the first polarization. Concurrently, the Ka-band LNAs of the processor 76b amplify the second Ka-band signals or data streams of the second polarization from the second output ports of the elements or feeds 56, respectively, to generate second amplified Ka-band signals or data streams of the second polarization. Next, the BPFs of the processor 76a pass the first amplified Ka-band signals or data streams of the first polarization only in a certain band of frequencies while attenuating the first amplified Ka-band signals or data streams of the first polarization outside the certain band so as to form first band-pass filtered signals or data streams in Ka band; concurrently, the BPFs of the processor 76b pass the second amplified Ka-band signals or data streams of the second polarization only in the certain band of frequencies while attenuating the second amplified signals or data streams of the second polarization outside the certain band so as to form second band-pass filtered signals or data streams in Ka band.

Next, the frequency down convertors of the processor 76a down convert the first band-pass filtered signals or data streams in Ka band into ones in an intermediate frequency (IF) at L or C band so as to generate first IF signals or data streams; concurrently, the frequency down convertors of the processor 76b down convert the second band-pass filtered signals or data streams in Ka band into ones in an intermediate frequency (IF) at L or C band so as to generate second IF signals or data streams. Next, the IF buffer amplifiers of the processor 76a amplify the first IF signals or data streams to generate first amplified IF signals or data streams to be sent to the output ports of the processor 76a; concurrently, the IF buffer amplifiers of the processor 76b amplify the second IF signals or data streams to generate second amplified IF signals or data streams to be sent to the output ports of the processor 76b. The first amplified IF signals or data streams are sent to the D/Cs 78a of the indoor unit 72 through the five parallel coaxial cables connecting the processor 76a and the D/Cs 78a of the indoor unit 72; the second amplified IF signals or data streams are sent to the D/Cs 78b of the indoor unit 72 through the five parallel coaxial cables connecting the processor 76b and the D/Cs 78b of the indoor unit 72.

Alternatively, the RF front end processors 76a and 76b may be designed to be implemented by more advanced technologies to provide broader bandwidth with lower cost. In an alternate and more advanced approach, each of the processors 76a and 76b may include (1) five Ka-band LNAs coupled to and arranged downstream of the corresponding first or second output ports of the feed elements 56 respectively, (2) five Ka-band BPFs coupled to and arranged downstream of the Ka-band LNAs respectively, (3) five Ka-band buffer amplifiers coupled to and arranged downstream of the Ka-band BPFs respectively, (4) a 5-to-1 multiplexer coupled to and arranged downstream of the Ka-band buffer amplifiers, and (5) a radio frequency (RF) to optical converter (or RF-to-optical converter) coupled to and arranged downstream of the 5-to-1 multiplexer. The RF-to-optical converters of the processors 76a and 76b may be coupled to two optical fibers, respectively. In this case, the indoor unit 72 may include (1) two optical-to-RF converters coupled to the other ends of the optical fibers respectively, and (2) two 1-to-5 de-multiplexers coupled to and arranged downstream of the optical-to-RF converters respectively. The de-multiplexed signals or data streams output from the two 1-to-5 de-multiplexers are sent to the DBFNs 82a and 82b after they are frequency down converted by the D/Cs 78a and 78b and digitized by the ADCs 80a and 80b.

The two 5-to-1 multiplexers of the processors 76a and 76b may be two 5-to-1 time division multiplexers respectively, each of which is configured to multiplex its five inputs in parallel into an output, containing its inputs in serial, based on time division, while the two 1-to-5 de-multiplexers of the indoor unit 72 may be two 1-to-5 time division de-multiplexers respectively, each of which is configured to output five outputs in parallel by demultiplexing an input, i.e. the output of the corresponding 5-to-1 multiplexer, based on time division. Alternatively, the two 5-to-1 multiplexers of the processors 76a and 76b may be two 5-to-1 frequency division multiplexers respectively, each of which is configured to multiplex its five inputs in parallel into an output, containing its inputs in different frequencies, based on frequency division while the two 1-to-5 de-multiplexers of the indoor unit 72 may be two 1-to-5 frequency division de-multiplexers respectively, each of which is configured to output five outputs in parallel by demultiplexing an input, i.e. the output of the corresponding 5-to-1 multiplexer, based on frequency division. Alternatively, the two 5-to-1 multiplexers of the processors 76a and 76b may be two 5-to-1 code division multiplexers respectively, each of which is configured to multiplex its five inputs in parallel into an output, combining its inputs multiplied or weighted by codes, based on code division while the two 1-to-5 de-multiplexers of the indoor unit 72 may be two 1-to-5 code division demultiplexers respectively, each of which is configured to output five outputs in parallel by demultiplexing an input, i.e. the output of the corresponding 5-to-1 multiplexer, based on code division.

In the alternate and more advanced approach, the Ka-band LNAs of the processor 76a amplify the first Ka-band signals or data streams of the first polarization from the first output ports of the elements or feeds 56, respectively, to generate first amplified Ka-band signals or data streams of the first polarization; concurrently, the Ka-band LNAs of the processor 76b amplify the second Ka-band signals or data streams of the second polarization from the second output ports of the elements or feeds 56, respectively, to generate second amplified Ka-band signals or data streams of the second polarization. Next, the BPFs of the processor 76a pass the first amplified Ka-band signals or data streams of the first polarization only in a certain band of frequencies while attenuating the first amplified Ka-band signals or data streams of the first polarization outside the certain band so as to form first band-pass filtered signals or data streams in Ka band; concurrently, the BPFs of the processor 76b pass the second amplified Ka-band signals or data streams of the second polarization only in the certain band of frequencies while attenuating the second amplified signals or data streams of the second polarization outside the certain band so as to form second band-pass filtered signals or data streams in Ka band.

Next, the Ka-band buffer amplifiers of the processor 76a amplify the first band-pass filtered signals or data streams to generate first amplified, filtered signals or data streams; concurrently, the Ka-band buffer amplifiers of the processor 76b amplify the second band-pass filtered signals or data streams to generate second amplified, filtered signals or data streams. Next, the 5-to-1 multiplexer of the processor 76a combines the first amplified, filtered signals or data streams in parallel into a first RF output signal or data stream based on the above-mentioned time division, frequency division or code division and sends the first RF output signal or data stream to the RF-to-optical converter of the processor 76a; concurrently, the 5-to-1 multiplexer of the processor 76b combines the second amplified, filtered signals or data streams in parallel into a second RF output signal or data stream based on the above-mentioned time division, frequency division or code division and sends the second RF output signal or data stream to the RF-to-optical converter of the processor 76b. Next, the RF-to-optical converter of the processor 76a converts the first RF output signal or data stream in an electronic mode into a first optical signal or data stream in an optical mode, which is sent to one of the optical fibers; concurrently, the RF-to-optical converter of the processor 76b converts the second RF output signal or data stream in an electronic mode into a second optical signal or data stream in an optical mode, which is sent to the other one of the optical fibers.

Next, one of the optical-to-RF converters of the indoor unit 72 converts the first optical signal or data stream in an optical mode into a first RF signal or data stream (hereinafter referred to as signal or data stream RS3) in an electronic mode, which is sent to one of the 1-to-5 de-multiplexers of the indoor unit 72; concurrently, the other one of the optical-to-RF converters of the indoor unit 72 converts the second optical signal or data stream in an optical mode into a second RF signal or data stream (hereinafter referred to as signal or data stream RS4) in an electronic mode, which is sent to the other one of the 1-to-5 de-multiplexers of the indoor unit 72. Next, one of the 1-to-5 de-multiplexers splits the signal or data stream RS3 carrying multiple payloads up into multiple first de-multiplexed signals or data streams in parallel, which are sent to the D/Cs 78a of the indoor unit 72; the other one of the 1-to-5 de-multiplexers splits the signal or data stream RS4 carrying multiple payloads up into multiple second de-multiplexed signals or data streams in parallel, which are sent to the D/Cs 78b of the indoor unit 72.

Referring to FIG. 23, the signals or data streams output from the processor 76a, i.e. the above-mentioned first amplified IF signals or data streams or the above-mentioned first de-multiplexed signals or data streams, are down-converted into ones in baseband by the D/Cs 78a; concurrently, the signals or data streams output from the processor 76b, i.e. the above-mentioned second amplified IF signals or data streams or the above-mentioned second de-multiplexed signals or data streams, are down-converted into ones in baseband by the D/Cs 78b. Next, inside the indoor unit 72, the down-converted signals or data streams in an analog format output from the D/Cs 78a (hereinafter referred to as analog signals or data streams L17) are sent to the ADCs 80a, which convert the analog signals or data streams L17 into first digital signals or data streams. The first digital signals or data streams are digital representations of the analog signals or data streams L17. The down-converted signals or data streams in an analog format output from the D/Cs 78b (hereinafter referred to as analog signals or data streams L18) are sent to the ADCs 80b, which convert the analog signals or data streams L18 into second digital signals or data streams. The analog signals or data streams L18 are digital representations of the analog signals or data streams L18. The first digital signals or data streams output from the ADCs 80a are sent to the DBFN 82a, which generates at least three simultaneous fixed or dynamic orthogonal beams (hereinafter referred to as orthogonal beams DO13) at baseband. In addition, the second digital signals or data streams output from the ADCs 80b are sent to the DBFN 82b, which generates at least three simultaneous fixed or dynamic orthogonal beams (hereinafter referred to as orthogonal beams DO14) at baseband. Next, the orthogonal beams DO13 are sent to the first processor 74a for further receiving functions such as synchronization, channalizations, and demodulations; concurrently, the orthogonal beams DO14 are sent to the second processor 74b for further receiving functions such as synchronization, channalizations, and demodulations.

Beam shaping techniques are used in designing these orthogonal beams DO13 and DO14. The shapes of the orthogonal beams DO13 are based on a first set of BWVs calculated by an optimization algorithm, and the shapes of the orthogonal beams DO14 are based on a second set of BWVs calculated by the optimization algorithm. For example, one of the orthogonal beams DO13 may be formed by the DBFN 82a multiplying or weighting first amplitude and phase weightings, i.e. the BWV in the first set, on the respective first digital signals or data streams so as to form a set of first weighted signals or data streams, and summing the set of first weighted signals or data streams. One of the orthogonal beams DO14 may be formed by the DBFN 82b multiplying or weighting second amplitude and phase weightings, i.e. the BWV in the second set, on the respective second digital signals or data streams so as to form a set of second weighted signals or data streams, and summing the set of second weighted signals or data streams. The BWVs in the first set may be, for example, the same as the BWVs in the second set.

The orthogonal beams DO13 may be vertically polarized (VP) beams, and the orthogonal beams DO14 may be horizontally polarized (HP) beams. Alternatively, the orthogonal beams DO13 may be right hand circular polarized (RHCP) beams, and the orthogonal beams DO14 may be left hand circular polarized (LHCP) beams. In one example, the orthogonal beams DO13 may have the same radiation patterns as the above-mentioned orthogonal beams A11-A13, respectively; the orthogonal beams DO14 may have the same radiation patterns as the above-mentioned orthogonal beams A14-A16, respectively.

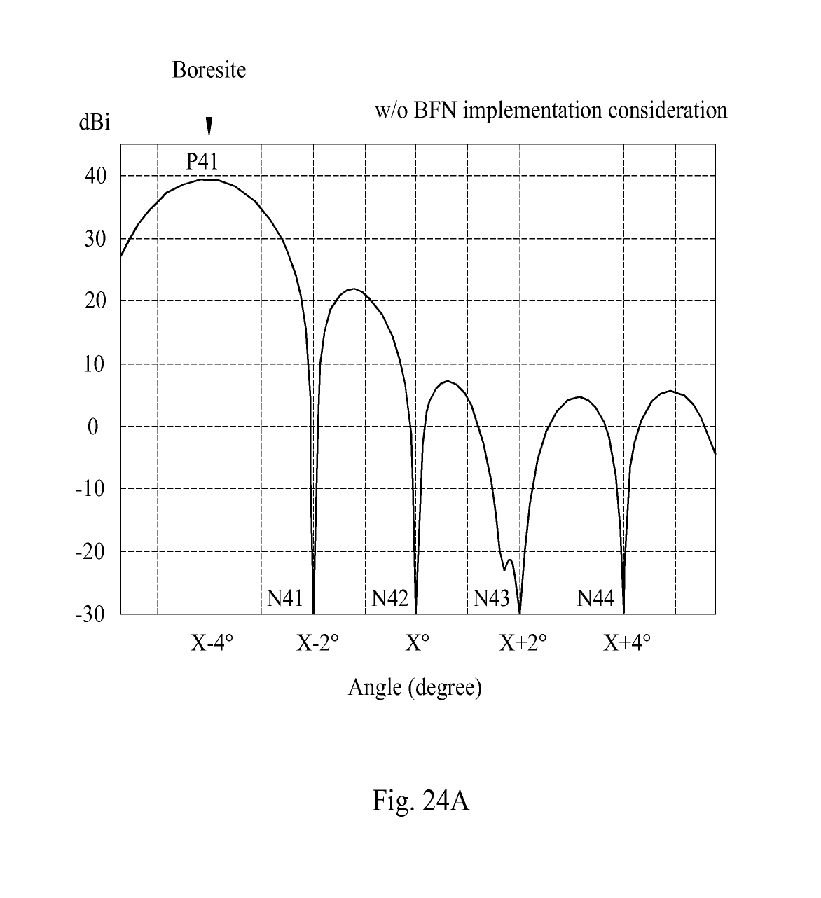

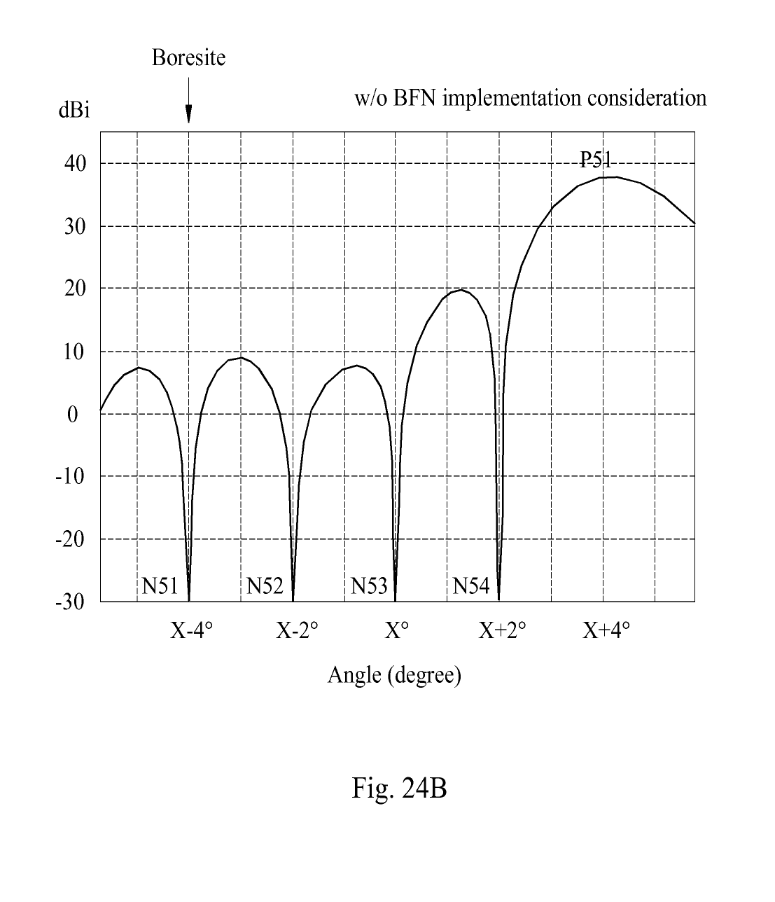

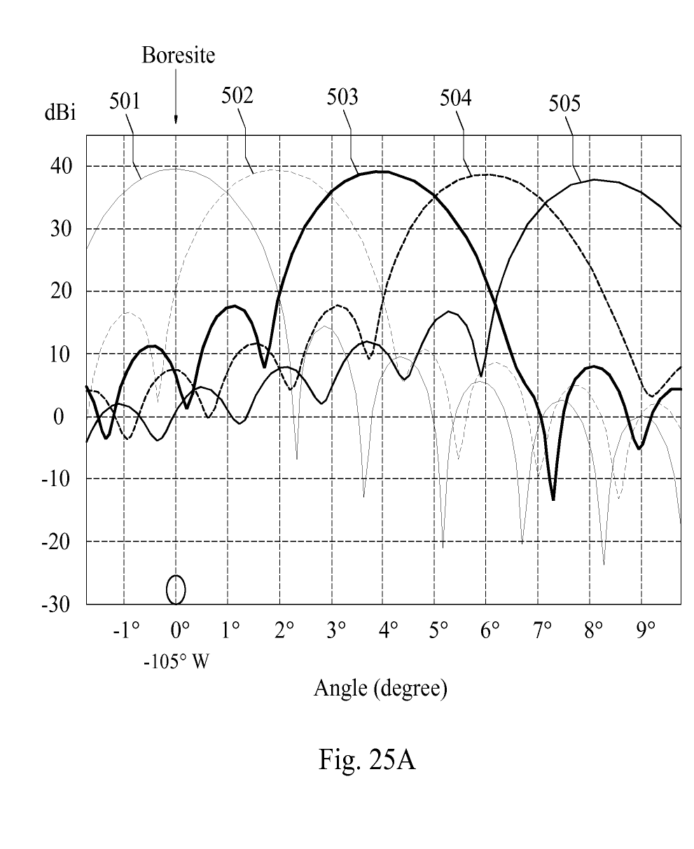

Besides simultaneously receiving signals or data streams originated from the Ka-band satellites S1, S2, and S3 in the satellite orbital slots at X−2°, X°, and X+2° depicted in FIG. 2, the outdoor unit of a satellite ground terminal depicted in FIG. 16 may simultaneously receive signals or data streams originated from the Ka-band satellites S4 and S5 in the satellite orbital slots at X−4° and X+4° depicted in FIG. 2 by five concurrent orthogonal beams at the same frequency in a frequency band (e.g. Ka band in this embodiment, Ku band, L band, C band, or X band). The five orthogonal beams include the three beams depicted in FIGS. 17A, 17B and 17C for receiving signals or data streams originated from the satellites S1, S2, and S3 and two beams depicted in FIGS. 24A and 24B for receiving signals or data streams originated from the satellites S4 and S5.

Referring to FIG. 24A, the orthogonal beam features a peak P41 of a main lobe in the direction of a desired satellite, i.e. the satellite S4 in the satellite orbital slot of X−4° as illustrated in FIG. 2, for enhancing gain of data streams or signals radiated from the satellite S4 and four nulls N41, N42, N43 and N44 in the four respective directions of potential interferences radiated from the satellites S1, S2, S3 and S5 in the four respective satellite orbital slots of X−2°, X°, X+2°, and X+4° as illustrated in FIG. 2 for suppressing gain of data streams or signals radiated from the satellites S1, S2, S3 and S5. The peak gain of the main lobe for the orthogonal beam depicted in FIG. 24A is above 39 dBi in the satellite space slot of X−4° while the gains in the satellite space slots of X−2°, X°, X+2° and X+4° are all suppressed to less than −30 dBi. The isolation of the gain for desired data streams or signals from the satellite S4 in the space slot of X−4° against the gain for potential interference from either of the satellites S1, S2, S3 and S5 in the respective space slots of X−2°, X°, X+2° and X+4° may be better than 30 dB or 60 dB. In the other words, the orthogonal beam depicted in FIG. 24A features spatial isolation greater than 30 dB or 60 dB between the gain for the desired data streams or signals from the satellite S4 in the space slot of X−4° and the gain for potential interference radiated by any one of the satellites S1, S2, S3 and S5 at respective angles of X−2°, X°, X+2° and X+4°.

Referring to FIG. 24B, the orthogonal beam features a peak P51 of a main lobe in the direction of a desired satellite, i.e. the satellite S5 in the satellite orbital slot of X+4° as illustrated in FIG. 2, for enhancing gain of data streams or signals radiated from the satellite S5 and four nulls N51, N52, N53 and N54 in the four respective directions of potential interferences radiated from the satellites S1-S4 in the four respective satellite orbital slots of X−2°, X°, X+2°, and X−4° as illustrated in FIG. 2 for suppressing gain of data streams or signals radiated from the satellites S1-S4. The peak gain of the main lobe for the orthogonal beam depicted in FIG. 24B is above 37 dBi in the satellite space slot of X+4° while the gains in the satellite space slots of X−2°, X°, X+2° and X−4° are all suppressed to less than −30 dBi. The isolation of the gain for desired data streams or signals from the satellite S5 in the space slot of X+4° against the gain for potential interference from either of the satellites S1-S4 in the respective space slots of X−2°, X°, X+2° and X−4° may be better than 30 dB or 60 dB. In the other words, the orthogonal beam depicted in FIG. 24B features spatial isolation greater than 30 dB or 60 dB between the gain for the desired data streams or signals from the satellite S5 in the space slot of X+4° and the gain for potential interference radiated by any one of the satellites S1-S4 at respective angles of X−2°, X°, X+2° and X−4°.

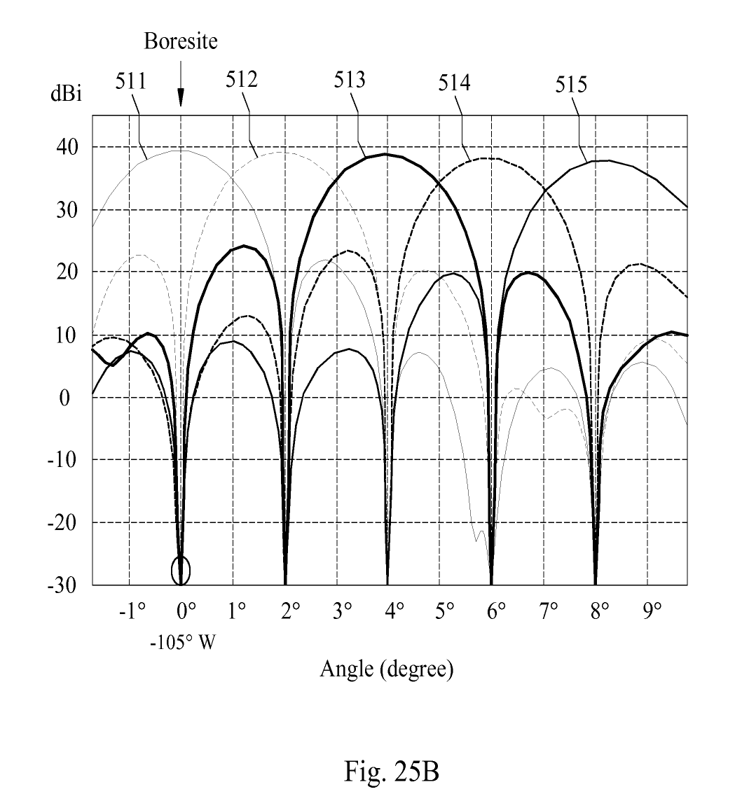

FIGS. 25A and 25B depict two groups of Ka-band radiation patterns from a multi-beam antenna with a 55-cm by 50-cm aperture. The two groups of beams are (1) five spot beams 501, 502, 503, 504, and 505 respectively pointed at 0°, 2°, 4°, 6°, and 8° as depicted in FIG. 25A, i.e. pointed at the satellite orbital slots of X−4°, X−2°, X°, X+2° and X+4°, and (2) five orthogonal beams 511, 512, 503, 504, and 505 respectively pointed at 0°, 2°, 4°, 6°, and 8° as depicted in FIG. 25B, i.e. pointed at the satellite orbital slots of X−4°, X−2°, X°, X+2° and X+4°. Referring to FIGS. 25A and 25B, the boresights are set at 0°, i.e. at the satellite orbital slot of X−4°, instead of at the satellite orbital slot of X°. Alternatively, the beam scans for the remaining 4 off-axis beams may be all in the positive (azimuthal) angle only, instead of pointed at X+2°, X+4°, and X−2°, X−4°. Referring to FIG. 25A, the 5 spot beams 501, 502, 503, 504, and 505 have peak gains of 39.5 dBi, 39.4 dBi, 39.3 dBi, 38.7 dBi, and 38 dBi, respectively. The peak gain of the spot beam 502 at the satellite orbital slot of X−2°, i.e. 2° in FIG. 25A, is about 39.4 dBi while the gain of the spot beam 502 at the satellite orbital slot of X−4°, i.e. 0° in FIG. 25A, is 22 dBi. It is noticed that the spot beam 501 has a beam peak at a gain level of 39.5 dBi pointed at the direction of X−4°, i.e. 0° in FIG. 25A. Therefore, the isolations, measured in signal-to-interference ratio, i.e. S/I, between the two spot beams 501 and 502 are less than 18 dB at the satellite orbital slot of X−4°, i.e. 0° in FIG. 25A. Similarly, it may be identified that the isolation of a specific one of the beams 501-505 having a specific beam peak in the direction of a specific satellite orbital slot against another one of the beams 501-505 having a beam peak in the direction of another satellite orbital slot adjacent to the specific satellite orbital slot is less than 18 dB, as shown in FIG. 25A.

Referring to FIG. 25B, the 5 orthogonal beams 511, 512, 513, 514, and 515 have peak gains of 39.4 dBi, 39.2 dBi, 38.8 dBi, 38.3 dBi, and 37.9 dBi, respectively pointed at 0°, 2°, 4°, 6°, and 8° as depicted in FIG. 25B, i.e. pointed at the satellite orbital slots of X−4°, X−2°, X°, X+2° and X+4°. The gain of the orthogonal beam 512 at 0°, i.e. the satellite orbital slot of X−4°, is less than −30 dBi. It is noticed that the orthogonal beam 511 has a beam peak pointed at the direction of 0°, i.e. the satellite orbital slot of X−4°. Therefore, the isolations (measured in signal-to-interference ratio or S/I between the orthogonal beam 511 having a beam peak pointed at 0°, i.e. the satellite orbital slot of X−4°, and the orthogonal beam 512 having a beam peak pointed at 2°, i.e. the satellite orbital slot of X−2°) are better than 60 dB at 0°, i.e. the satellite orbital slot of X−4°. Similarly, it may be identified that the isolation of a specific one of the orthogonal beams 511-515 having a specific beam peak in the direction of a specific satellite orbital slot against another one of the orthogonal beams 511-515 having a beam peak in the direction of another satellite orbital slot adjacent to the specific satellite orbital slot is better than 60 dB, as shown in FIG. 25B.

Referring to FIGS. 25A and 25B, it is clear the peak gains of the five orthogonal beams 511, 512, 513, 514, and 515 are slightly less than those of the five spot beams 501, 502, 503, 504, and 505 respectively. The differences between the peak gains of the beams 511 and 501, between the peak gains of the beams 512 and 502, between the peak gains of the beams 513 and 503, between the peak gains of the beams 514 and 504 or between the peak gains of the beams 515 and 505 are less than 0.2 dB. However, the orthogonal beams 511, 512, 513, 514, and 515 provide much better isolations or S/I of the peak gain of one of the orthogonal beams 511-515 pointed at one of the satellite orbital slots of X−4°, X−2°, X°, X+2° and X+4° against gain levels at nulls of the others of the orthogonal beams 511-515 pointed at said one of the satellite orbital slots.

The invention can enhance the performance of (1) signals availability, (2) configurable via programming, and/or (3) supporting satellite links with smaller dishes by using an orthogonal-beam technique. Furthermore, with orthogonal-beam technologies for illuminating interferences from closely spaced (<2 degree) satellites covering same serve areas with same frequencies and polarizations, it is possible to have additional Ka assets inserted into the space between the satellite orbital slot of X° and the satellite orbital slot of X+2° or X−2° illustrated in FIG. 2. This new constellation with more satellite orbital slots added between the satellite orbital slot of X° and the satellite orbital slot of X+2° or X−2° shall communicate independently with ground terminals with orthogonal beams in the same coverage using same frequency spectrum in the same polarization without mutual interferences among satellites due to enhanced directional isolations provide by the orthogonal beams. Thus, more space assets in the limited space shall become available (1) to enhance availability for existing program signals, and/or (2) to deliver more programs. In addition, the reflector may feature a smaller aperture size with 50 cm in a vertical (elevation) axis thereof and 65 cm or less in a horizontal (azimuth) axis thereof, such as between 50 cm and 65 cm in the horizontal (azimuth) axis thereof to form orthogonal beams providing services with enhance isolations.

Alternatively, by using a multiple-aperture array technology and beam shaping technique, the invention shall enable two or more Ka-band satellite orbital slots to operate independently with minimum interference at the same frequency band, polarization and same coverage. Current Ka band for DBS TV service constellations are for satellites in five orbital slots of X−4°, X−2°, X°, X−2°, and X+4°. The extend 8° orbital slot range would be able to support more than 5 Ka DBS slots if orthogonal-beam ground terminals are used. Thereby, the neighboring satellite orbital slots may only be separate from each other by less than 1.5 degrees, such as between 1.5 and 0.5 degrees.

In addition, the invention can dynamically allocate the available power and bandwidths in space when incorporating with a wave-front multiplexing technique, which features multidimensional waveforms and may be very useful to a service provider. The above-mentioned architectures enable operator to allocate existing asset (e.g. bandwidth) to various subscribers more effectively and improve isolations among neighboring satellites operating in the same frequency slot in a satellite communication frequency band (e.g. Ka band, UHF, L/S band, C band, X band, or Ku band).

The above-mentioned embodiments of the present invention may be, but not limited to, applied to a wireless communication system, a radio frequency communication system, a satellite communication system, a direct broadcasting satellite system, or a communication system between a satellite ground terminal and one or more satellites.

The components, steps, features, benefits and advantages that have been discussed are merely illustrative. None of them, nor the discussions relating to them, are intended to limit the scope of protection in any way. Numerous other embodiments are also contemplated. These include embodiments that have fewer, additional, and/or different components, steps, features, benefits and advantages. These also include embodiments in which the components and/or steps are arranged and/or ordered differently.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain. Furthermore, unless stated otherwise, the numerical ranges provided are intended to be inclusive of the stated lower and upper values. Moreover, unless stated otherwise, all material selections and numerical values are representative of preferred embodiments and other ranges and/or materials may be used.

The scope of protection is limited solely by the claims, and such scope is intended and should be interpreted to be as broad as is consistent with the ordinary meaning of the language that is used in the claims when interpreted in light of this specification and the prosecution history that follows, and to encompass all structural and functional equivalents thereof.

What is claimed is:

1. A satellite ground terminal comprising:
an antenna comprising multiple feeds, wherein said feeds are each configured to collect satellite signals in Ka band from multiple different orbital satellites so as to output Ka-band signals in an analog format, wherein said different orbital satellites comprise first and second satellites;
an analogue beamforming network arranged downstream of said antenna, wherein said analogue beamforming network is configured to form multiple concurrent orthogonal beams at the same frequency in a frequency band based on said Ka-band signals, wherein said concurrent orthogonal beams comprises first and second orthogonal beams, wherein said first orthogonal beam comprises a first beam peak in a direction of said first satellite and a first null substantially in a direction of said second satellite, wherein said second orthogonal beam comprises a second beam peak in said direction of said second satellite and a second null substantially in said direction of said first satellite; and
a front end processor arranged downstream of said analogue beamforming network.

2. The satellite ground terminal of claim 1, wherein the number of said feeds is equal to or more than the number of satellite orbital slots allocated for said different orbital satellites.

3. The satellite ground terminal of claim 1 comprising a direct broadcasting satellite (DBS) TV terminal.

4. The satellite ground terminal of claim 1 further comprising an indoor unit configured to receive signals from said front end processor.

5. The satellite ground terminal of claim 1, wherein said frequency band is in Ka band.

6. The satellite ground terminal of claim 1, wherein said first orthogonal beam further comprises a third null adjacent to said first null, wherein an angular width between said first and third nulls ranges from 0.05 to 0.5 degrees.

7. The satellite ground terminal of claim 1, wherein said front end processor comprises a controller, a switching mechanism arranged downstream of said analogue beamforming network, and multiple output ports arranged downstream of said switching mechanism.

8. The satellite ground terminal of claim 1, wherein said antenna comprises a reflector having an aperture size ranging from 55 cm to 85 cm in azimuth.

9. The satellite ground terminal of claim 1, wherein said antenna comprises a multi-beam antenna.

10. The satellite ground terminal of claim 1, wherein said antenna comprises a direct radiating/reception array.

11. An outdoor unit of a satellite ground terminal comprising:
an antenna comprising multiple feeds, wherein said feeds are each configured to collect satellite signals in Ka band from multiple different orbital satellites so as to output Ka-band signals in an analog format, wherein said different orbital satellites comprise first and second satellites; and
an analogue beamforming network arranged downstream of said antenna, wherein said analogue beamforming network comprises a power dividing network arranged downstream of said feeds, wherein said power dividing network is configured to divide said Ka-band signals into first and second sets of power-divided signals, a first hybrid network arranged downstream of said power dividing network, wherein said first hybrid network is configured to receive said first set of power-divided signals and form a first beam based on said first set of power-divided signals, wherein said first beam comprises a first beam peak in a direction of said first satellite and a first null substantially in a direction of said second satellite, and a second hybrid network arranged downstream of said power dividing network, wherein said second hybrid network is configured to receive said second set of power-divided signals and form a second beam simultaneously with said first beam based on said second set of power-divided signals, wherein said second beam comprises a second beam peak in said direction of said second satellite and a second null substantially in said direction of said first satellite.

12. The outdoor unit of claim 11, wherein said satellite ground terminal comprises a direct broadcasting satellite (DBS) TV terminal.

13. The outdoor unit of claim 11, wherein said power dividing network is configured to divide one of said Ka-band signals into a first power-divided signal with a first power and a second power-divided signal with a second power and divide another one of said Ka-band signals into a third power-divided signal with a third power and a fourth power-divided signal with a fourth power, wherein said first set of power-divided signals comprises said first and third power-divided signals, wherein said second set of power-divided signals comprises said second and fourth power-divided signals, wherein said first hybrid network comprises a first hybrid configured to receive said first and third power-divided signals and output a first combined signal containing information associated with said first and third power-divided signals, wherein said second hybrid network comprises a second hybrid configured to receive said second and fourth power-divided signals and output a second combined signal containing information associated with said second and fourth power-divided signals.

14. The outdoor unit of claim 13, wherein said first combined signal comprises a first linear combination of said first power-divided signal multiplied by a first complex number plus said second power-divided signal multiplied by a second complex number, wherein said second combined signal comprises a second linear combination of said second power-divided signal multiplied by a third complex number plus said fourth power-divided signal multiplied by a fourth complex number.

15. The outdoor unit of claim 13, wherein said first power is equal to said second power.

16. The outdoor unit of claim 13, wherein said first power is different from said second power.

17. The outdoor unit of claim 11 further comprising a front end processor arranged downstream of said analogue beamforming network, wherein said front end processor comprises a switching mechanism configured to select one of said first and second beams.

18. The outdoor unit of claim 11, wherein said first beam further comprises a third null adjacent to said first null, wherein an angular width between said first and third nulls ranges from 0.05 to 0.5 degrees.

19. The outdoor unit of claim 18, wherein said first beam further comprises a peak of a side lobe at a gain level less than 0 dBi between said first and third nulls.

20. The outdoor unit of claim 18, wherein said first beam further comprises a peak of a side lobe, below greater than 30 dB from said first beam peak, between said first and third nulls.
